(19) United States
(12) Patent Application Publication
(10) Pub. No.: US 2003/0207216 A1
(43) Pub. Date: Nov. 6, 2003

(54) Photothermographic material and image forming method

(76) Inventors: Kouta Fukui, Kanagawa (JP); Eiichi Okutsu, Kanagawa (JP); Fumito Nariyuki, Kanagawa (JP)

Correspondence Address: Sheldon J. Moss, c/o Yumi Yerks, Apartment #412-North, 2111 Jefferson Davis Highway, Arlington, VA, 22202, US

(21) Appl. No.: 10/403,006

(22) Filed: Apr. 1, 2003

(30) Foreign Application Priority Data
Apr. 4, 2002 (JP) 2002-102318
Apr. 19, 2002 (JP) 2002-117880

(51) Int. Cl. G03C 1/498; G03C 5/16

(52) U.S. Cl. 430/350; 430/567; 430/613; 430/619; 430/620; 430/945; 430/965

(57) ABSTRACT

The present invention provides a photothermographic material comprising a support and an image forming layer provided thereon, the image forming layer including at least a photosensitive silver halide, a non-photosensitive organic silver salt, a reducing agent and a binder, the photothermographic material meets at least one of the following conditions of (i) and (ii):

(i) the total silver iodide content of the photosensitive silver halide is from 40 mol % to 100 mol % and the photothermographic material is wrapped with a packaging material so that humidity inside the packaging material is 60 %RH or lower at an ambient temperature of 25° C., and

(ii) the silver iodide content of the photosensitive silver halide is from 5 mol % to 100 mol % and the photothermographic material contains a specific compound. Further, the present invention provides an image forming method using the photothermographic material.

### BACKGROUND OF THE INVENTION

1. Field of Invention

The present invention relates to a photothermographic material (hereinafter referred to as “photosensitive material” or “sensitive material” from time to time) and a image forming method using same.

2. Description of the Related Art

A strong demand for reducing the volume of waste process liquid has risen in recent years particularly in medical fields from the viewpoint of environmental preservation and space saving. Thus, a technology related to a thermally processed image forming material for diagnostic and photographic purposes has been desired, by which efficient light exposure with a laser image setter or laser imager is enabled, and a black image having a high resolution and sharpness is enabled. Such thermally processed image forming material can provide the user with amore simple and environmentally-conscious image producing system using no solution-based process chemicals.

While a similar need has arisen in the field of general image forming materials, images used in the diagnostic field specially require a high image quality such as excellent sharpness and particle for fine depiction, where a blue-black tone for facilitating diagnosis is preferred. Although various hard copy systems using pigment or dye, such as an inkjet printer and electronic photograph system, prevail as a general image forming system, none of these are satisfactory as an output system for diagnostic images.

Organic silver salt-utilizing thermally processed image forming systems are described in Patent Document 1, Patent Document 2 and Non-Patent Document 1.

In particular, photothermographic materials are generally provided with an image forming layer in which a photo catalyst (for example, silver halide) in a catalytically active quantity, a reducing agent, a reducible silver salt (for example, organic silver salt) and an image tone modifier for controlling silver tone when necessary are dispersed in the matrix of a binder. Photothermographic materials are heated to higher temperatures (for example, 80° C. or greater) after images are exposed to light to cause an oxidation-reduction reaction between silver halide or reducible silver salt (acting as oxidizing agent) and a reducing agent, thus providing a black silver image. Silver halide produced upon exposure to light catalytically acts on a latent image to promote the oxidation-reduction reaction, thus producing the black silver image on exposed areas. This process has been disclosed in various documents including Patent Document 3 and Patent Document 4, and commercialized as an image forming system for diagnostic purposes using photothermographic materials, exemplified by Fuji Medical Dry Imager FM-DP L (trade name, manufactured by Fuji Film Medical Co., Ltd.).

An organic silver salt-utilizing thermally processed image forming system is produced either by coating of solvents or by applying a coating liquid that contains polymer micro-particles as water dispersion (as a major binder) and effecting the drying. The latter method is simpler in terms of production facilities due to unnecessary of processes of collecting solvents, etc., and more advantageous in mass production than the former method.

Such an organic silver salt-utilizing system had a serious problem in image preservation after development processing due to the absence of fixing processes and degenerated quality of printouts upon light exposure in particular. A method for improving the printout degeneration is to utilize silver iodide (AgI) formed by conversion of an organic silver salt, which is disclosed in Patent Document 5 and Patent Document 6. However, the method by which an organic silver salt is converted by iodine as disclosed in these documents was unable to attain a sufficient sensitivity, thus making it difficult to provide practical systems.

Other AgI-using sensitive materials were described in Patent Documents 7 through 11, none of which was able to attain a sufficient sensitivity/fogging level and eligible as laser exposure sensitive materials for practical use. Greatly anticipated has been disclosure of a method for attaining a full utilization of silver halide that is rich in silver iodide.

Further, Patent Document 12 disclosed the image forming methods and photosensitive materials that use blue to ultraviolet laser, which were, however, free of AgI and insufficient in sensitivity.

The inventors found that the blue to ultraviolet laser-utilizing system is able to provide high sensitivity and high quality photosensitive materials by use of AgI.

However, as compared with the materials prepared with conventional AgBrI emulsions, the photosensitive materials prepared with AgI-rich emulsion had a problem in sensitivity being greatly reduced with the lapse of time when unused photosensitive materials are stored.

[Patent Document 1]

Specification of U.S. Pat. No. 3,152,904

[Patent Document 2]

Specification of U.S. Pat. No. 3,457,075

[Patent Document 3]

Specification of U.S. Pat. No. 2,910,377

[Patent Document 4]

Patent Publication of JP-B No. 43-4924

[Patent Document 5]

Specification of U.S. Pat. No. 6,143,488

[Patent Document 6]

Specification of EP No.0922995

[Patent Document 7]

Pamphlet of International Patent Publication No. 97/48014

[Patent Document 8]

Pamphlet of International Patent Publication No. 97/48015

[Patent Document 9]

Specification of U.S. Pat. No. 6,165,705

[Patent Document 10]

Patent Publication of JP-A No. 8-297345

[Patent Document 11]

Specification of Japanese Patent No. 2785129

[Patent Document 12]

Patent Publication of JP-A No. 2000-305213

[Non-Patent Document-1]

Page 279, Chapter 9, “Thermally Processed Silver Systems” (Imaging Processes and Materials) authored by D. Klosterboer, Neblette, 8^{th} edition, compiled by J. Sturge, V. Walworth and A. Shepp, 1989.

### SUMMARY OF THE INVENTION

Thus, an object of the present invention is to provide a photothermographic material capable of suppressing sensitivity reduction resulting from humidity in preservation of unused photosensitive materials, with use of AgI-rich photosensitive silver halide.

An object of the invention was achieved by the following photosensitive materials and the image forming method thereof. Specifically, the first aspect of the invention is to provide a photothermographic material comprising: a support; and an image forming layer provided on the support, the image forming layer including at least a photosensitive silver halide, a non-photosensitive organic silver salt, a reducing agent and a binder, wherein, the total silver iodide content of said photosensitive silver halide is in a range of from 40 mol % to 100 mol %; and the photothermographic material is wrapped with a packaging material so that humidity inside the packaging material is no more than 60%RH at the ambient temperature of 25° C.

Further, the second aspect of the invention is to provide a photothermographic material comprising a support and an image forming layer provided on the support, the image forming layer including at least a photosensitive silver halide, a non-photosensitive organic silver salt, a reducing agent and a binder; wherein the silver iodide content of said photosensitive silver halide is in a range of from 5 mol % to 100 mol % and the photothermographic material contains the compound represented by the general formula (I) below:

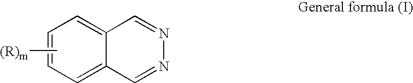

wherein in the formula (I), R represents a monovalent substituent and where a plurality of Rs are adjacent, they may form an aliphatic ring, aromatic ring or hetero cycle; m representing an integer from 1 to 4 and when m is at least 2, the plurality of Rs may be the same or different.

The invention also provides an image forming method characterized in that the above photothermographic materials are exposed to light by using as a light source a semi-conductor laser having peak light emitting intensity of 350 nm to 450 nm.

### BRIEF DESCRIPTION OF THE DRAWINGS

FIG. 1 is a graph showing light absorption of silver iodide emulsion preferably used in the present invention.

### DETAILED DESCRIPTION OF THE PREFERRED EMBODIMENTS

The present invention is now explained in greater detail by referring to the following embodiments.

1. Photothermographic Materials

The photothermographic material as the first aspect of the invention is a photothermographic material comprising: a support; and an image forming layer provided on the support, the image forming layer including at least a photosensitive silver halide, a non-photosensitive organic silver salt, a reducing agent and a binder, wherein the total silver iodide content of said photosensitive silver halide is in a range of from 40 mol % to 100 mol %; and the photothermographic material is wrapped with a packaging material so that humidity inside the packaging material is no more than 60%RH at the ambient temperature of 25° C.

Further, the photothermographic material as the second aspect of the invention is a photothermographic material comprising a support and an image forming layer provided on the support, the image forming layer including at least a photosensitive silver halide (hereinafter it may be simply referred to as silver halide), a non-photosensitive organic sliver salt (hereinafter it maybe simply referred to as organic silver salt), a reducing agent and a binder, wherein the silver iodide content of said photosensitive silver halide is in a range of from 5 mol % to 100 mol % and the photothermographic material contains the compound represented by the general formula (I) below.

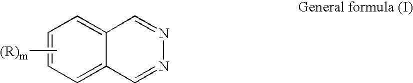

In the general formula (I), R represents a monovalent substituent and where a plurality of Rs are adjacent, they may form an aliphatic ring, aromatic ring or hetero cycle; m representing an integer from 1 to 4 and when m is at least 2, the plurality of Rs may be the same or different.

The photothermographic material of the invention having the above characteristics is able to provide a higher long time stability when unused photosensitive materials are stored, despite the use of photosensitive silver halides rich in silver iodide content.

A detailed explanation is now made as follows about each component of the photothermographic material according to the invention.

Packaging Material

The packaging material of the invention is explained as follows:

The packaging material as described in the first aspect of the invention must be kept at 60% RH or lower at 25° C. for inner package humidity. The 60% RH at 25° C. means that the relative humidity is 60% at ambient temperature of 25° C. The relative humidity is expressed as a percentage, which is a percentage of moisture vapor pressure in air at a specified temperature (partial pressure of moisture vapor) and satuated moisture vapor pressure at the same temperature.

The inner package humidity is 60% RH or lower at 25° C. as described above, preferably 40% RH or lower at 25° C. and more preferably 30% RH or lower at 25° C. Inner package humidity exceeding 60% RH at 25° C. is not desirable due to a higher reduction in sensitivity.

“The inner package humidity” hereof means humidity inside the packaging material measured by inserting a hygrometer into a partially opened area of the packaging material in a room kept constant at 50% RH at 25° C., with the sensitive material wrapped in the packaging material having the features to be described later.

It is preferable to adjust the inner package humidity of the invention as follows:

Namely, where the inner package humidity is adjusted to 60% RH or lower at 25° C., after drying of the sensitive material to adjust the humidity in a room kept constant at 60% RH or lower at 25° C., heating is performed to the surface of the packaging material so as to reach a temperature from 70 to 90° C. After the heating, the surface is cooled to 25° C. and again humidity is adjusted to a room kept constant at 60% RH or lower at 25° C. Thereafter, the thus-treated sensitive material is stored in the packaging material having the features to be described later to adjust the inner package humidity. Where the inner package humidity is adjusted to 40% RH or lower at 25° C., the humidity is kept at 40% RH at 25° C. to make a similar adjustment.

Features of the Packaging Material

Preferable packaging materials as described in the first and second aspects of the invention are those completely free from moisture and oxygen permeability or extremely low in moisture and oxygen permeability, for example, metal film laminated with resin.

To be specific, preferable packaging materials of the invention are those having the following oxygen permeability and moisture permeability when measured by the following methods.

Measurement conditions of oxygen permeability: temperature at 25° C., RH of 0%, gas concentration of 100% and measurement conditions of moisture permeability: temperature at 25° C. and RH of 90%

When measured under the above conditions, the oxygen permeability is preferably no more than 50 mL/atm·m²·day, more preferably no more than 10 mL/atm·m²·25° C. day, still more preferably no more than 1 mL/atm·m²·25° C. day, and the most preferably 0 mL/atm·m²·25° C. day.

When measured under the above conditions, the moisture permeability is preferably no more than 10 g/atm·m²·day, more preferably no more than 5 mL/atm·m²·25° C. day, still more preferably no more than 1 mL/atm·m²·25° C. day, and the most preferably 0 mL/atm·m²·25° C. day.

At the above-described oxygen permeability and moisture permeability, 0 mL/atm·m²·25° C. day means less than the detection limit by the above measurement method.

Specific examples of the above packaging materials are those described in JP-A No. 8-254793 and JP-A No. 2000-206653.

Photosensitive Silver Halide

The photosensitive silver halide used in the invention is explained as follows:

The preferable photosensitive silver halide used in the invention is a silver halide, part of which is provided with a phase that can absorb light through direct transition. It is well known that light absorption through direct transition can be realized by providing the silver halide with a high silver iodide structure having hexagonal wurtzite structure or cubic zincblende structure at 350 nm to 450 nm, exposure wavelength of image forming methods favorably applied for the photothermographic materials according to the invention. However, silver halide with said absorption structure is, in general, low in sensitivity and hardly utilized within the photographic industry.

In the invention, exposure is made at a great light emission exceeding 1 mW/mm² for a short period (no more than 1 second, preferably no more than 10⁻² seconds, and more preferably no more than 10⁻⁴ seconds) so that the photothermographic material having the above-mentioned high silver iodide-containing photosensitive silver halide can be provided with high sensitivity and sharpness.

The photosensitizing sliver halide used in the first aspect of the invention must be from 40 mol % to 100 mol % at a total silver iodide content.

The photosensitizing sliver halide used in the second aspect of the invention must be from 5 mol % to 100 mol % at a mean silver iodide content. The mean silver iodide content is preferably from 10 mol % to 100 mol %, more preferably from 40 mol % to 100 mol %, still more preferably from 70 mol % to 100 mol %, and particularly preferably from 90 mol % to 100 mol %.

As explained above, at a higher silver iodide content, effects of the invention are more clearly exhibited.

The preferable photosensitive silver halides of the invention are those showing absorption through direct transition derived from a high silver iodide crystalline structure at a wavelength within a range from 350 nm to 450 nm. Whether these silver halides have light absorption through direct transition or not can be easily discriminated by confirming the excitation absorption derived from direct transition in the vicinity from 400 nm to 430 nm.

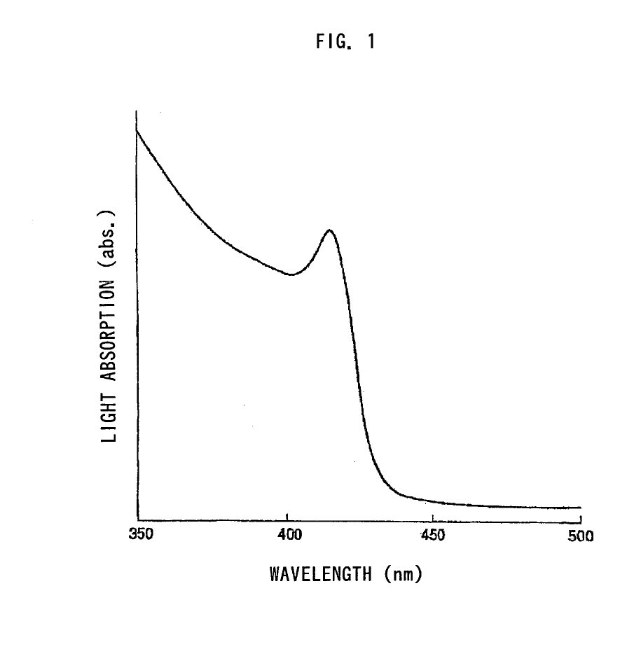

FIG. 1 shows the light absorption of an silver iodide emulsion preferably used in the invention. As apparent from FIG. 1, the absorption derived from excitation of high silver iodide is shown in the vicinity of 420 nm.

High silver iodide phase showing the said light absorption through direct transition may be present solely. Also preferably used in the invention are those combined with silver halides exhibiting light absorption through indirect transition at a wavelength within a range from 350 nm to 450 nm such as silver bromide emulsion, silver chloride emulsion, silver iodide bromide emulsion, silver iodide chloride emulsion and their mixtures.

Silver halide phases that absorb light through direct transition exhibit a strong light absorption in general, but are lower in sensitivity than silver halide phases that show a weak light absorption through indirect transition, and therefore have been rarely utilized in industries.

The photothermographic material of the invention is provided with a favorable sensitivity by using the above described silver halides and providing exposed illumination intensity exceeding 1 mW/mm² at a wavelength within a range from 350 nm to 450 nm, which is the exposed wavelength in the image forming method preferably applied to the photothermographic material of the invention.

The photosensitive silver halides of the invention exhibit more preferable effects when the particle size is from 5 nm to 80 nm. In particular, silver halide particles assuming the phase of light absorption through direct transition are able to exhibit sensitivity when the particle size is smaller, namely, 80 nm or less.

The particle size of photosensitive silver halides is more preferably from 5 nm to 60 nm and still more preferably from 10 nm to 50 nm. The particle size hereof means the average diameter obtained when the project area of silver halide particles observed under an electron microscope (project area of a major surface in the case of tabular particle) are converted to a circular image of the said area.

Methods for forming photosensitive silver halides are well known in the art. For examples, such methods are employable that are described in Research Disclosure No. 17029 published in June 1978 and the specification of U.S. Pat. No. 3,700,458. Specifically, silver-imparting compounds and halogen-imparting compounds are added to gelatin or other polymer solutions to prepare a photosensitive silver halide, and then organic silvers are mixed with the resultant.

Further, preferable methods are those described in paragraphs [0217] to [0224], of JP-A No. 11-119374, Japanese Patent Application No. 11-98708 and JP-A No. 2000-347335.

Configurations of silver halide particles of the invention include cube, octahedron, dodecahedron, tetradecahedron, tubular particle, spherical particle, bar-shaped particle and potato-shaped particle. In the first aspect of the invention, dodecahedron and tetradecahedron are particularly preferable. The dodecahedron hereof means a particle having planes of (001), {1(-1) 0} and {101} and the tetradecahedron hereof means a particle having planes of (001), {101} and {100}. The plane of {100} represents a crystal plane group equivalent in valence to the plane of (100). In the second aspect of the invention, cubic particles are particularly preferable. Silver halide particles with round corners can be used preferably.

Silver iodides of the invention can assume any given β-phase and γ-phase contents. The β phase hereof means a high silver iodide structure having a hexagonal wurtzite structure, while the γ phase hereof means a high silver iodide structure having a cubic zincblende structure.

There are no particular restrictions on the plane index (Miller index) on outer surface of photosensitive silver halide particles. It is, however, preferable to have a higher percentage of the plane {100} high in spectral sensitization efficiency when a spectral sensitization dye is adsorbed. The percentage is preferably 50% or greater, more preferably 65% or greater and still more preferably 80% or greater. The percentage of Miller index for a plane of {100} can be determined by the method described in T. Tarni; J. Imaging Sci., 29, 165 (1985) utilizing adsorption dependency on planes of {111} and {100} in relation to adsorption of the sensitization dye.

In the invention, preferable are silver halide particles wherein a hexa-cyano metal complex is incorporated on the uppermost surface of the particles. The hexa-cyano metal complexes includes [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻ and [Re(CN)₆]³⁻. In the invention, preferable is hexa-cyano Fe complex.

Since a hexa-cyano metal complex is present as ion in aqueous solution, counter cation is not important. It is preferable to use the following: alkaline metal ions such as sodium ion, potassium ion, rubidium ion, cesium ion and lithium ion; or ammonium ion and alkyl ammonium ion (for example, tetra-methyl ammonium ion, tetra-ethyl ammonium ion, tetra-propyl ammonium ion, tetra (n-butyl) ammonium ion) that are easily mixable with water and suitable in causing sedimentation of silver halide emulsions.

Hexa-cyano metal complexes can be used after mixture with water, or suitable organic solvents easily mixable with water (for example, alcohols, ethers, glycols, ketones, esters, amides and others) or a mixture with gelatin, in addition to water.

Hexa-cyano metal complexes are added preferably in a quantity from 1×10⁻⁵ mol to 1×10⁻² mol, and more preferably in a quantity from 1×10⁻⁴ mol to 1×10⁻³ mol, in relation to 1 mol of silver.

Hexa-cyano metal complexes are directly added before completion of the feeding process prior to the chemical sensitization process wherein sulfur sensitization, chalcogen sensitization such as selenium sensitization and tellurium sensitization, and noble metal sensitization such as gold sensitization, during the washing process, during the dispersion process or before the chemical sensitization process, following the completed feeding of silver nitrate aqueous solution to be used for forming particles, so that hexa-cyano metal complexes can be incorporated on the uppermost surface of silver halide particles. In order to prevent the growth of silver halide micro-particles, it is preferable to add hexa-cyano metal complexes immediately after formation of particles and more preferably to add it before completion of the feeding process.

Addition of hexa-cyano metal complexes may be started after addition of silver nitrate by 96% by weight in a total volume for improving particle formation. It is preferable to start the addition after 98% by weight of silver nitrate is added and it is particularly preferable to start the addition after 99% by weight of it is added.

When hexa-cyano metal complexes are added to a silver nitrate aqueous solution, the state of which is immediately before completion of particle formation, it is possible to provide adsorption on the uppermost surface of silver halide particles, mostly in the form of hardly-soluble salt with silver ion on particle surfaces. Silver salt of hexa-cyano iron (II) is more hardly-soluble than AgI, and able to prevent re-dissolution due to micro particles, thus making it possible to produce silver halide micro-particles with a smaller particle size.

The photosensitive silver halide particles of the invention are able to contain metals and metal complexes covering groups 8 to 10 in the Periodic Table (groups 1 to 18).

Of the metals and metal complexes belonging to the groups 8 to 10 listed in the Periodic Table, rhodium, ruthenium and iridium are preferable. These metal complexes may be used solely or in combination with two or more types of complexes consisting of the same or different types of metals.

The preferable content is from 1×10⁻⁹ to 1×10⁻⁶ mol in relation to 1 mol of silver.

These heavy metals, metal complexes and the method for addition are described in JP-A No. 7-225449, paragraphs [0018] through [0024] of JP-A No. 11-65021 and paragraphs [0227] through [0240] of JP-A No. 11-119374.

Metal atoms (for example, [Fe(CN)₆]⁴⁻) to be contained in silver halide particles used in the invention as well as desalting and chemical sensitization of silver halide emulsions are described in paragraphs [0046] through [0050] of JP-A No. 11-84574, paragraphs [0025] through [0031] of JP-A No. 11-65021 and paragraphs [0242] through [0250] of JP-A No. 11-119374.

Various gelatins can be used as gelatins to be contained in emulsions in which the photosensitive silver halides of the invention are used. Gelatins with a lower molecular weight of 500 to 60,000 are preferable in maintaining better dispersion conditions in an organic silver containing-coating liquid for photosensitive silver halide emulsions. These low-molecular weight gelatins may be used at the time of particle formation or dispersion after desalting treatment. It is, however, preferable to use the gelatins at the time of dispersion after the desalting treatment.

For the purpose of increasing intrinsic sensitivity, various compounds known as strong sensitizing agents can be used in the invention. The compounds used in the invention include those described in EP-A No. 587,338, U.S. Pat. Nos. 3,877,943 and 4,873,184, JP-A Nos. 5-341432, 11-109547 and 10-111543.

The photosensitive silver halide particles used in the invention are preferably subjected to chemical treatment by sulfur sensitization method, selenium sensitization method or tellurium sensitization method. Known compounds, for example, those described in JP-A No. 7-128768 may be used as compounds preferably used in the sulfur sensitization method, selenium sensitization method or tellurium sensitization method. Tellurium sensitization is particularly preferable in the invention. Further, preferable compounds are described in paragraph [0030] of JP-A No. 11-65021, and those indicated by the general formulae of (II), (III) and (IV) of JP-A No. 5-313284,

In the invention, chemical sensitization may be performed at any time as long as the sensitization is performed after particle formation but before coating. It may be done, for example, after desalting, (1) before spectral sensitization, (2) at the same time with spectral sensitization, (3) after spectral sensitization, and (4) immediately before coating. It is particularly preferable to perform the chemical sensitization after spectral sensitization.

Quantities of sulfur, selenium and tellurium sensitizing agents used in the invention vary, depending on silver halide particles to be used, chemical aging and others, in a range from 10⁻⁸ to 10⁻² in relation to 1 mol of silver halide and preferably in a range from 10⁻⁷ to 10⁻³. There are no particular restrictions in performing the chemical sensitization in the invention, with pH of 5 to 8, pAg of 6 to 11 and temperatures of 40 to 95° C.

To the silver halide emulsion used in the invention, thiosulfonic acid may be added by the method described in EP-A No. 293,917.

A photosensitive silver halide emulsion to be incorporated into the photosensitive material of the invention may be used solely or in combination with 2 or more types of emulsions (for example, those with different mean particle sizes, those with different halogen compositions, those with different habits, those with different conditions of chemical sensitization). Use of 2 or more types of sensitive silver halides with different sensitivity makes it possible to modulate the gradation.

Techniques concerning the above are those described in JP-A Nos. 57-119341, 53-106125, 47-3929, 48-55730, 46-5187, 50-73627 and 57-150841. It is desirable to provide a sensitization difference of 0.2 logE or greater for each emulsion.

The photothermographic material as mentioned in the first aspect of the invention preferably contain a compound wherein one electron oxidant produced by one electron oxidation is able to release one or more electrons.

A compound wherein one electron oxidant produced by one electron oxidation is able to release one or more electrons is that selected from any one of the following types of 1 to 5.

Type 1:

A compound wherein one electron oxidant produced by one electron oxidation is able to release additionally 2 or more electrons, in association with the subsequent bond and cleavage reaction.

Type 2:

A compound wherein one electron oxidant produced by one electron oxidation is able to release additionally one electron, in association with the subsequent bond and cleavage reaction and also has 2 or more adsorption groups to silver halide in the same molecule.

Type 3:

A compound wherein one electron oxidant produced by one electron oxidation is able to release additionally 1 or more electrons, after the subsequent bond and formation processes.

Type 4:

A compound wherein one electron oxidant produced by one electron oxidation is able to release additionally 1 or more electrons after the subsequent intra-molecular ring cleavage processes.

Type 5:

A compound represented by X-Y wherein X represents a reduction group while Y represents a desorption group and one electron oxidant produced by oxidation of one reduction group represented by X is able to produce X radical through desorption of Y in association with subsequent cleavage reaction of X-Y bond and to release additionally 1 more electron therefrom.

Of compounds of the above type I and types 3 to 5, preferable are “those having the adsorption group to silver halide in molecule” or “those having a partial structure of spectral sensitization dye in molecule.” More preferable are “those compounds having the adsorption group to silver halide in molecule.” More preferable compounds of type 1 to 4 are “those having as an adsorption group a nitrogen-containing hetero cycle group substituted with 2 or more mercapto groups. ” A more detailed explanation is now made about the compounds of type 1 to 5.

In the compound of type 1, “the bond and cleavage reaction” means cleavages of bonds among individual elements, more particularly, carbon-carbon, carbon-silicon, carbon-hydrogen, carbon-boron, carbon-tin, carbon-germanium, and the cleavage of carbon-hydrogen bond may be further accompanied. The compound of type 1 is such that only after one electron oxidant is produced by oxidation of one electron, the electron oxidant is able to release additionally 2 or more electrons (preferably 3 or more electrons) in association with the bond and cleavage reaction.

Among the compound of type 1, preferable are those represented by the general formulae (A), (B), (1), (2) and (3) below:

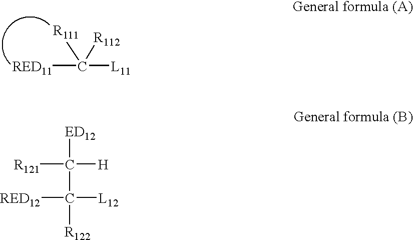

In the general formula (A), RED₁₁ represents a reduction group capable of undergoing oxidation of one electron and L₁₁ represents a desorption group. R₁₁₂ represents a hydrogen atom or substituent. R₁₁₁ represents a non-metallic group capable of producing a ring structure equivalent to tetrahedron, hexahedron or octahedron of pentagonal and hexagonal aromatic rings (including aromatic hetero cycles), together with carbon atom (C) and RED₁₁.

In the general formula (B), RED₁₂ represents a reduction group capable of undergoing oxidation of one electron and L₁₂ represents a desorption group. R₁₂₁ and R₁₂₂ respectively represent a hydrogen atom and a substituent. ED₁₂ represents an electron-imparting group. In the general formula (B), R₁₂₁ and RED₁₂, R₁₂₁ and R₁₂₂, or ED₁₂ and RED 12 may bond with each other to form a ring structure.

The compounds expressed in the general formula (A) or (B) are those capable of causing a spontaneous desorption of L₁₁ or L₁₂ through the bond and cleavage reaction after oxidation of one electron of the reduction group represented by RED or RED₁₂, thus releasing 2 or more electrons and preferably 3 or more electrons.

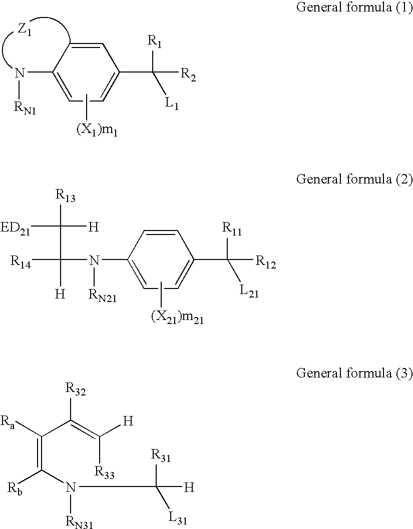

In the general formula (1), Z₁ represents an atomic group capable of producing hexagonal rings together with a nitrogen atom and two carbon atoms of benzene ring, R₁, R₂ and R_{N1} independently represent a hydrogen atom or a substituent, X₁ represents the substituent substitutable on a benzene ring, m₁ represents an integer from 0 to 3, and L₁ represents a desorption group. In the general formula (2) wherein ED₂₁ represents an electron-imparting group, R₁₁, R₁₂, R_{N21}, R₁₃ and R₁₄ independently represent a hydrogen atom or a substituent, X₂₁ represents the substituent substitutable with a benzene ring, m₂₁ represents an integer from 0 to 3, and L₂₁ represents a desorption group. R_{N21}, R₁₃, R₁₄, X₂₁ and ED₂₁ may bond with each other to produce a ring structure. In the general formula (3) wherein R₃₂, R₃₃, R₃₁, R_{N31}, Rₐ and R_{b} independently represent a hydrogen atom or a substituent, and L₃₁ represents a desorption group. However, when R_{N31} represents a group other than an aryl group, Rₐ and R_{b} bond with each other to form an aromatic ring.

These compounds are able to undergo spontaneous desorption of L₁, L₂₁ or L₃₁ through the bond and cleavage reaction after oxidation of one electron, thus releasing 2 or more electrons and preferably 3 or more electrons.

The following is a detailed explanation regarding a compound represented by the formula (A).

The reducing group capable of undergoing oxidation of one electron represented by RED₁₁ in the general formula (A) is a group capable of forming a specific ring through bond with R₁₁₁ to be explained later, to be more specific, including divalent group excluding one hydrogen atom appropriately positioned in forming a ring from the following monovalent groups. More particularly, they are an alkylamino group, arylamino group (aniline group, naphthylamino group, etc.), hetero-cycle amino group (benzothiazolyl amino group, pyrrolyl amino group, etc.), alkylthio group, arylthio group (phenylthio group, etc.), hetero cycle thio group, alkoxy group, aryloxy group (phenoxy group, etc.), hetero cycle oxy group, aryl group (phenyl group, naphthyl group, anthranyl group, etc.), hetero cycle group of aromatic series or non-aromatic series (hetero cycle that contains at least one hetero atom selected from a pentagonal or heptagonal mono-cyclic or condensed ring nitrogen atom, sulfur atom, oxygen atom or selenium atom, for example, tetrahydroquinoline ring, tetrahydroisoquinoline ring, tetrahydroquinoxaline ring, tetrahydroquinazoline ring, indoline ring, indole ring, indazole ring, carbazole ring, phenoxaziline ring, phenothiazine ring, benzothiazoline ring, pyrrole ring, imidazole ring, thiazoline ring, piperidine ring, pyrrolidine ring, morpholine ring, benzoimidazole ring, benzoimidazoline ring, benzoxazoline ring, methylenediozyphenyl ring, etc.). (Hereinafter, RED₁₁ is described as a monovalent group name for simple reference). RED₁₁ may contain a substituent.

Substituents of the invention mean any groups selected from the following groups, unless otherwise specified. They are a halogen atom, alkyl groups (including aralkyl group, cycloarkyl group, active methine group), alkenyl group, alkinyl group, aryl group, hetero cycle group (regardless of which position is substituted), hetero cycle group containing quaternary nitrogen atom (for example, pyridinio group, imidazolio group, quinolinio group, isoquinolinio group), acyl group, alkoxy carbonyl group, aryloxyl carbonyl group, carbamoyl group, carboxy group or its salt, sulfonyl carbamoyl group, acyl carbamoyl group, sulfamoyl carbamoyl group, carbazoyl group, oxalyl group, oxamoyl group, cyano group, carbone imidoyl group, thiocarbamoyl group, hydroxy group, alkoxy group (including a group consisting of repetition of ethyleneoxy group or propyleneoxy group), aryloxy group, hetero cycle oxy group, acyloxy group (alkoxy or aryloxy) carbonyloxy group, carbamoyloxy group, sulfonyoxy group, amino group (alkyl, aryl, or hetero cycle) amino group, acylamino group, sulfonamide group, ureide group, thioureide group, imide group (alkoxy or aryloxy) carbonylamino group, sulfamoylamino group, semicarbazides group, thiosemicarbazides group, hydrazine group, ammonia group, oxamoylamino group, (alkyl or aryl) sulfonylureide group, acylureide group, acylsufamoleamino group, nitro group, mercapto group, (alkyl, aryl or hetero cycle) thio group, (alkyl or aryl) sulfonyl group, (alkyl or aryl) sulfinyl group, sulfo group or its salt, sulfamoyl group, acylsulfamoyl group, sulfonylsulfamoyl group or its salt, a group containing phosphoric amid and phosphoric ester structure. These substituents may undergo further substitution with these substituents.

RED₁₁ are preferably an alkylamino group, arylamino group, hetero cycle amino group, aryl group, hetero cycle of aromatic series or non-aromatic series, and more preferably an arylamino group (particularly aniline group) and aryl group (particularly phenyl group). When these substances are provided with substituents, preferable substituents are a halogen atom, alkyl group, alkoxy group, carbamoyl group, sulfamoyl group, acylamino group and sulfonamide group.

However, it is preferable that the aryl group has at least one “electron-imparting group,” when RED₁₁ represents an aryl group. “The electron-imparting group” hereof means a hetero cycle group of pentagonal, mono-cyclic or condensed ring and electron-excessive aromatic series, which contains in the ring at least any one of the following: hydroxy group, alkoxy group, mercapto group, sulfonamide group, acylamino group, alkylamino group, arylamino group, hetero cycle amino group, active methine group and nitrogen atom (for example, indolyl group, pyrrolyl group, imidazolyl group, benzoimidazolyl group, thiazolyl group, benzothiazolyl group and indazolyl group), or hetero cycle groups of non-aromatic series substituted with nitrogen atom (pyrrolidinyl group, indolyl group, piperidinyl group, piperazinyl group, morpholino group, which are also called circular amino groups). The active methine hereof means a methine group substituted with two “electron-imparting groups.” “The electron-imparting group” hereof means an acyl group, alkoxycarbonyl group, aryloxycarbonyl group, carbamoyl group, alkylsulfonyl group, arylsulfonyl group, sulfamoyl group, trifluoromethyl group, cyano group, nitro group or carbonimidoyl group. These two electron-imparting groups may bond with each other to form a ring structure.

In the formula (A) wherein L₁₁ represents specifically a carboxyl group or its salt, sylyl group, hydrogen atom, triarylbromide anion, trialkylstannyl group, trialkylgermyl group or —CR_{C1} R_{C2} R_{C3} group. Silyl group hereof means specifically a trialkylsilyl group, aryldialkylsilyl group, triarylsilyl group, and may have any given substituent.

When L₁₁ represents a salt of a carboxyl group, salt-forming counter ions include alkaline metal ion, alkaline earth metal ion, heavy metal ion, ammonium ion, phosphonium ion, preferably alkaline metal ion or ammonium ion, and most preferably alkaline metal ion (particularly, Li⁺, Na⁺ and K⁺ ion).

When L₁₁ represents a —CR_{C1} R_{C2} R_{C3} group, R_{C1}, R_{C2} and R_{C3} independently represent a hydrogen atom, alkyl group, arly group, hetero cycle group, alkylthio group, arylthio group, alkylamino group, arylamino group, hetero cycle amino group, alkoxy group, aryloxy group and hydroxy group, which may bond with each other to form ring structures or may contain any given substituent. However, when any one of R_{C1}, R_{C2} or R_{C3} represents a hydrogen atom or alkyl group, the remaining two shall not represent a hydrogen atom or alkyl group. Preferable R_{C1}, R_{C2} and R_{C3} are independently an alkyl group, aryl group (particularly phenyl group), alkylthio group, arylthio group, alkylamino group, arylamino group, hetero cycle group, alkoxy group and hydroxy group. For example, they include a phenyl group, p-dimethylaminophenyl group, p-methoxyphenyl group, 2,4-dimethoxyphenyl group, p-hydroxyphenyl group, methythio group, phenylthio group, phenoxy group, methoxy group, ethoxy group, dimethylamino group, N-methylanilino group, diphenylamino group, morpholino group, thiomorpholino group and hydroxy group. Examples wherein they bond with each other to form a ring structure include a 1,3-dithiolan-2-yl group, 1,3-dithian-2-yl group, N-methyl-1,3-thiazolidine-2-yl group, N-benzyl-benzothiaolidine-2-yl group.

It is also preferable that, after R_{C1}, R_{C2} and R_{C3} are selected within the above-mentioned scope, a —CR_{C1} R_{C2} R_{C3} group represents the same group as the remaining groups excluding L₁₁ in the general formula (A).

In the general formula (A) wherein L₁₁ preferably represents a carboxyl group or its salt and hydrogen atom, and more preferably a carboxyl group and its salt.

Where L₁₁ represents a hydrogen atom, it is preferable that a compound expressed in the general formula (A) contains an intramolecular base site. The base site acts to deprotonate a hydrogen atom represented by L₁₁ after oxidation of the compound expressed in the general formula (A), thus resulting in release of electrons.

The base hereof means specifically a conjugate base exhibiting approx. 1 to 10 pKa. For example, it includes nitrogen-containing hetero cycles (pyridines, imidazoles, benzoimidazoles, thiazoles, etc.), anilines, trialkylamines, amino group, carbon acids (active methylene aniones), thio-acetic acid anion, carboxylate (—COO⁻), sulfate (—SO₃⁻) and aminoxide (>N⁺(O⁻)—). Preferable is a conjugate base of acid exhibiting approx. 1 to 8 pKa, more preferable are carboxylate, sulfate and aminooxide, and particularly preferable is carboxylate. When these bases contain anion, they may possess counter cation, samples of which include alkaline metal ion, alkaline earth metal ion, heavy metal ion, ammonium ion, phosphonium ion. These bases are at any given sites coupled with a compound expressed in the general formula (A) The areas where these base sites are coupled may be any of RED₁₁, R₁₁₁ or R₁₁₂ given in the general formula (A), or may couple with substituents of these bases.

In the general formula (A), R₁₁₂ represents a substituent substitutable with a hydrogen atom or carbon atom. However, R₁₁₂ and R₁₁ shall not give the same group.

Preferable R₁₁₂ includes a hydrogen atom, alkyl group, aryl group (phenyl group, etc.), alkoxy group (methoxy group, ethoxy group, benzyloxy group, etc.), hydroxy group, alkylthio group (methylthio group, butylthio group, etc.), amino group, alkylamino group, arylamino group and hetero cycle group, and more preferable R₁₁₂ includes a hydrogen atom, alkyl group, alkoxy group, hydroxy group, phenyl group and alkylamino group.

In the general formula (A), R₁₁₁-formed ring structures are those corresponding to tetrahydrons, hexahydrons or octahydrons of pentagonal or hexagonal aromatic series (including aromatic hetero cycles), the hydro substance hereof means a partial hydrogenated ring structure of a carom-carbon double bond (or carbon-nitrogen double bond) present in aromatic ring (including aromatic hetero cycle), and the tetrahydro substance, hexahydro substance or octahydro substance hereof means a structure wherein respectively 2, 3 and 4 of a carbon-carbon double bond (or carbon-nitrogen double bond) are hydrogenated. For hydrogenation, an aromatic ring assumes a partially hydrogenated non-aromatic ring structure.

For example, the said ring structures include a pyrrolidine ring, imidazolidine ring, thiazolidine ring, pyrazolidine ring and oxazolidine ring, piperidine ring, tetrahydropyridine ring, tetrahydropyrimidine ring, piperazine ring, tetralin ring, tetrahydroquinoline ring, tetrahydroisoquinoline ring, tetrahydroquinazoline ring, tetrahydroquinoxaline ring, tetrahydrocarbazole ring and octahydrophenantolidine ring. These ring structures may have any given substituent.

More preferable R₁₁₁-formed ring structures include a pyrrolidine ring, imidazolidine ring, piperidine ring, tetrahydropyridine ring, tetrahydropyrimidine ring, piperazine ring, tetrahydroquinoline ring, tetrahydroisoquinoline ring, tetrahydroquinazoline ring, tetrahydroquinoxaline ring and tetrahydrocarbazole ring, particularly preferable R₁₁₁-formed ring structures include pyrrolidine ring, piperidine ring, piperazine ring, tetrahydropyridine ring, tetrahydroquinoline ring, tetrahydroisoquinoline ring, tetrahydroquinazoline ring, tetrahydroquinoxaline ring, and most preferable R₁₁₁-formed ring structures include pyrrolidine ring, piperidine ring, tetrahydropyridine ring, tetrahydroquinoline ring and tetrahydroisoquinoline ring.

In the genera formula (B), RED₁₂ and L₁₂ are the same groups meaning RED₁₁ and L₁₁ expressed in the general formula (A), with the same preferable scope. However, RED₁₂ is a monovalent group, except when it assumes the following ring structure, specifically, including the monovalent group described by RED₁₁. R₁₂₁ and R₁₂₁ are the same group meaning R₁₁₂ expressed in the general formula (A), with the same preferable scope. ED₁₂ represents an electron-imparting group. R₁₂₁ and RED₁₂, R₁₂₁ and R₁₂₂, or ED₁₂ and RED₁₂ may bond with each other to form a ring structure.

In the general formula (B), the electron-imparting group represented by ED₁₂ is the same meaning the electron-imparting group explained as the substituent when RED₁₁ represents an aryl group. Preferable ED₁₂ includes hetero cycle groups of pentagonal, mono-cyclic or condensed ring and electron-excessive aromatic series, which contain in the ring at least any one of a hydroxy group, alkoxy group, mercapto group, sulfonamide group, alkylamino group, arylamino group, active methine group or nitrogen atom, or hetero cycle groups of non-aromatic series substituted with a nitrogen atom, and phenyl groups substituted with these electron-imparting groups. More preferable ED₁₂ includes a hydroxy group, mercapto group, sulfonamide group, alkylamino group, arylamino group, active methine group, hetero cycle groups of non-aromatic series substituted with a nitrogen atom, and phenyl groups substituted with these electron-imparting groups (for example, a p-hydroxyphenyl group, p-dialkylaminophenyl group, o,p-dialkoxyphenyl group).

In the general formula (B), R₁₂₁ and RED₁₂, R₁₂₁ and R₁₂₂, or ED₁₂ and RED₁₂ may bond with each other to form a ring structure. The ring structure hereof includes a carbon ring or hetero cycle of non-aromatic series, which is pentagonal or heptagonal and a mono-cyclic or condensed ring, and substituted or unsubstituted. Examples of ring structures formed by R₁₂₁ and RED₁₂ include a pyrolyne ring, imidazoline ring, thiazoline ring, pyrazoline ring, oxazoline ring, indan ring, morphorine ring, indolyne ring, tetrahydro-1,4-oxazine ring, 2,3-dihydrobenzo-1,4-oxazine ring, tetrahydro-1,4-thiazine ring, 2,3-dihydrobenzo-1,4-thiazine ring, 2-3-dihydrobenzofuran ring, 2,3-dihydrobenzothiophene ring, in addition to those enumerated as ring structures formed by R₁₁₁ in the general formula (A). When ED₁₂ and RED₁₂ assume ring structures, preferable ED₁₂ represents an amino group, alkyl amino group, or arylamino group. Examples of ring structures formed by ED₁₂ include a tetrahydropyradine ring, piperazine ring, tetrahydroquinoxaline ring and tetrahydroisoquinoline ring. Examples of ring structures formed by R₁₂₂ and R₁₂₁ include a cyclohexane ring and cyclopentane ring.

The following is an explanation regarding the general formulae of (1) to (3).

In the general formulae (1) to (3), R₁, R₂, R₁₁, R₁₂ or R₃₁ are the same group meaning R₁₁₂ expressed in the general formula (A), with the same preferable scope. L₁, L₂₁ or L₃₁ represents the same desorption group meaning the group enumerated as an example of L₁₁ in the general formula (A), with the same preferable scope. The substituent represented by X₁ or X₂₁ is the same meaning the substituent formed when RED₁₁ of the formula (A) is provided with a substituent, with the same preferable scope. m₁ and m₂₁ are preferably an integer from 0 to 2, more preferably 0 or 1.

When R_{N1}, R_{N21} and R_{N31} represent substituents, preferable substituents include an alkyl group, aryl group, hetero cycle, and they may also be provided with any given substituents. R_{N1}, R_{N21} and R_{N31} include preferably a hydrogen atom, alkyl group or aryl group, and more preferably a hydrogen atom or alkyl group.

When R₁₃, R₁₄, R₃₃, Rₐ and R_{b} represent substituents, preferable substituents include an alkyl group, aryl group, acyl group, alkoxycarbonyl group, carbamoyl group, cyano group, alkoxy group, acylamino group, sulfonamide group, ureido group, thioureido group, alkylthio group, arylthio group, alkylsulfonyl group, arylsulfonyl group and sulfamoyl group.

In the general formula (1), the hexagonal rings formed by Z₁ is a hetero cycle of non-aromatic series condensed with benzene rings of the general formula (1), and specifically include a tetrahydroquinoline ring, tetrahydroquinoxaline ring and tetrahydroquinazoline ring, and more preferably a tetrahydroquinoline ring and tetrahydroquinoxaline ring. They may be provided with a substituent.

ED₂₁ in the general formula (2) is the same group meaning ED₁₂ expressed in the general formula (B), with the same preferable scope.

In the general formula (2), any two of R_{N21}, R₁₃, R₁₄, X₂₁ and ED₂₁ may bond with each other to form a ring structure. The ring structure formed by bonding of R_{N21} with X₂₁ is preferably carbon rings or hetero cycles of pentagonal to heptagonal non-aromatic series condensed with benzene ring, and these examples include a tetrahydroquinoline ring, tetrahydroquinoxaline ring, indoline ring and 2,3-dihydro-5,6-benzo-1,4-thiazine ring, and more preferably include a tetrahydroquinoline ring, tetrahydroquinoxaline ring and indoline ring.

When R_{N31} represents a group other than an aryl group in the general formula (3), Rₐ, and R_{b} bond with each other to form an aromatic ring. The aromatic ring hereof includes an aryl group (for example, a phenyl group, naphthyl group) and aromatic hetero cycle groups (for example, a pyridine ring group, pyrrole ring group, quinolne ring group, indole ring group), and preferably aryl group. The said aromatic ring groups may be provided with any given substituent.

It is preferable that Rₐ, and R_{b} in the general formula (3) bond with each other to form an aromatic ring (particularly a phenyl group).

In the general formula (3), preferable R₃₂ includes a hydrogen atom, alkyl group, aryl group, hydroxy group, alkoky group, mercapto group and amino group. Where R₃₂ represents a hydroxy group, it is also preferable that R₃₃ represents an “electron-imparting group.” “The electron-imparting group” hereof is the same as that explained in the previous paragraph, and preferably includes an acyl group, alkoxycarbonyl group, carbamoyl group and cyano group.

Next, the type 2 compound is explained as follows.

“Bond and cleavage reaction” in the type 2 compound means cleavage of reactions between carbon-carbon, carbon-silicon, carbon-hydrogen, carbon-boron, carbon-tin and carbon-germanium, and the cleavage of carbon-hydrogen bond may be associated.

The type 2 compound is that having 2 or more (preferably, 2 to 6, more preferably 2 to 4) adsorption groups to silver halide inside the molecule. More preferable compounds of type 2 are those having, as an adsorption group, a nitrogen-containing hetero cycle group substituted with 2 or more mercapto groups. The number of adsorption groups is preferably 2 to 6 and more preferably 2 to 4. The adsorption group will be described later.

Among the compounds of type 2, a preferable compound is shown in the general formula (C).

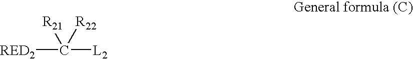

The compound expressed in the general formula (C) is that capable of causing a spontaneous desorption of L₂ through bond and cleavage reaction after oxidation of one electron of the reduction group represented by RED₂, thus releasing one more electron.

In the general formula (C), RED₂ represents the same group meaning RED₁₂ in the general formula (B), with the same preferable scope. L₂ represents the same group in the meaning that explained regarding L₁₁ in the general formula (A), with the same preferable scope. Where L₂ represents a silyl group, said compound is such that a nitrogen-containing hetero cycle group substituted with 2 or more mercapto groups is provided as an adsorption group. R₂₁ and R₂₂ respectively represent a hydrogen atom and a substituent, and are the same group meaning R₁₁₂ of the general formula of (A), with the same preferable scope. RED₂ and R₂₁ may bond with each other to form a ring structure.

The ring structure formed herein is a carbon ring or a hetero cycle of non-aromatic series that is pentagonal to heptagonal, mono-cyclic or condensed ring. The structure may be provided with a substituent. The said ring structure is not a ring structure corresponding to tetrahydron, hexahydron or octahydron of an aromatic ring or aromatic hetero cycle. Preferable ring structures include those corresponding to the dihydron of an aromatic ring and aromatic hetero cycle. For example, they include a 2-pyrolyne ring, 2-imidazoline ring, 2-thiazoline ring, 1,2-dihydropyridine ring, 1,4-dihydropyridine ring, indoline ring, benzoimidazoline ring, benzothiazoline ring, benzoxazoline ring, 2,3-dihydrobenzothiophene ring, 2-3-dihydrobenzofuran ring, benzo-α-pyran ring, 1,2-dihydroquinoline ring, 1,2-dihydroquinazoline ring, 1,2-dihydroquinoxaline ring, and preferably include 2-imidazoline ring, 2-thiazoline ring, indoline ring, benzoimidazoline ring, benzothiazoline ring, benzoxazoline ring, 1,2-dihydropridine ring, 1,2-dihydroquinoline ring, 1,2-tetrahydroquinazoline ring, 1,2-dihydroquinoxaline ring, and more preferably include an indoline ring, benzoimidazoline ring, benzothiazoline ring, 1,2-dihydroquinoline ring, and particularly preferably include an indoline ring.

Next, the type 3 compound is explained as follows.

In the type 3 compound, “the bond formation process” means formation of links between atoms such as carbon-carbon, carbon-nitrogen, carbon-sulfur and carbon-oxygen.

Type 3 compounds are such that after one electron oxidant produced by oxidation of one electron reacts with intramolecularly coexisting reactive group sites (double link site of carbon-carbon, triple link site of carbon-carbon, aromatic base site or non-aromatic hetero cycle site of benzo-condensed ring) to form binding, the electron is able to release additionally 1 or more electrons.

To be more specific, the type 3 compounds are such that one electron oxidant produced by oxidation of one electron (cation radical group or neutral radical group produced therefrom by desorption of proton) reacts with the above reactive group coexisting in the same molecule to form a binding, thus resulting in formation of a radical group having a new ring structure in the molecule, and the second electron is released directly from the radical group or in association with the desorption of proton. Further, in some of the type 3 compounds, the subsequently-produced two electron oxidants are able to release one or more electrons, usually two or more electrons, after the said subsequent production, or after hydrolysis reaction or in association with tautomerization usually involved in direct transfer of protons. There are other compounds wherein two electron oxidants are able to release additionally one or more electrons, ordinarily two or more electrons directly and not through tautomerization.

A preferable type 3 compound is shown in the general formula (D).

RED₃-L₃-Y₃ General formula (D)

In the general formula (D), RED₃ represents a reduction site capable of undergoing one electron oxidation, Y₃ represents a reactive group site, which reacts after RED₃ is oxidized by one electron, specifically represents organic groups including a carbon-carbon double bond site, carbon-carbon triple bond site, aromatic group site or hetero ring group site of benzo-condensed non-aromatic series. L₃ represents a coupling group of RED₃ with Y₃.

RED₃ represents the same group as RED₁₂ in the general formula (B), preferably, an arylamino group, hetero cycle amino group, aryloxy group, arylthio group, aryl group and hetero cycle of aromatic or non-aromatic series (particularly nitrogen-containing hetero ring group), and more preferably an arylamino group, hetero cycle amino group, aryl group, hetero cycle group of aromatic or non-aromatic series. Preferably hetero cycle groups include a tetrahydroquinoline ring group, tetrahydroquinoxaline ring group, tetrahydroquinazoline ring group, indoline ring group, indole ring group, carbazole ring group, phenoxazine ring group, phenothiazine ring group, benzothiazoline ring group, pyrrole ring group, imidazole ring group, thiazole ring group, benzoimidazole ring group, benzoimidazoline ring group, benzothiazoline ring group, 3,4-methylenedioxyphenyl-1-yl group.

Particularly preferable RED₃ includes an arylamino group (particularly anilino group), aryl group (particularly phenyl group) and a hetero ring group of aromatic or non-aromatic series.

When RED₃ represents an aryl group, it is desirable that the aryl group should have at least one “electron-imparting group.” “The electron-imparting group” is the same as the one previously explained.

When RED₃ represents an aryl group, a substituent of said aryl group includes more preferably an alkylamino group, hydroxy group, alkoxy group, mercaputo group, sulfoneamid group, active methine group, non-aromatic nitrogen-containing hetero cycle group substituted with nitrogen atom, still more preferably, an alkylamino group, hydroxy group, active methine group, non-aromatic nitrogen-containing hetero cycle group substituted with nitrogen atom, and, most preferably, an alkylamino group and non-aromatic nitrogen-containing hetero cycle group substituted with a nitrogen atom.

When organic groups containing carbon-carbon double bond sites (for example, vinyl group) represented by Y₃ are provided with substituents, the said substituents include preferably an alkyl group, phenyl group, acyl group, cyano group, alkoxycarbonyl group, carbamoyl group, electron-imparting groups, and said electron-imparting groups preferably include an alkoxy group, hydroxy group (those protected with silyl group are also preferable such as a trimethylsilyloxy group, t-butyldimethylsilyloxy group, triphenysilyloxy group, triethylsilyloxy group, phenyldimethylsilyloxy group), amino group, alkylamino group, arylamino group, sulfoneamide group, active methine group, mercapto group, alkylthio group and phenyl group having these electron-imparting groups as substituents.

When an organic group containing carbon-carbon double bond sites is provided with a hydroxyl group, Y₃ is interpreted to contain the previously-explained partial structure: >C₁=C₂ (—OH)—, and the partial structure after tautomerization: >C₁H—C₂₍₋O)— is also acceptable. It is also preferable that said C₁-substituting substituent is an electron-attracting group. In this instance, Y₃ is interpreted to possess the partial structure of an “active methylene group” or “active methine group.” Said electron-attracting group that imparts the partial structure of an active methylene group or of an active methine group is the same as that explained in the previous paragraph of “the active methine group.”

When an organic group containing carbon-carbon triple bond sites represented by Y₃ (for example, ethynyl group) is provided with a substituent, said substituent includes preferably an alkyl group, phenyl group, alkoxycarbonyl group, carbamoyl group and electron-imparting group.

When Y₃ represents an organic group containing an aromatic group site, said aromatic group includes preferably an aryl group (particularly phenyl group) or indole group having an electron-imparting group as a substituent, and said electron-imparting group preferably include a hydroxy group (that protected with silyl group is also acceptable), alkoxy group, amino group, alkylamino group, active methine group, sulfoneamind group and mercapto group.

When Y₃ represents an organic group containing a hetero cycle site of benzo-condensed non-aromatic series, said benzo-condensed non-aromatic hetero cycle groups are preferably those in which the aniline structure is retained as a partial structure, for example, an indoline ring group, 1,2,3,4-tetrahydroquinoline ring group, 1,2,3,4-tetrahydroquinoxaline ring group and 4-quinolone ring group.

The reactive group represented by Y₃ includes preferably a carbon-carbon double bond site, aromatic group site and organic group that contains benzo-condensed non-aromatic hetero cycle group, and more preferably a carbon-carbon double bond site, phenyl group having an electron-imparting group as a substituent, indole ring group and benzo-condensed non-aromatic hetero cycle group in which the aniline structure is present as a partial structure. The carbon-carbon double bond site hereof is more preferably provided with at least one electron-imparting group as a substituent.

The compound wherein the reactive group represented by Y₃ is provided with the same partial structure with the reduction group represented by RED₃, as a result of selection made from the scope as explained previously, is another preferable compound represented by the general formula (D).

L₃ represents a coupling group of RED₃ with Y₃, and specifically representing a single bond, alkylene group, arylene group, and single or any combined group of —O—, —S—, —NR_{N}—, —C(═O)—, —SO₂—, —SO—, —P(═O)—. In this instance, R_{N} represents a hydrogen atom, alkyl group, aryl group or hetero cycle group. The coupling group represented by L₃ may be provided with any given substituent. The coupling group represented by L₃ can be coupled in such a way that it is individually substituted with any one hydrogen atom at any given site represented by RED₃ and Y₃.

Preferable examples of L₃ include a single bond, alkylene group (particularly, methylene group, ethylene group, propylene group), arylene group (particularly phenylene group), single group of —C(═O)— group, —O— group, —NH— group, or —N (alkyl group)— group and divalent coupling groups of these combinations.

In the case of the group represented by L₃, when a cation radical group (X⁺.) produced through oxidation of RED₃ or a radical group (X.) produced therefrom in association with desorption of a proton reacts with a Y₃-expressed reactive group to form a linkage, it is preferable that atomic groups involved in the linkage formation are able to form trigonal to heptagonal ring structures including L₃. For this purpose, it is preferable that the radical group (X⁺. or X.), Y-expressed reactive group and L are coupled with 3 to 7 atomic groups.

Next, the type 4 compounds are explained as follows.

The type 4 compounds are those having a ring structure wherein a reduction group is substituted and, after said reduction group undergoes oxidation of one electron, one or more electrons can be released in association with the cleavage reaction of the ring structure. The cleavage reaction of the ring structure hereof means a reaction that will proceed as shown in the figure below.

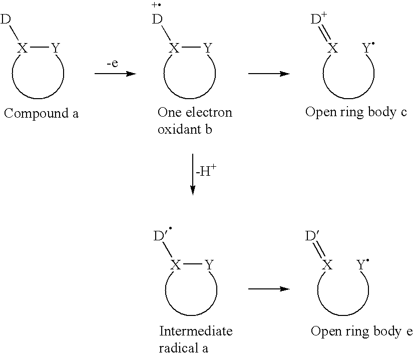

In the figure, the compound a represents a compound of type 4. In the compound a, D represents a reduction group, while X and Y represent atoms that form the linkage to be cleaved after oxidation of one electron in the ring structure. First, the compound a is subjected to oxidation of one electron to form one electron oxidant b. Then, D-X mono bond changes into double bond, and at the same time the X-Y linkage is cut to form an open ring body c. There is another case where intermediate radial d is formed from one electron oxidant b in association with desorption of a proton, from which the open ring body e is formed. The compounds according to the invention are characterized in that one or more electrons are continuously released from thus-formed open ring bodies c or e.

The ring structure assumed by the type 4 compounds are a trigonal to heptagonal carbon ring or hetero cycle structures and mono-cyclic or condensed-rings, saturated or unsaturated non-aromatic rings, preferably saturated ring structures and more preferably trigonal or tetragonal rings. The ring structures include preferably a cyclopropane ring, cyclobutane ring, oxirane ring, oxetane ring, aziridine ring, azetidine ring, episulfide ring, thietane ring, more preferably a cyclopropane ring, cyclobutane ring, oxirane ring, oxetane ring and azetidine ring, and particularly preferably a cyclopropane ring, cyclobutane ring and azetidine ring. The ring structures may be provided with any given substituents.

The type 4 compounds are preferably expressed in the formula (E) or (F)

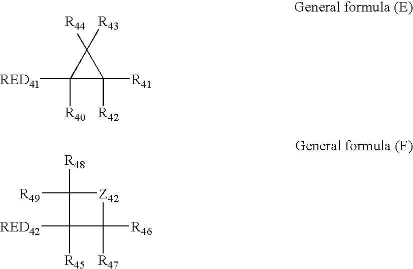

In the general formulae (E) and (F), RED₄₁ and RED₄₂ are respectively the same groups meaning RED₁₂ in the general formula (B), with the same preferable scope. R₄₀ to R₄₄ and R₄₅ to R₄₉ respectively represent hydrogen atoms and substituents. In the general formula (F), Z₄₂ represents —CR₄₂₀, R₄₂₁—, —NR₄₂₃—, or —O—. In this instance, R₄₂₀ and R₄₂₁ independently represent a hydrogen atom and a substituent, while R₄₂₃ represents a hydrogen atom, an alkyl group, an aryl group or a hetero cycle group.

In the general formulae (E) and (F), R₄₀ and R₄₅ include preferably a hydrogen atom, alkyl group, aryl group and hetero cycle group, and more preferably a hydrogen atom, alkyl group and aryl group. R₄₁ to R₄₄ and R₄₆ to R₄₉ include preferably a hydrogen atom, alkyl group, alkenyl group, aryl group, hetero cycle group, arylthio group, alkylthio group, acylamino group and sulfonamide group, and more preferably a hydrogen atom, alkyl group, aryl group and hetero cycle group.

It is preferable that, at least one of R₄₁ to R₄₄, is a donor-like group or either R₄₁/R₄₂ or R₄₃/R₄₄ are an electron-attracting group. It is more preferable that at least one of R₄₁ to R₄₄ is a donor-like group. It is still more preferable that at least one of these R₄₁ to R₄₄ is a donor-like group while those not the donor-like are a hydrogen atom or an alkyl group.

The donor-like group hereof is an “electron-imparting group” or aryl group that is substituted with at least one “electron-imparting group.” Preferably-used donor-like groups include an alkylamino group, arylamino group, hetero cycle amino group, pentagonal, mono-cyclic or condensed ring electron-excess aromatic hetero cycle group, nitrogen-containing hetero cycle group of non-aromatic series substituted with a nitrogen atom, and phenyl group substituted with at least one electron-imparting group. More preferably usable are an alkylamino group, arylamino group, pentagonal mono-cyclic or condensed ring electron-excess aromatic hetero cycle group that contains at least one nitrogen atom inside the ring (indole ring, pyrole ring and carbazole ring, etc.) and a phenyl group substituted with an electron-imparting group (phenyl group substituted with 3 or more alkoxy groups or a phenyl group substituted with a hydroxy group or alkylamino group or arylamino group). Particularly preferably used are an arylamino group, pentagonal mono-cyclic or condensed ring electron-excess aromatic hetero cycle group that contains at least one nitrogen atom inside the ring (particularly 3-indolyl group) and a phenyl group substituted with an electron-imparting group (particularly, a phenyl group substituted with a trialkoxyphenyl group, alkyamino group or arylamino group).

Z₄₂ include preferably —CR₄₂₀R₄₂₁— or —NR₄₂₃—, and more preferably —NR₄₂₃—. R₄₂₀ and R₄₂₁ include preferably a hydrogen atom, alkyl group, aryl group, hetero cycle group, acylamino group, sulfonamide, and more preferably a hydrogen atom, alkyl group, aryl group, hetero cycle group. R₄₂₃ includes preferably a hydrogen atom, alkyl group, aryl group and aromatic hetero cycle group, and more preferably a hydrogen atom, alkyl group and aryl group.

Where R₄₀ to R₄₉ and R₄₂₀, R₄₂₁ and R₄₂₃ are individually substituents, each of which is preferably 40 or less in a total carbon number, more preferably 30 or less and particularly preferably 15 or less. These substituents may bond with each other or with other parts (RED₄₁, RED₄₂ or Z₄₂) in the molecule to form rings.

The silver halide-adsorbing group in the type 1 to 4 compounds of the invention include a group directly adsorbing a silver halide or a group promoting adsorption to a silver halide. Specifically, it includes a mercapto group (or its salt), thione group (—C(═S)—), hetero cycle group containing at least one atom selected from any of a nitrogen atom, sulfur atom, selenium atom or tellurium atom, sulfide group, cation-like group, ethynyl group, however, the type 2 compounds of the invention do not include a sulfide group as an adsorption group.

Mercapto group (or its salt) as an adsorption group means a mercapto group (or its salt) per se, and more preferably a hetero cycle group, aryl group or alkyl group in which at least one of the mercapto group (or its salt) is substituted.

The hetero cycle group hereof means a hetero cycle group of pentagonal to heptagonal, mono-cyclic or condensed-ring aromatic or non-aromatic series, and examples include imidazole ring group, thiazole ring group, oxazole ring group, benzimidazole ring group, benzthiazole ring group, benzoxazole ring group, triazole ring group, thiadiazole ring group, oxadiazole ring group, tetrazole ring group, purine ring group, pyridine ring group, quinoline ring group, isoquinoline ring group, pyrimidine ring group, and a triazine ring group. A hetero cycle group that contains a quaternary nitrogen atom may be acceptable, and in this instance, it is also acceptable that a substituted mercapto group undergoes dissociation to give meso-ion. Such hetero cycle group examples include an imidazolium ring group, pyrazolium ring group, thiazolium ring group, triazolium ring group, tetrazolium ring group, thiadiazolium ring group, pyridinium ring group, pyrimidinum ring group and triazonium ring group. Among these groups, a triazolium ring group (for example, 1,2,4-triazolium-3-thiolate ring group) is preferable. Aryl group includes a phenyl group and naphthyl group. Alkyl group includes straight-chained, branched or circular alkyl groups with a carbon number of 1 to 30. Counter ions on formation of salt by a mercapto group include cations such as alkaline metal, alkaline earth metal and heavy metal (Li⁺, Na⁺, K⁺, Mg2⁺, Ag⁺, Zn²⁺, etc.), ammonium ion, hetero cycle group that contains a quaternary nitrogen atom, and phosphonium ion.

Mercapto group as an adsorption group may be a thione group after tautomerization, and specifically includes a thioamide group (in this instance, —C(═S)—NH— group) and the partial structure of said thioamide group. More particularly, they include a chain-like or circular thioamide group, thioureido group, thiourethane group and dithiocarbamic acid ester group. In this instance, examples of the circular group include a thiazolidine-2-thione group, oxazolidine-2-thione group, 2-thiohydantoin group, rhodanine group, isorhodanine group, thiobarbituric acid group, and a 2-thioxo-oxazolidine-4-on group.

Thione group as an adsorption group includes a chain-like or circular thioamide group, thioureido group, thiourethane group, and dithiocarbamic acid ester group, which can not undergo tautomerization to yield mercapto group (no hydrogen atom at α site of thione group), in addition to the case where the above mercapto group undergoes tautomerization to yield a thione group.

Hetero cycle group which contains at least one atom selected from any of a nitrogen atom, sulfur atom, selenium atom or tellurium atom as an adsorption group is either a nitrogen-containing hetero cycle group having an —NH— group capable of forming imino silver (>NAg) as a partial structure of the hetero cycle, or a hetero cycle group having an “—S—” group, “—Se—” group, “—Te—” group or “═N— ” group capable of binding with silver ion through a coordinate bond. The former examples include a benzotriazole group, triazole group, indazole group, pyrazole group, tetrazole group, benzoimidazole group, imidazole group, purine group, whereas the latter examples include a thiophene group, thiazole group, oxazole group, benzothiazole group, benzoxazole group, thiadiazole group, oxadiazole group, triadine group, selenoazole group, benzselenoazole group, telluriumazole group and a benztelluriumazole group. In the invention, the former examples are preferable.

Sulfide group as an adsorption group includes all those having a partial structure of “—S—”. Preferable sulfide groups are those having a partial structure of alkyl (or alkylene)-S-alkyl (or alkylene), aryl (or arylene)-S-alkyl (or alkylene), aryl (or arylene) —S-aryl (or arylene). These sulfide groups may also be provided with ring structures or an “—S—S—” group. Examples of ring structure formation are groups comprising a thiolane ring, 1,3-dithiolane ring or 1,2-dithiolane ring, thiane ring, dithiane ring and tetrahydro-1,4-thiadine ring (thiomorphorine ring). Particularly preferable sulfide groups are those having a partial structure of alkyl (or alkylene) —S-alkyl (or alkylene).

Cation-like group as an adsorption group means a group that contains a quaternary nitrogen atom, and examples are those including an ammonio group and nitrogen-containing hetero cycle group that contains a quaternary nitrogen atom, however, said cation-like group is assumed not to become a part of the atomic group that forms a dye structure (for example, cyanine chromophore). The ammonio groups hereof include a trialkylammonio group, dialkyldiarylammonio group and alkylarylammonio group. The examples include a benzildimethylammonio group, trihexylammonio group, phenyldiethylammonio group and others. Nitrogen-containing hetero cycle groups that contain a quaternary nitrogen atom are, for example, a pyrijinio group, quinolio group, isoquinolinio group and imidazolio group, preferably, a pyridinio group and imidazolinio group and, particularly preferably, pyridinio group. The nitrogen-containing hetero cycle groups that contain a quaternary nitrogen atom may be provided with any given substituents. Preferable substituents for a pyridinio group and imidazolio group include an alkyl group, aryl group, acylamino group, chloro-atom, alkoxycarbonyl group and carbamoyl group. A particularly preferable substituent for pyridinio includes a phenyl group.

Ethynyl group as an adsorption group means a —C═CH group wherein a hydrogen atom may be substituted.

Said adsorption group may be provided with any given substituent.

Further examples of the adsorption group are those disclosed on pages 4 through 7 in the specification of JP-A No. 11-95355.

Preferable adsorption groups in the invention include a mercapto-substituted nitrogen-containing hetero cycle group (for example, a 2-mercaptothiadiazole group, 3-mercapto-1,2,4-triazole group, 5-mercaptotetrazole group, 2-mercapto-1,3,4-oxadiazole group, 2-mercaptobenzoxazole group, 2-mercaptobenzothiazole group, 1,5-dimethyl-1,2,4-triazolium-3-thiolate group) or nitrogen-containing hetero cycle group having a —NH— group capable of forming imino silver (>NAg) as a partial structure of the hetero cycle (for example, a benzotriazole group, benzoimidazole group, indazole group) Particularly preferable adsorption groups include a 5-mercaptotetrazole group, 3-mercapto-1,2,4-triazole group and benzotriazole group, and the most preferable adsorption groups include 3-mercapto-1,2,4-triazole group and 5-mercaptotetrazole group.

Of the compounds according to the invention, particularly preferable compounds are those having 2 or more mercapto groups in the molecule as a partial structure. The mercapto group (—SH) hereof may be a thione group where tautomerization is possible. Examples of these compounds may be those having the molecule 2 or more adsorption groups (for example, ring-forming thioamide group, alkylmercapto group, arylmercapto group or hetero cycle mercapto group) and having the sofar mentioned mercapto groups or thione groups as a partial structure. They may be also provided with one or more adsorption groups (for example, dimercapto-substituted nitrogen-containing hetero cycle group) having, as a partial structure, 2 or more mercapto groups or thione groups.

Examples of adsorption groups (dimercapto-substituted nitrogen-containing hetero cycle group) having 2 or more mercapto groups as a partial structure include a 2,4-dimercaptopyrimidine group, 2,4-dimercaptotriazine group, 3,5-dimercapto-1,2,4-triazole group, 2,5-dimercapto-1,3-thiazole group, 2,5-dimercapto-1,3-oxazole group, 2,7-dimercapto-5-methyl-s-triazolo (1,5-A)-pyrimidine, 2,6,8-trimercaptopurine, 6,8-dimercaptopurine, 3,5,7-trimercapto-s-triazotriadine, 4,6-dimercaptopyrazolopyrimidine, and 2,5-dimercaptoimidazole. Particularly preferable examples include a 2,4-dimercaptopyrimidine group, 2,4-dimercaptotriazine group and 3,5-dimercapto-1,2,4-triazole group.

The adsorption groups may be substituted at any site in the general formulae (A) to (F) and general formulae (1) to (3). It is, however, preferable that substitution is given to RED₁₁, RED₁₂, RED₂ and RED₃ in the general formulae (A) to (D) and to RED₄₁, R₄₁, RED₄₂ and R₄₆ to R₄₈ in the general formulae (E) and (F), and to any site excluding R₁, R₂, R₁₁, R₁₂, R₃₁, L₁, L₂₁ and L₃₁ in the general formulae (1) to (3). It is more preferable that substitution is given to RED₁. to RED₄₂ in all the general formulae (A) to (F).

The partial structure of a spectral sensitization dye is a group containing chromophore of a spectral sensitization dye, namely, a residual group excluding any given hydrogen atoms or substituents from spectral sensitization dye compounds. The partial structure of a spectral sensitization dye may be substituted at any site in the general formulae (A) to (F) and general formulae (1) to (3). It is, however, preferable that substitution is given to RED₁₁, RED₁₂, RED₂ and RED₃ in the general formulae (A) to (D) and to RED₄₁, R₄₁, RED₄₂ and R₄₆ to R₄₈ in the general formulae (E) and (F), and to any site excluding R₁, R₂, R₁₁, R₁₂, R₃₁, L₁, L₂₁ and L₃₁ in the general formulae (1) to (3). It is more preferable that substitution is given to RED₁₁ to RED₄₂ in all the general formulae (A) to (F). Preferable spectral sensitization dyes are those typically used in a color sensitization method, and examples include cyanine dyes, complicated cyanine dyes, merocyanine dyes, complicated merocyanine dyes, homopolar cyanine dyes, styryl dyes and hemicyanine dyes. Representative spectral sensitization dyes are disclosed in Research Disclosure, Item 36544, September 1994. Those skilled in the art are able to synthesize these dyes according to the procedures described in the Research Disclosure or The Cyanine Dyes and Related Compounds (Interscience Publsihers, New York, 1964) authored by F. M. Hammer. These dyes are all addressed on pages 7 through 14 in the specification of JP-A No. 11-95355 (U.S. Pat. No. 6,054,260).

The type 1 to 4 compounds of the invention are preferably 10 to 60 in a total carbon number, more preferably 15 to 50 and particularly preferably 18 to 30.

The type 1 to 4 compounds of the invention undergo oxidation of one electron upon exposure of silver halide photosensitive materials wherein these compounds are used, releasing additionally one electron or two or more electrons depending on the type of compounds, following the subsequent reaction, with the continuous oxidation. The oxidation potential of the first electron is preferably approx. 1.4 V or less and more preferably 1.0 V or less. The oxidation potential is preferably higher than 0 V and more preferably higher than 0.3 V. Therefore, the oxidation potential is in a range of approx. 0 to 1.4 V and more preferably in a range of approx. 0.3 V to 1.0 V.

The oxidation potential can be measured by a technique of cyclic voltammetry. More particularly, specimens are dissolved in a solution of acetonitrile: water (including 0.1M lithium perchloride)=80%:20% (% by volume) and subjected to aeration with nitrogen gas for 10 minutes. Then, a glass carbon disk is used as an operating electrode, platinum wire as a pair electrode and calomel electrode (SCE) as a reference electrode in the thus prepared resultant to determine the oxidation potential at 0.1 V/second potential scanning velocity at 25° C. Oxidation potential counter SCE is determined at the peak potential of a cyclic voltammetry wave.

Where the type 1 to 4 compounds of the invention are those undergoing oxidation of one electron, releasing additionally one electron, after the subsequent reactions, the oxidation potential at the subsequent stage is preferably from −0.5 V to −2 V, and more preferably from −0.7 V to −2 V, and still more preferably from −0.9 V to −1.6 V.

Where the type 1 to 4 compounds of the invention are those undergoing oxidation of one electron, releasing additionally 2 or more electrons after the subsequent reactions, with continuous oxidation, there are no restrictions in oxidation potential at the subsequent stage. This is because it is often difficult to exactly determine the oxidation potentials of the second and third electrons for their discrimination.

The type 5 compound is now explained as follows.

The compound is represented by X-Y wherein X represents a reduction group while Y represents a desorption group and one electron oxidant produced by oxidation of one reduction group represented by X is able to produce X radical through desorption of Y in association with subsequent cleavage reaction of X-Y bond and to release additionally 1 more electron therefrom. The reaction on oxidation of the type 5 compound can be represented by the following formula.

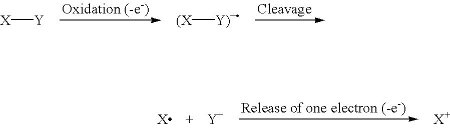

In the type 5 compound, the oxidation potential is preferably 0 to 1.4 V and more preferably 0.3 V to 1.0 V. Regarding the radical X formed in the above reaction formula, the oxidation potential is preferably −0.7 V to −2.0 V, and more preferably −0.9 V to −1.6 V.

The type 5 compound is preferably expressed in the general formula (G).

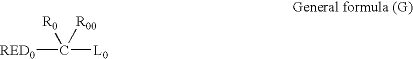

In the general formula (G), REDO represents a reduction group, L₀, a desorption group, and R₀ and R₀₀, a hydrogen atom or a substituent. RED₀ and R₀ as well as R₀ and R₀₀ may react with each other to form a ring structure. RED₀ is the same group meaning RED₂ described in the general formula (C), with the same preferable scope. R₀ and R₀₀ are the same group meaning R₂₁ and R₂₂ expressed in the general formula (C), with the same preferable scope. However, R₀ and R₀₀ do not represent the same group meaning L₀ except a hydrogen atom. RED₀ and R₀ may bond with each other to form a ring structure. Examples of said ring structures are the same examples in which RED₂ and R₂₁ are coupled to form the ring structure expressed in the general formula (C). The preferable scope is also the same. The examples of ring structures in which R₀ and R₀₀ bond with each other to form a ring structure include a cyclopentane ring and tetrahydrofuran ring. In the general formula (G), L₀ is the same group meaning L₂ described in the general formula (G) with the same preferable scope.

The compound represented by the general formula (G) preferably has a group adsorbing silver halide or a partial structure of a spectral sensitization dye in the molecule. However, where L₀ represents a group other than silyl group, said compound will not have 2 or more adsorption groups at the same time in the molecule. In this instance, the sulfide group as an adsorption group is not dependant on L₀ but may be provided with 2 or more L₀.

Silver halide adsorption groups contained in the compound expressed in the general formula (G) are exemplified as the same adsorption groups that may be contained in the type 1 to 4 compounds of the invention. In addition, the examples include all the adsorption groups of silver halide described on pages 4 through 7 in JP-A No. 11-95355 as “silver halide adsorption groups”, with the same preferable scope.

The partial structure of the spectral sensitization dye that may be contained in the compound represented by the general formula (G) is the same as the partial structure of the spectral sensitization dye that may be contained in the type 1 to 4 compounds of the invention. In addition, the examples include all the light absorption groups described on pages 7 through 14 in JP-A No. 11-95355, with the same preferable scope.

The following shows examples of the type 1 to 5 compounds of the invention, which are construed not to limit the scope of the invention.

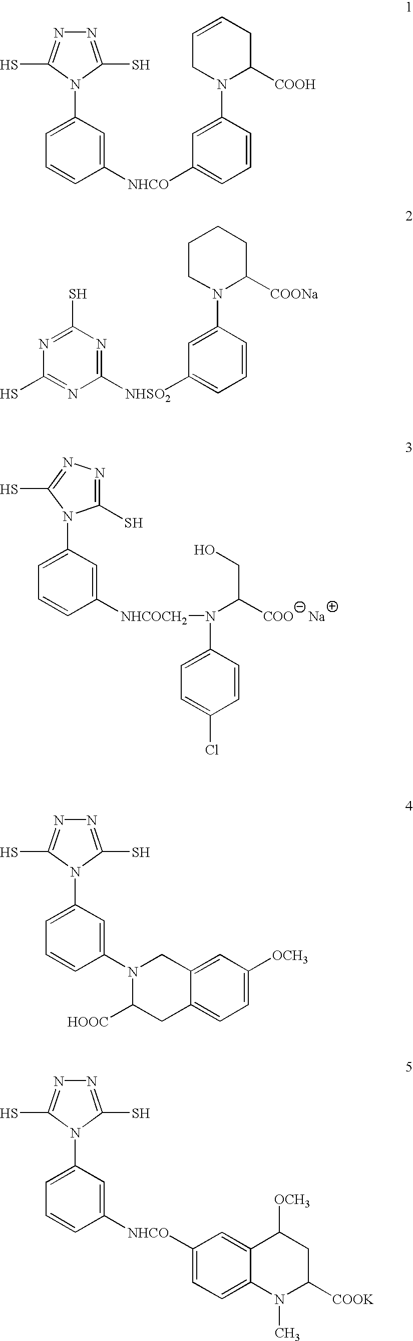

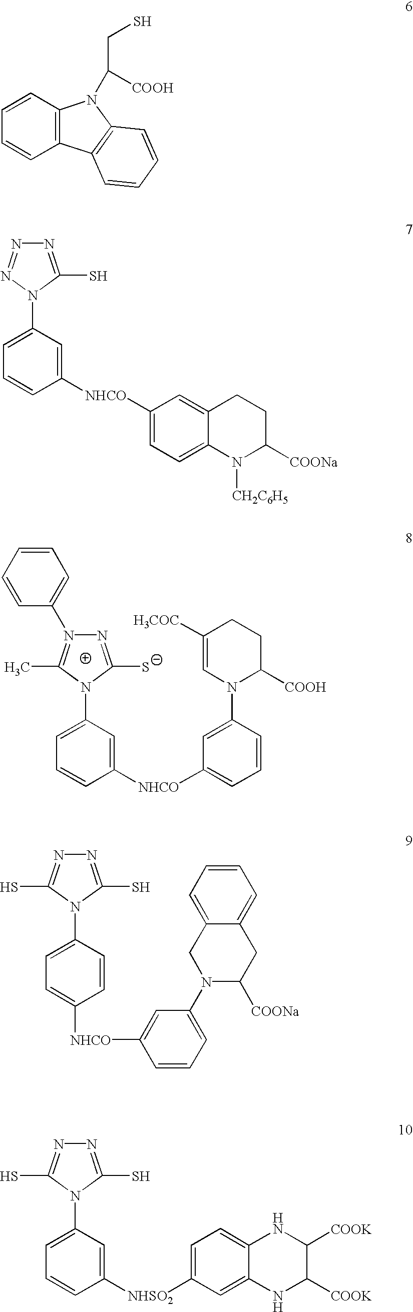

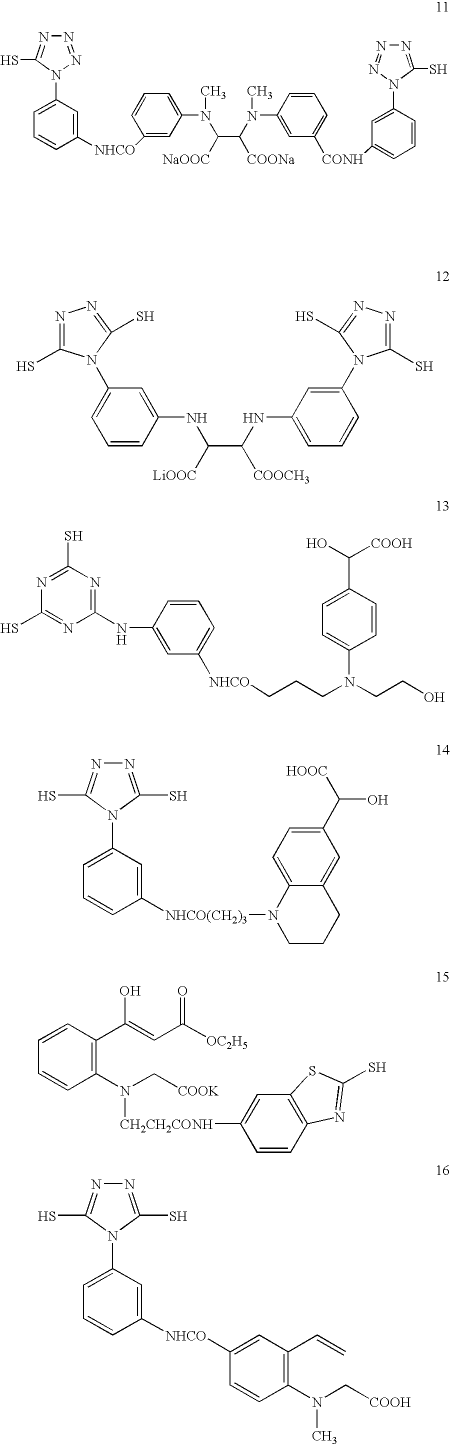

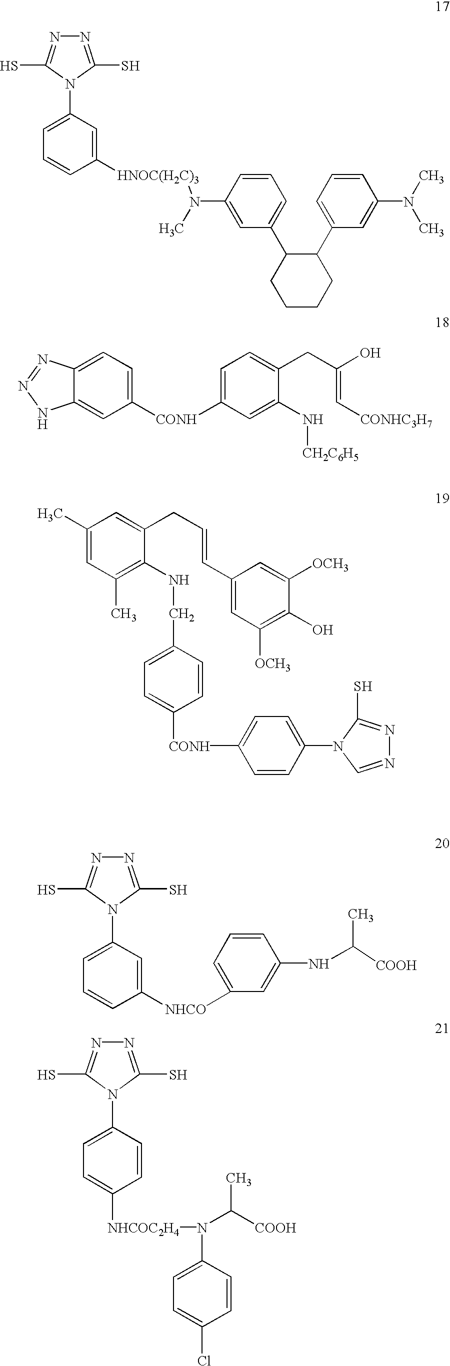

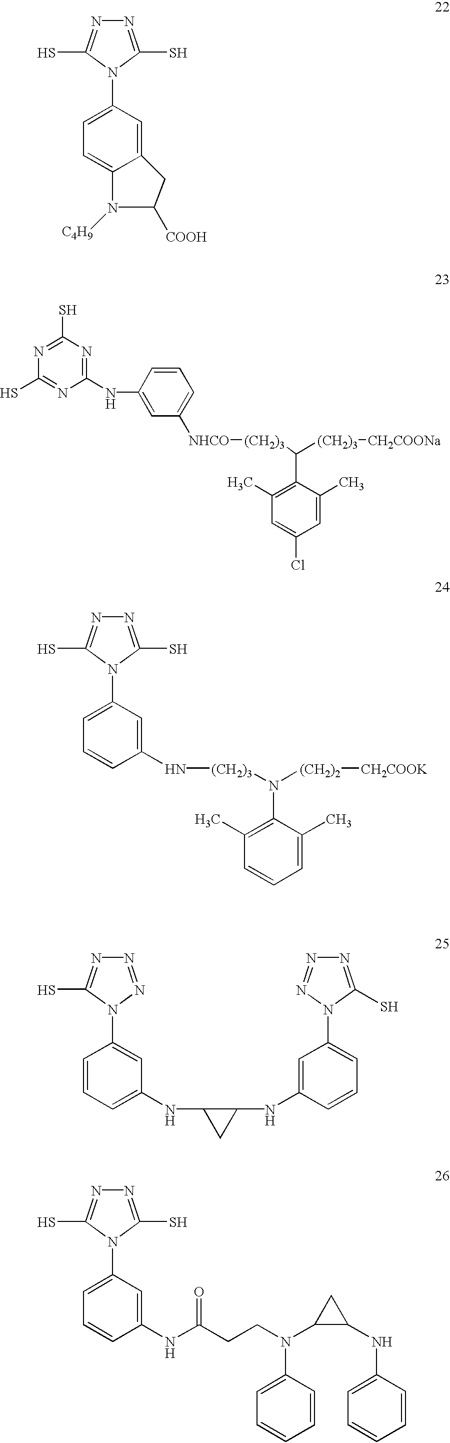

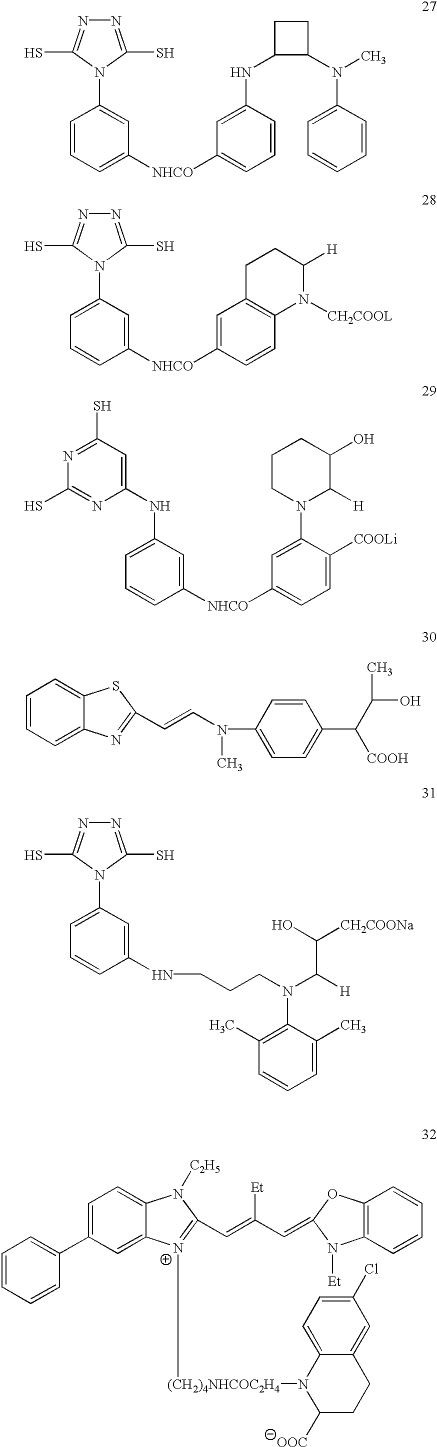

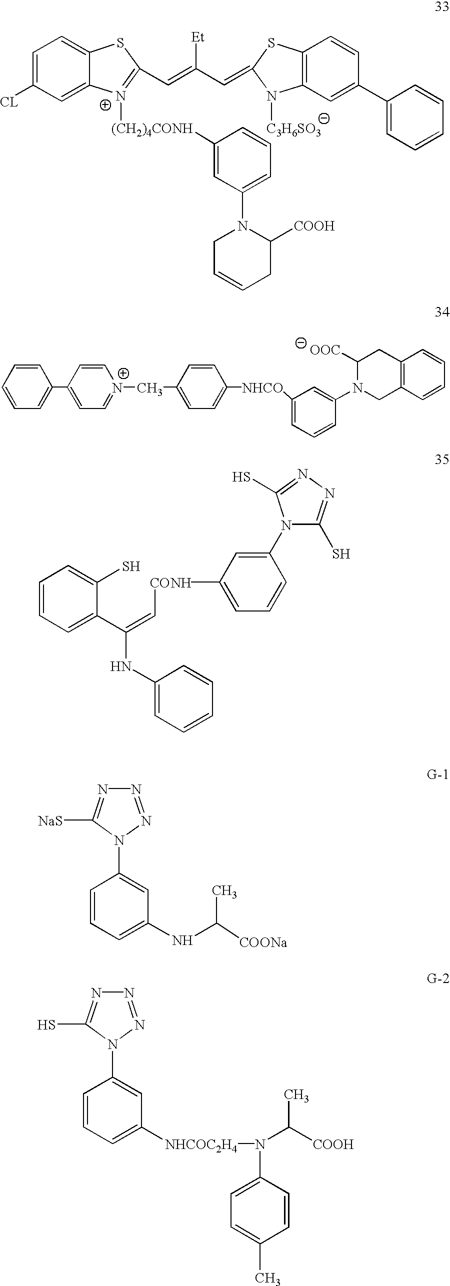

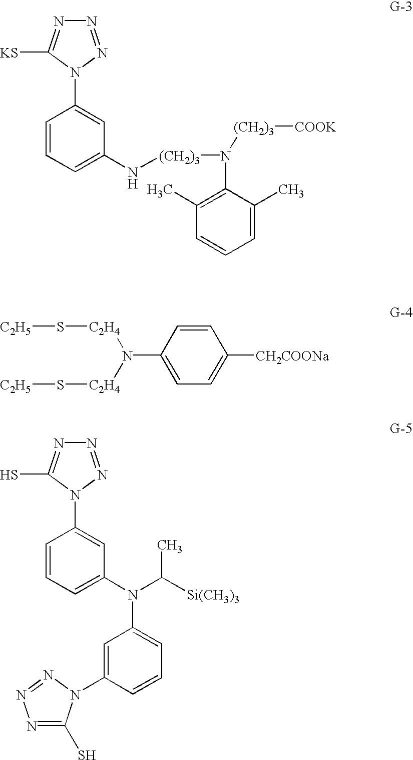

The type 1 to 4 compounds of the inventions are the same as those explained in details respectively in Japanese Patent Application Nos. 2002-192373, 2002-188537, 2002-188536, 2001-272137 and 2002-192374. The compounds specifically explained in the specifications of these patent applications are also examples of the type 1 to 4 compounds of the invention. The synthesized compounds of type 1 to 4 of the invention are also the same as those described in these patents.

The type 5 compounds of the invention are exactly embodied in JP-A No. 9-211769 (compounds PMT-1 to S-37 described in tables E and F on pages 28 through 32), JP-A No. 9-211774 and JP-A No. 11-95355 (compounds INV1 to 36), JP-W No. 2001-500996 (compounds 1 to 74, 80 to 87 and 92 to 122), U.S. Pat. No. 5,747,235, U.S. Pat. No. 5,747,236 and EP No. 786692A1 (compounds INNV1 to 35), EP No. 893732A1, U.S. Pat. No. 6,054,260 and U.S. Pat. No. 5,994,051 as compounds called “1 photon 2 electrons sensitizing agent” or “deprotonized electron-imparting sensitizing agent”.

The type 1 to 5 compounds of the invention may be used at any time while in a process of producing the photothermographic material or preparing photosensitive silver halide emulsions. The processes are, for example, those for granulation of photosensitive silver halide, for desalting, for chemical sensitization and prior to coating. The compounds may be added separately and at multiple times during these processes. They are preferably added during the time from completion of the granulation process of photosensitive silver halide to the process prior to desalting, or at the time of chemical sensitization (during the period from immediately before starting the process of chemical sensitization to immediately after the process) or before coating, and more preferably during the time from the process of chemical sensitization to the process prior to mixing with non-photosensitive organic silver salts.

The type 1 to 5 compounds of the invention are preferably added by dissolving in water or in a water-soluble solvent such as methanol and ethanol or their mixture. When a compound that can be more easily dissolved at increased or decreased pH is dissolved in water, said compound may be dissolved at higher or lower pH levels before addition of the solvent in water.

The type 1 to 5 compounds of the invention are preferably used in an image forming layer that contains photosensitive silver halide and non-photosensitive organic silver salt. It is also acceptable that these compounds are added to a surface-protective layer or an intermediate layer, in addition to the image forming layer that contains photosensitive silver halide and non-photosensitive organic silver salt, and allowed to disperse at the time of coating. The compounds of the invention may be added either before or after addition of the sensitization dye, and are incorporated into the silver halide emulsion layer preferably at a quantity from 1×10⁻⁹ to 5×10⁻¹ mol for one mol of silver halide and more preferably at a quantity from 1×10⁻⁸ to 5×10⁻² mol.

The photosensitive silver halide is added preferably at 0.03 to 0.6 g/m² in terms of the silver quantity coated for 1 m² of the sensitive material, more preferably at 0.07 to 0.4 g/m², and most preferably at 0.05 to 0.3 g/m². In terms of one mol of organic silver salt, the photosensitive silver halide is added preferably at a range of 0.01 mol or higher to 0.3 mol or lower, more preferably in a range of 0.02 mol or higher to 0.2 mol or lower, and still more preferably in a range of 0.03 mol or higher to 0.15 mol or lower.

Regarding methods and conditions for mixing photosensitive silver halide (separately prepared) and non-photosensitive organic silver salt (to be described later), they are effected by a method for mixing silver halide particles with organic silver salt, both of which are completed for preparation, by using a high speed mixer, ball mill, sand mill, colloid mill, vibrating mill, homogenizer, etc., or by other methods for mixing, at any process of preparing the organic silver salt, a preparation-completed photosensitive silver halide to prepare the organic silver salt.

As explained above, the photosensitive silver halide of the invention is preferably produced in the absence of non-photosensitive organic silver salts. Mixture of at least 2 types of organic silver salt water dispersions with at least 2 types of photosensitive silver salt water dispersions is a preferable method for adjusting photographic characteristics.

The silver halide of the invention is added to a coating liquid for an image forming layer preferably from 180 minutes before coating to immediately before coating and more preferably from 60 minutes before coating to 10 seconds before coating. There are no particular restrictions in the mixing methods and conditions, as long as the effect of the invention can be attained sufficiently.

Specifically, silver halide may be mixed in a tank in such way that a desired mean staying time can be attained from calculation based on the additive flow rate and the flow volume to coaters, or by using a static mixer described in the 8^{th} chapter of “Liquid Mixing Technology” authored by N. Harnby, M. F. Edwqrds and A. W. Nienow and translated by Koji Takahashi (published by Nikkan Kogyo Shinbun, 1989)

Compounds Represented by the General Formula (I)

A detailed explanation is made about the compounds represented by the following general formula (I) and used as photothermographic materials in the second aspect of the invention.

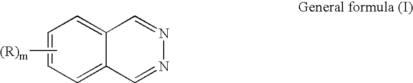

In the general formula (I), R represents a monovalent substituent, and m represents an integer from 1 to 4. When m is at least 2, plural Rs may be the same or different. Where plural Rs are kept adjacent, they may form aliphatic, aromatic and hetero cycles.

Incorporation of the compounds represented by the general formula (I) can prevent reduction in image concentration, when kept unwrapped, to give a better long time storability, thus offering a better image storability after thermal development. In particular, said effect can be satisfactorily obtained in the photothermographic materials that contain a highly iodized photosensitive silver halide according to the invention. In contrast, use of phthalizine in place of the compound represented by the general formula (I) can result in reduced image concentration when kept unwrapped and deteriorate the image storability of thermal development.

A detailed explanation is made about compounds represented by the general formula (I).

In the general formula (I), R represents a monovalent substituent. The substituent represented by R includes an alkyl group (preferably comprising 1 to 20 carbon atoms, more preferably comprising 1 to 12 carbon atoms, and particularly preferably comprising 1 to 8 carbon atoms, are exemplified as the following: methyl group, ethyl group, n-propyl group, iso-propyl group, n-butyl group, iso-butyl group, tert-butyl group, n-octyl group, n-decyl group, n-hexadecyl group, cyclopropyl group, cyclopentyl group, cyclohexyl group), alkenyl group (preferably comprising 2 to 20 carbon atoms, more preferably comprising 2 to 12 carbon atoms, and particularly preferably comprising 2 to 3 carbon atoms, for example, a vinyl group, allyl group, 2-butynyl group, 3-pentynyl group), alkynyl group (preferably comprising 2 to 20 carbon atoms, more preferably comprising 2 to 12 carbon atoms, and particularly preferably comprising 2 to 8 carbon atoms, for example, a propargyl group and 3-pentynyl group), aryl group (preferably comprising 6 to 30 carbon atoms, more comprising 6 to 20 carbon atoms, and particularly preferably comprising 6 to 12 carbon atoms, for example, a phenyl group, p-methyphenyl group and naphthyl group), amino group (preferably comprising 0 to 20 carbon atoms, more preferably comprising 0 to 10 carbon atoms, and particularly preferably comprising 0 to 6 carbon atoms, for example, an amino group, methylamino group, dimethylamino group, diethylamino group and dibenzilamino group), alkoxy group (preferably, comprising 1 to 20 carbon atoms, more preferably comprising 1 to 12 carbon atoms, and particularly preferably comprising 1 to 8 carbon atoms, for example, a methoxy group, ethoxy group, butoxy group), aryloxy group (preferably comprising 6 to 20 carbon atoms, more preferably comprising 6 to 16 carbon atoms, and particularly preferably comprising 6 to 12 carbon atoms, for example, a phenyoxy group and 2-naphthyloxy group), acyl group (preferably comprising 1 to 20 carbon atoms, more preferably comprising 1 to 16 carbon atoms, and particularly preferably comprising 1 to 12 carbon atoms, for example, an acetyl group, benzyl group, formyl group and pivaloyl group), alkoxycarbonyl group (preferably comprising 2 to 20 carbon atoms, more preferably comprising 2 to 16 carbon atoms, and particularly preferably comprising 2 to 12 carbon atoms, for example, a methoxycarbonyl group, ethoxycarbonyl group and cyclohexyloxycarbonyl group), arynyloxycarbonyl group (preferably comprising 7 to 20 carbon atoms, more preferably comprising 7 to 16 carbon atoms, and particularly preferably comprising 7 to 10 carbon atoms, for example, a phenyloxycarbonyl group), acyoxy group (preferably comprising 2 to 20 carbon atoms, more preferably comprising 2 to 16 carbon atoms, and particularly preferably comprising 2 to 10 carbon atoms, for example, an acetoxy group and benzoyloxy group), acyamino group (preferably comprising 2 to 20 carbon atoms, more preferably comprising 2 to 16 carbon atoms, and particularly preferably comprising 2 to 10 carbon atoms, for example, an acetylamino group and benzoylamino group), alkoxycarbonylamino group (preferably comprising 2 to 20 carbon atoms, more preferably comprising 2 to 16 carbon atoms, and particularly preferably comprising 2 to 12 carbon atoms, for example, a methoxycarbonyamino group), aryloxycarbonylamino group (preferably comprising 7 to 20 carbon atoms, more preferably comprising 7 to 16 carbon atoms, and particularly preferably comprising 7 to 12 carbon atoms, for example, a phenyloxycarbonylamino group), sulfonylamino group (preferably comrising 1 to 20 carbon atoms, more preferably comprising 1 to 16 carbon atoms, and particularly preferably comprising 1 to 12 carbon atoms, for example, a methanesulfonylamino group and benzenesulfonylamino group), sulfamoyl group (preferably, having 0 to 20 carbon atoms, more preferably having 0 to 16 carbon atoms, and particularly preferably having 0 to 12, carbon atoms, for example, a sulfamoyl, methylsulfamoyl group, dimethylsulfamoyl group and phenylsulfamoyl group), carbamoyl group (preferably having 1 to 20, carbon atoms, more preferably having 1 to 16 carbon atoms, and particularly preferably having 1 to 12 carbon atoms, for example, a carbamoyl group, methylcarbamoyl group, ethylcarbamoyl group, diethylcarbamoyl group and phenylcarbamoyl group), alkylthio group (preferably having 1 to 20, carbon atoms, more preferably having 1 to 16 carbon atoms, and particularly preferably having 1 to 12 carbon atoms, for example, a methylthio group and ethylthio group), arylthio group (preferably having 6 to 20, carbon atoms, more preferably having 6 to 16 carbon atoms, and particularly preferably having 6 to 12 carbon atoms, for example, a phenylthio group), sulfonyl group (preferably having 1 to 20, carbon atoms, more preferably having 1 to 16 carbon atoms, and particularly preferably having 1 to 12 carbon atoms, for example, a mecyl group and tosyl group), sulfinyl group (preferably having 1 to 20, carbon atoms, more preferably having 1 to 16 carbon atoms, and particularly preferably having 1 to 12 carbon atoms, for example, a methanesulfinyl group and benzenesulfinyl group), ureido group (preferably having 1 to 20, carbon atoms, more preferably having 1 to 16 carbon atoms, and particularly preferably having 1 to 12 carbon atoms, for example, a ureido group, methylureido group, butylureido group and phenylureido group), phosphate amide group (preferabl, having 1 to 20, carbon atoms, more preferably having 1 to 16 carbon atoms, and particularly preferably having 1 to 12 carbon atoms, for example, a diethyl phosphate amide group and phenyl phosphate amide group), hydroxy group, mercapto group, halogen atom (for example, fluorine atom, chlorine atom, bromine atom, iodine atom), cyano group, sulfo group, carboxyl group, nitro group, hydroxamic acid group, sulfino group, hydrazino group, hetero cycle group (for example, imidazolyl, pyridyl, furyl, piperidyl, morpholino). These substituents may undergo further substitution. Where two or more substituents are available, they may be the same or different.

Examples of the above R include preferably an alkyl group, aryl group, alkoxy group, aryloxy group, cyano group, halogen atom and nitro group, more preferably an alkyl group, aryl group, alkoxy group, aryloxy group, halogen atom, still more preferably an alkyl group, aryl group, alkoxy group, and particularly preferably an alkyl group and aryl group.

m represents an integer from 1 or more but not more than 4. When m is at least 2, plural Rs maybe the same or different. Where plural Rs are adjacent to each other, they may form an aliphatic ring, aromatic ring, or hetero cycle (benzene ring or dioxolene ring).

Of compounds represented by the general formula (I), the compound represented by the following general formula (I-a) is more preferable.

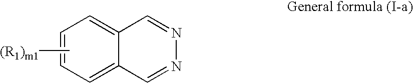

In the general formula (I-a), R₁ represents an alkyl group, aryl group, alkoxy group, aryloxy group, halogen atom, cyano group or nitro group. m₁ represents an integer from 1 to 4. when m₁ is at least 2, the plurality of R₁ may be the same or different. Where a plurality of R₁s are adjacent, they may form an aliphatic ring, aromatic ring or hetero cycle.

Where R₁ in the general formula (I-a) represents an alkyl group, aryl group, alkoxy group or aryloxy group, the preferable scope is the same as that of R in the previous formula (I).

Of the compounds represented by the previous general formula (I), particularly preferable are those represented by the following formulae (I-b), (I-c) and (I-d).

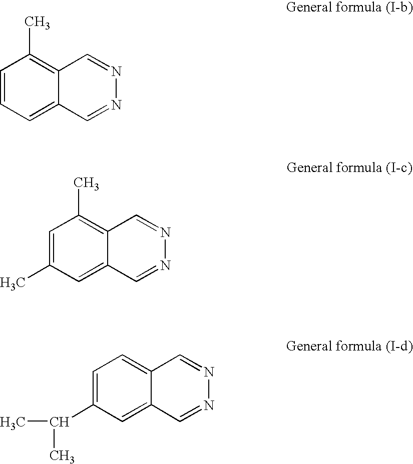

Shown below are examples of the compounds represented by the general formula (I) (I-1 to I-49), together with the compounds represented by the above formulae (I-b), (I-c) and (I-d), which are not intended to limit the scope of the invention.

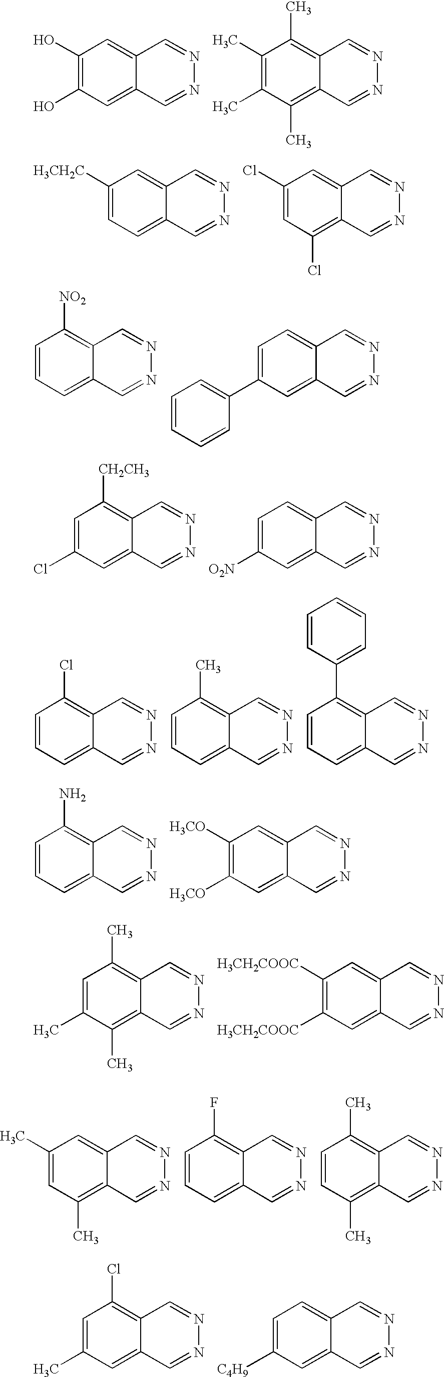

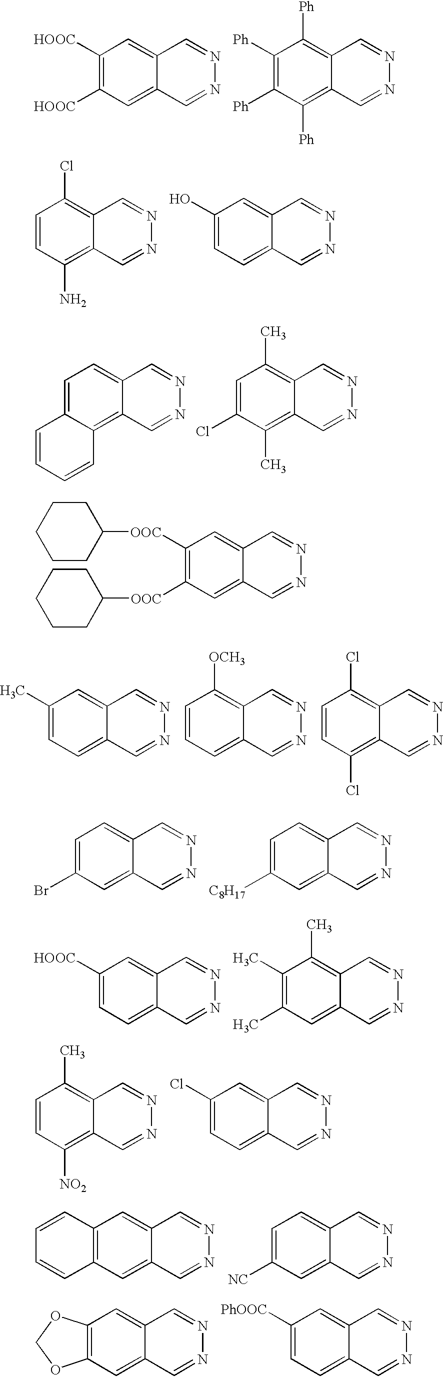

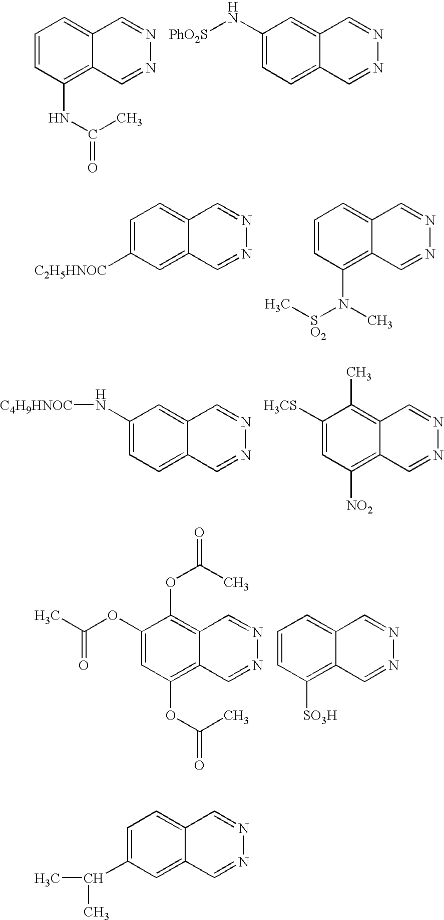

Compounds represented by the general formula (I) in the invention can be synthesized by known methods such as those described in R. G. Elder Field “Heterocyclic Compounds”, John Wiley and Sons, Vol. 1 to 9, 1950-1967 and A. R. Katritzky “Comprehensive Heterocyclic Chemistry”, Pergamon Press, 1984.

Non-Photosensitive Organic Silver Salts

The non-photosensitive organic silver salts used in the invention are now explained as follows.

The organic silver salts usable in the invention are silver salts that are relatively stable against light and able to form a silver image upon heating at 80° C. or higher in the presence of exposed photocatalysts (such as a latent image of photosensitive silver halide) and reducing agents.

These non-photosensitive organic silver salts are described in paragraphs [0048] through [0049] of JP-A No. 10-62899, from the 24th line on page 18 to the 37th line on page 19 of EP-A No. 0803764A1, EP-A No. 0962812A1, JP-A No. 11-349591, JP-A No. 2000-7683 and JP-A No. 2000-72711. Organic silver salts are preferable and silver salts of long-chain aliphatic carboxylic acid (with a carbon number of 10 to 30 and preferably, 15 to 28) are more preferable.

Preferable organic silver salts include behenic acid silver, arachidic acid silver, stearic acid silver, oleic acid silver, lauric acid silver, caproic acid silver, myristic acid silver, palmitic acid silver and their mixtures.

In the invention, of the above organic silver salts, preferable are those having behenic acid silver content of 50 mol % or higher, and more preferable are those having a content of 80 mol % or higher, and particularly preferable are those having a content of 90 mol % or higher.

There are no particular restrictions in the configurations of organic silver salts usable in the invention, and any configuration such as needle shape, bar shape, tabular shape or flaky shape will do.

Flaky organic silver salts are preferable in the invention. Also preferably used are amorphous particles of short needle shape, rectangular shape, cubical shape or potato shape, whose ratio of major axis to minor axis is 5 or less. These organic silver particles are characterized by less fogging on thermal development as compared with long-needle shaped particles having a major axis to minor axis ratio of 5 or greater.

In this invention, the flaky organic silver salt is defined as follows: under electron microscopic observation, the particle of the said salt is closely similar to a rectangular solid shape and when the sides of the rectangular solid are assumed to be a, b, and c in an ascending order of length (c and b may be of the same length), x is determined as follows by a calculation referring to the shorter sides of a and b.

x=b/a

By referring to the above formula, x is determined for approx. 200 particles to obtain a mean value x. When the relation of x (mean value)≧1.5 is obtained, such particles are defined as a flaky particle. The preferable relationship is 30>x (mean value)≧1.5 and a more preferable relationship is 15>x (mean value)≧1.5. For reference, the needle shape is expressed as the relationship of 1.5≧x (mean value)≧1.5

In the flaky particle, a is the thickness of a tabular-shaped particle having a major surface with the sides of b and c. The mean value of a is preferably in a range from 0.01 μm to 0.3 μm, and more preferably in a range from 1 μm to 0.23 μm. The mean value of c/b is preferably in a range from 1 to 6 s, and more preferably in a range from 1 to 4, and still more preferably in a range from 1 to 3.

The particle size distribution of an organic silver salt is preferably of mono-dispersion. The mono dispersion can be expressed as a percentage obtained by dividing the standard deviations of the lengths of the minor axis and of the major axis with the minor axis and the major axis. It is preferably no more than 100%, more preferably no more than 80%, and still more preferably no more than 50%. The configuration of organic silver salts can be determined by observing the image of dispersed organic silver salt under a transmission electron microscope.

The mono-dispersion can be determined by another method, namely, the standard deviation is calculated for the volume-weighted mean diameter of organic silver salt, and expressed as a percentage (coefficient of variation) obtained by dividing the standard deviation with the volume-weighted mean diameter. The thus obtained mono-dispersion is preferably no more than 100%, more preferably no more than 80% and still more preferably no more than 50%.

Other methods are also available, for example, a laser beam is radiated to organic silver salt dispersed in a liquid to obtain the autocorrelation function in relation to over-time variation in scattered light, from which particle size is measured (volume-weighted mean diameter).

Manufacturing and dispersion methods for the organic silver salts usable in the invention can be attained by well-known methods, for example, by referring to those described in JP-A No. 10-62899, EP-A No. 0803763A1, EP-A No. 0962812A1, JP-A No. 11-349591, JP-A Nos. 2000-7683 and 2000-72711, and Japanese Patent Application Nos. 11-348228 to 30 and 11-203413, Japanese Patent Application Nos. 2000-90093, 2000-195621, 2000-191226, 2000-213813, 2000-214155 and 2000-191226.

Where a photosensitive silver salt is allowed to coexist at the time of dispersing organic silver salt, fogging increases and results in a great decrease in the sensitivity. Therefore, it is more preferable that no photosensitive silver salt is practically contained at the time of dispersion.

In the invention, the photosensitive silver salt content in the aqueous dispersion to be dispersed is preferably no more than 1 mol % in relation to 1 mol of organic silver salt contained in the aqueous dispersion and more particularly no more than 0.1 mol %. It is still more preferable that the photosensitive silver salt is not intentionally added.

In this invention, it is possible to mix an organic silver aqueous dispersion with a photosensitive silver aqueous dispersion for the manufacture of photosensitive materials. The organic silver salt and the photosensitive silver salt can be mixed at any rate, depending on the purposes. The ratio of the photosensitive silver salt to the organic silver salt is preferably in a range of 1 to 30 mol %, more preferably in a range of 2 to 20 mol % and particularly preferably in a range of 3 to 15 mol %.

Mixture of 2 or more types of organic silver salt aqueous dispersions with 2 or more types of photosensitive silver salt aqueous dispersions is a preferable method for modifying photographic characteristics.

The organic silver salt used in the invention can be employed at a desired quantity, namely, in a range of 0.1 to 5 g/m² in terms of silver content, more preferably in a range of 0.3 to 3 g/m², and still more preferably in a range of 0.5 to 2 g/m².

Reducing Agents

Reducing agents used in the invention are now explained as follows:

It is preferable that the photothermographic material of the invention contains a reducing agent for organic silver salts. The reducing agent for organic silver salts may be any material that can reduce silver ion into a metallic silver (preferably organic materials).

Examples of said reducing agent are described in paragraphs [0043] through [0045] of JP-A No. 11-65021 and from the 34th line on page 7 to the 12th line on page 18 of EP-A No. 0803764A1.

In the invention, preferable reducing agents are a hindered phenol reducing agent and bisphenol reducing agent, which contain substituents at the ortho position of phenolic hydroxyl group, and a more preferable agent is that shown in the general formula (R) below.

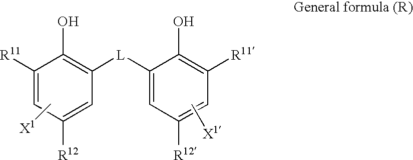

In the general formula (R), R¹¹ and R^{11′} independently represent an alkyl group having 1 to 20 carbon atoms. Further, R¹² and R^{12′} independently represent a hydrogen atom or substituent that can be substituted with a benzene ring. L represents an —S— group or —CHR¹³— group. R¹³ represents a hydrogen atom or an alkyl group having 1 to 20 carbon atoms. X¹ and X^{1′} independently represent a hydrogen atom or group that can be substituted with a benzene ring.

A detailed explanation is now made about the substituents in the general formula (R).

1) R¹¹ and R^{11′}

R¹¹ and R^{11′} independently represent substituted or unsubstituted alkyl groups having 1 to 20 carbon atoms. There are no restrictions on the substituents of the alkyl group but preferable substituents include an aryl group, hydroxy group, alkoxy group, aryloxy group, alkylthio group, arylthio group, acylamino group, sulfoneamide group, sulfonyl group, phosphoryl group, acyl group, carbamoyl group, ester group, ureido group, urethane group and halogen atom.

2) R¹² and R^{12′} and X¹ and X^{1′}

R¹² and R^{12′} independently represent a hydrogen atom or substituent that can be substituted with benzene ring.

X¹ and X^{1′} independently represent a hydrogen atom or substituent that can be substituted with benzene ring. Their respective substituents that can be substituted with a benzene ring include an alkyl group, aryl group, halogen atom, alkoxy group and acyamino group.

3) L

L represents —S— group or —CHR¹³— group. R¹³ represents a hydrogen atom or alkyl group having 1 to 20 carbon atoms. The alkyl group may be provided with substituents.

Examples of R¹³ unsubstituted alkyl groups include a methyl group, ethyl group, propyl group, butyl group, heptyl group, undecyl group, isopropyl group, 1-ethylpentyl group and 2,4,4-trimethylpentyl group. Examples of substituted alkyl groups include the similar groups as those given for the above R¹¹.

4) Preferable Substituents

Preferable R¹¹ and R^{11′} are secondary and tertiary alkyl groups having 3 to 15 carbon atoms, and examples include an isopropyl group, isobutyl group, t-butyl group, t-amyl group, t-octyl group, cyclohexyl group, cyclopentyl group, 1-methylcyclohexyl group and 1-methylcyclopropyl group. More preferable R¹¹ and R^{11′} are tertiary alkyl groups having 4 to 125 carbon atoms, of which t-butyl group, t-amyl group and 1-methylcyclopropyl group are particularly preferable, and t-butyl group is the most preferable.

Preferable R¹² and R^{12′} are alkyl groups having 1 to 20 carbon atoms, and examples include a methyl group, ethyl group, propyl group, butyl group, isopropyl group, t-butyl group, t-amyl group, cyclohexyl group, 1-methylcyclohexyl group, benzyl group, methoxymethyl group and methoxyethyl group. More preferable examples include a methyl group, ethyl group, propyl group, isopropyl group and t-butyl group.

X¹ and X^{1′} are preferably a hydrogen atom, halogen atom or an alkyl group, and more preferably a hydrogen atom Preferable L is —CHR¹³— group.

Preferable R¹³ is a hydrogen atom or alkyl group having 1 to 15 carbon atoms, and preferable alkyl groups include a methyl group, ethyl group, propyl group, isopropyl group or 2,4,4-trimethylpentyl group. Particularly preferable R¹³ is a hydrogen atom, methyl group, ethyl group, propyl group or isopropyl group.

Where R¹³ is a hydrogen atom, R¹² and R^{12′} are preferably alkyl groups having 2 to 5 carbon atoms, more preferably an ethyl group or propyl group, and the most preferably an ethyl group.

Where R¹³ is a primary or secondary alkyl group having 1 to 8 carbon atoms, R¹² and R^{12′} are preferably a methyl group. Primary and secondary alkyl groups of R¹³ having 1 to 8 carbon atoms are more preferably a methyl group, ethyl group, propyl group or isopropyl group, and still more preferably a methyl group, ethyl group or propyl group.

Where R¹¹, R^{11′}, R¹² and R^{12′} are all methyl groups, it is preferable that R¹³ is a secondary alkyl group. In this instance, the secondary alkyl group of R¹³ is preferably an isopropyl group, isobutyl group or 1-ethylpentyl group, and more preferably isopropyl group.

The above reducing agents are different in thermal development properties, silver tone in development and others, depending on a combination of R¹¹, R^{11′}, R¹² or R^{12′}. Since these properties can be adjusted by combining at least 2 reducing agents, it is desirable to use reducing agents in at least 2 combinations, depending on the purpose.

Examples of reducing agents of the invention represented by the general formula (R) are shown below (R-1 to R-34), which are not intended to limit the scope of the invention.

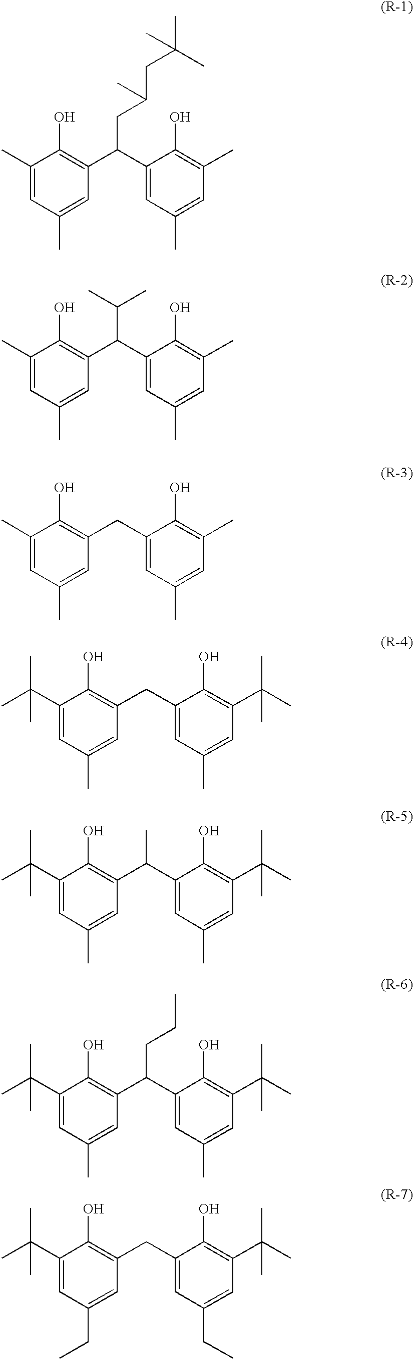

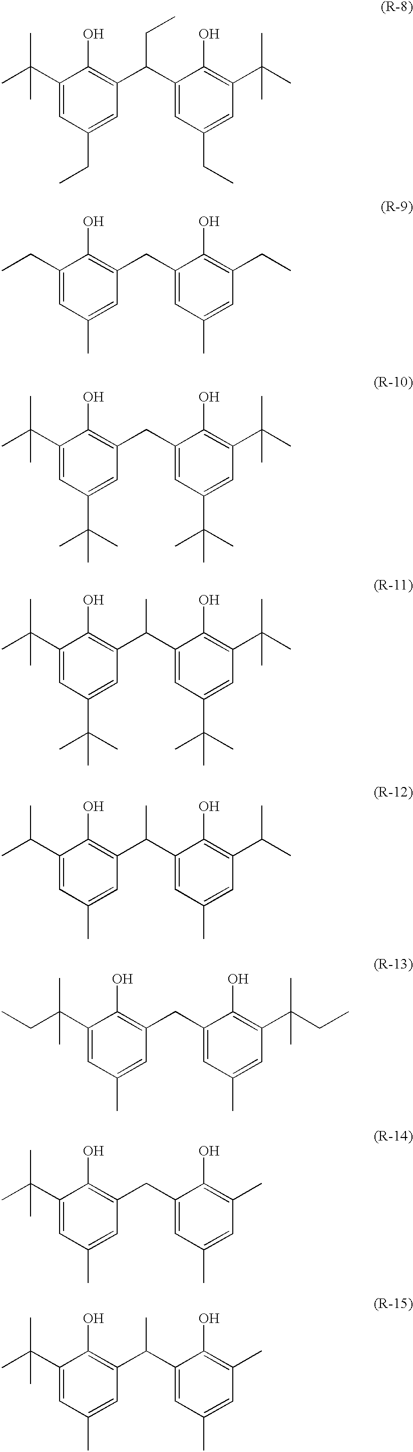

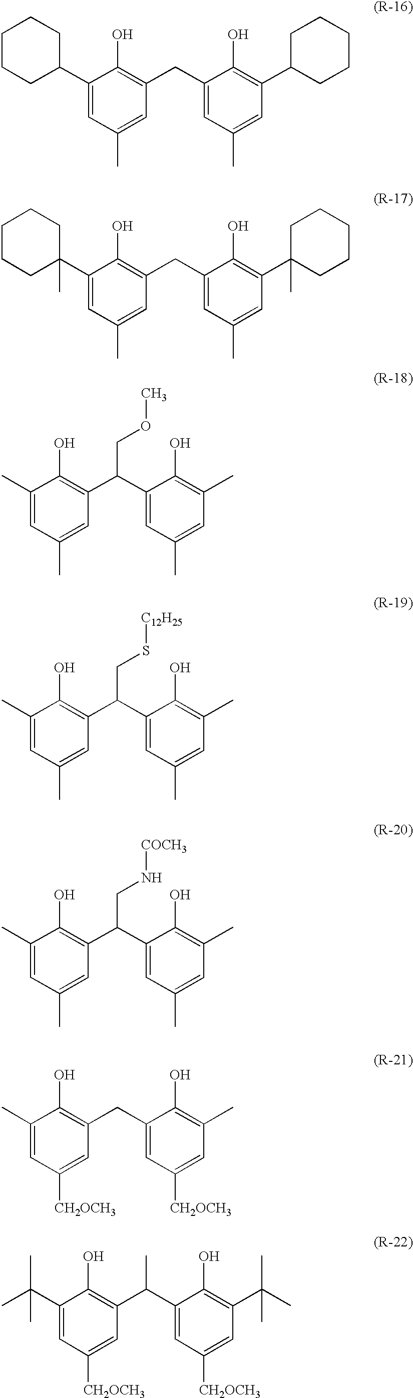

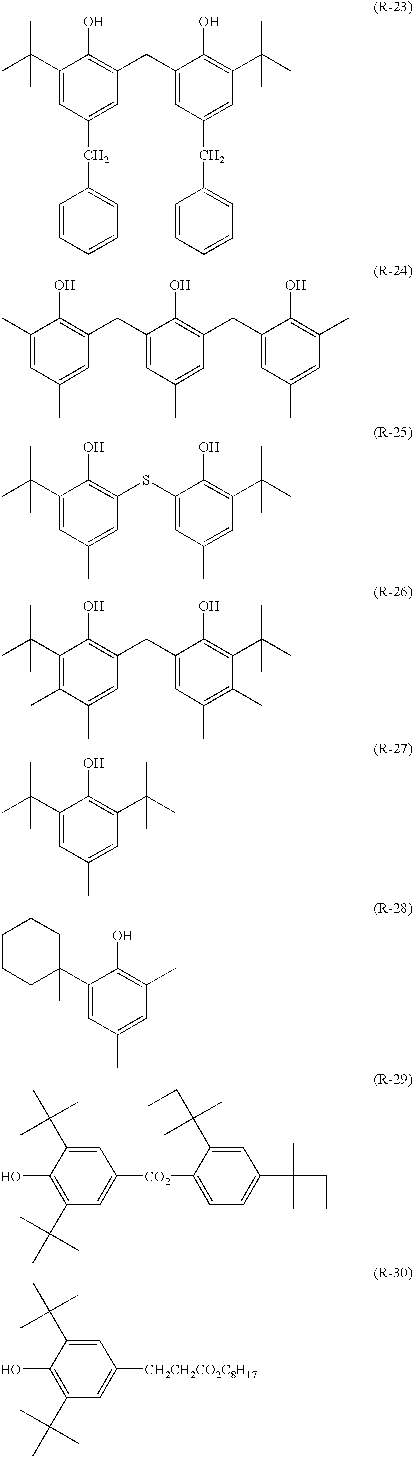

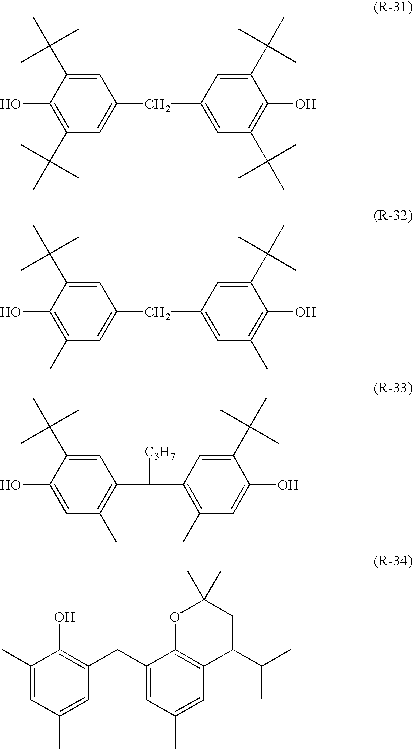

In this invention, a reducing agent is added preferably in a range from 0.1 to 3.0 g/m², more preferably in a range from 0.2 to 1.5 g/m², and still more preferably in a range from 0.3 to 1.0 g/m².

The reducing agent is contained preferably in a range from 5 to 50 mol % in relation to 1 mol of silver on the image-producing surface, more preferably in a range from 8 to 30 mol % and still more preferably in a range of 10 to 20 mol %. It is preferable that the reducing agent is incorporated into the image-producing surface.

The reducing agent may be contained in a coating liquid in any form or in any method such as an emulsified dispersion or a micro-particle solid-state dispersion so that it can be incorporated into the photosensitive material.

A well-known method for attaining an emulsified dispersion is that oils such as dibutylphthalate, tricresylphosphate, glyceryltriacetate and diethylphthalate, or auxiliary solvents such as ethyl acetate and cyclohexane are used to dissolve the reducing agent, thus mechanically preparing the emulsified dispersion.

A method for preparing the micro-particle solid-state dispersion is that a powdery reducing agent is dispersed in any appropriate solvent such as water by means of a ball mill, colloid mill, vibrating ball mill, sand mill, jet mill, roller mill or by a supersonic wave to prepare a solid dispersion. In this instance, protective colloids (for example, polyvinyl alcohol), surfactants (for example, anion surfactant such as sodium triisopropylnaphthalenesulfonate) (a mixture of substances with different substitution positions of 3 isopropyl groups) may be used. Beads such as zirconia are commonly used in mills mentioned above, and Zr and others eluted from beads may be found in dispersions. Normal dispersion is in a range of 1 ppm to 1000 ppm, although dependent upon the conditions. It is practically acceptable as long as Zr is present at 0.5 mg or less for one gram of silver in the photosensitive material.

It is preferable that an antiseptic agent (for example, sodium benzoisothiazolinon) is incorporated into an aqueous dispersion.

Development Accelerator

Development accelerators that are preferably used in the photothermographic materials of the invention include sulfonamide phenol compounds represented by the general formula (A) in JP-A No. 2000-267222 and JP-A No. 2000-330234, hindered phenol compounds represented by the general formula (I) in JP-A No. 2001-92075, hydrazine compounds represented by the general formula (I) in JP-A No. 10-62895 and JP-A No. 11-15116 and also by the general formula (I) in Japanese Patent Application No. 2001-074278, and phenol and naphthol compounds represented by the general formula (2) in Japanese Patent Application No. 2000-76240.

The development accelerator is preferably used in a range of 0.1 to 20 mol % in relation to the reducing agent, more preferably in a range of 0.5 to 10 mol %, and still more preferably in a range of 1 to 5 mol %. The development accelerator can be added to the sensitive material in a similar way for adding the reducing agent to the sensitive material. It is particularly preferable that the development accelerator should be added as a solid dispersion or an emulsified dispersion.

When added as an emulsified dispersion, the development accelerator should be added preferably as tabular emulsified dispersion prepared with high-boiling point solvent in a solid form at ordinary temperatures and with low-boiling point solvent, or added as a so called oil-free emulsified dispersion in which no high-boiling point solvent is used.

Hydrogen Bond Compound

Hydrogen bond compounds used in the invention are now explained as follows:

Where the reducing agent used in the invention has an aromatic hydroxyl group (—OH), especially in the case of bisphenol as mentioned before, preferable is a concomitant use with a non-reducing compound having a group capable of forming hydrogen bond with these hydroxyl group (hereinafter, referred to as hydrogen bond compound).

The groups capable of forming a hydrogen bond with the hydroxyl group or amino groups include phosphoryl group, sulfoxide group, sulfonyl group, carbonyl group, amide group, ester group, urethane group, ureido group, tertiary amino group and nitrogen-containing aromatic group.

Among other things, preferable compounds are those having a phosphoryl group, sulfoxide group, amide group (however, those free from the >N—H group and blocked like >N—Ra (Ra is a substituent other than H), urethane group (however, those free from the >N—H group and blocked like >N—Ra (Ra is a substituent other than H) and ureido group(however, those free from the >N—H group and blocked like >N—Ra (Ra is a substituent other than H).

A particularly preferable hydrogen bond compound of the invention is that represented by the following general formula (D).

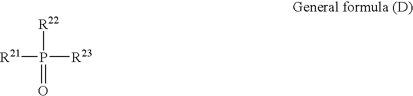

Where in the general formula (D), R²¹, R²² and R²³ independently represent alkyl group, aryl group, alkoxy group, aryloxy group, amino group or hetero cycle group, and these groups may be provided with groups which may be unsubstituted or substituted.

Where R²¹, R²² and R²³ are provided with substituents, to substituents include a halogen atom, alkyl group, aryl group, alkoxy group, amino group, acyl group, acylamino group, alkylthio group, arylthio group, sulfonamide group, acyloxy group, oxycarbonyl group, carbamoyl group, sulfamoyl group, sulfonyl group and phosphoryl group. Preferable substituents are an alkyl group and aryl group, and their examples include a methyl group, ethyl group, isopropyl group, t-butyl group, t-octyl group, phenyl group, 4-alkoxyphenyl group and 4-acyloxyphenyl group.

Examples of alkyl groups represented by R²¹, R²² and R²³ include a methyl group, ethyl group, butyl group, octyl group, dodecyl group, isopropyl group, t-butyl group, t-amyl group, t-octyl group, cyclohexyl group, 1-methylcylcohexyl group, benzyl group, phenethyl group and 2-phenoxypropyl group.

Examples of aryl groups represented by R²¹, R²² and R²³ include a phenyl group, cresyl group, xylyl group, naphthyl group, 4-t-butylphenyl group, 4-t-octylphenyl group, 4-anisyzyl group and 3,5-dichlorophenyl group.

Examples of alkoxy groups represented by R²¹, R²² and R²³ include a methoxy group, ethoxy group, butoxy group, octyloxy group, 2-ethylhexyloxy group, 3,5, 5-trimethylhexyloxy group, dodecyloxy group, cyclohexyloxy group, 4-methylcyclohexyloxy group and benzyloxy group.

Examples of aryloxy groups represented by R²¹, R²² and R²³ include a phenoxy group, cresyloxy group, isopropylphenoxy group, 4-t-butylphenoxy group, naphthoxy group, and biphenyl group.

Examples of amino groups represented by R²¹, R²² and R²³ include a dimethylamino group, diethylamino group, dibutylamino group, dioctylamino group, N-methyl-N-hexylamino group, dicyclohexylamino group, diphenylamino group, and N-methyl-N-phenylamio group.

Preferable R²¹, R²² and R²³ include an alkyl group, aryl group, alkoxy group and aryloxy group. In terms of the effect of the invention, it is preferable that at least any one of R²¹, R²² or R²³ is an alkyl group or aryl group, and it is more preferable that at least any 2 of them are an alkyl group or aryl group. It is preferable that R²¹, R²² and R²³ are the same group in view of economic feasibility.

Shown below are examples of hydrogen bond compounds (D-1 to D-21) including the compound represented by the general formula (D) of the invention, which are not intended to limit the scope of the invention.

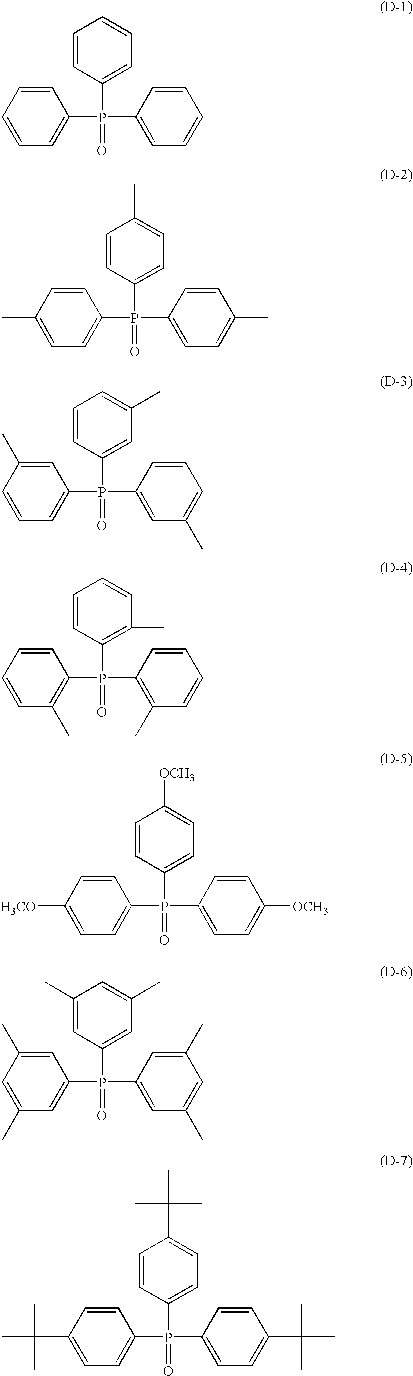

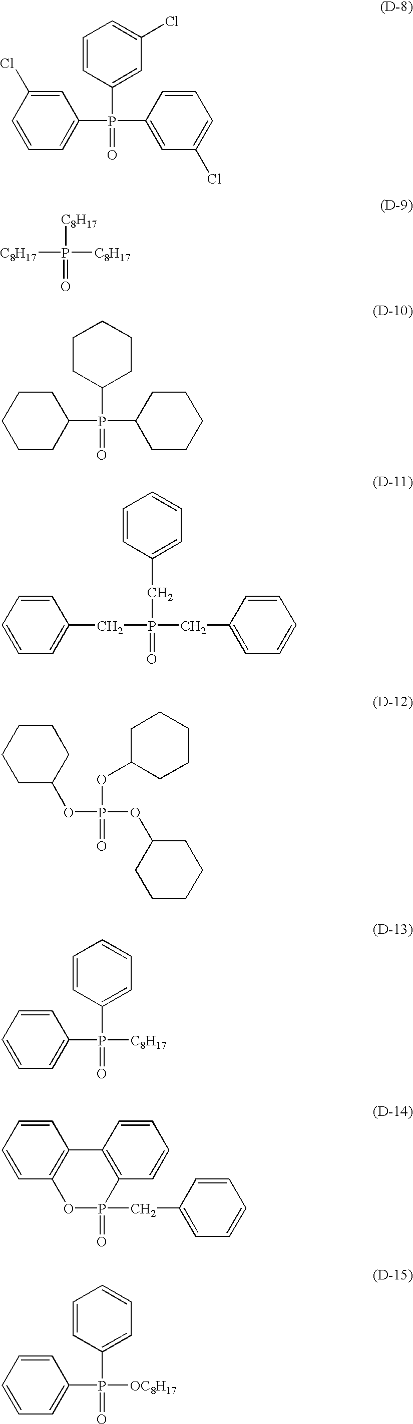

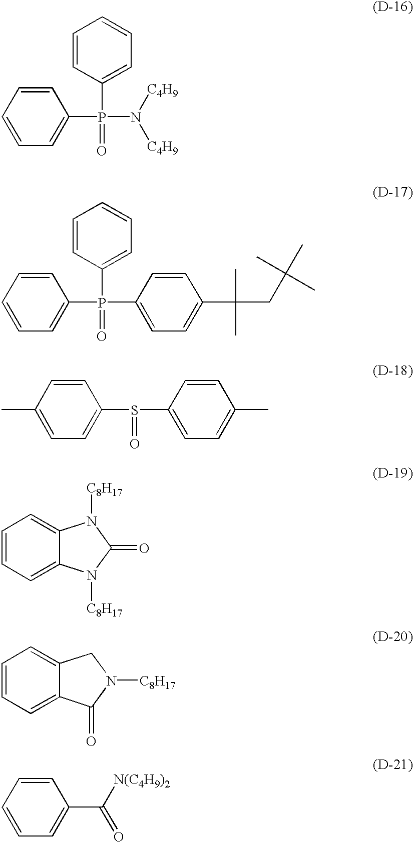

In addition to the above examples of the hydrogen bond compounds, they are also described in the specifications of EP No. 1096310, Japanese Patent Application No. 2000-270498 and No. 2001-124796.

As with reducing agents, the hydrogen bond compounds of the invention may be incorporated into a coating liquid in a state of solution, emulsified dispersion or solid micro-particle dispersion so that they can be used in the photosensitive material. The hydrogen bond compound of the invention is provided with a hydrogen-binding complex with compounds having phenol hydroxyl or an amino group in a state of solution, and can be isolated as a crystalline complex through combination with certain reducing agents. It is particularly preferable in attaining the storability to use thus isolated crystalline powders as the solid micro-particle dispersion. Such method is also preferably employable in the invention in which the hydrogen bond compound of the invention is mixed in a powdery state with reducing agents and further processed with a sand grind mill, etc., and by addition of appropriate dispersing agents to produce complexes at the time of dispersion.

The hydrogen bond compound of the invention is preferably used in a range of 1 to 200 mol % in relation to the reducing agent, more preferably in a range of 10 to 150 mol %, and still more preferably in a range of 20 to 100 mol %.

Binders

Binders used in the invention are now explained as follows:

Any polymer can be used as a binder of the organic silver salt-containing layer (namely, image forming layer) of the invention. Preferable binders are transparent or semi-transparent, generally colorless natural resins or synthesized resins, polymers or copolymers, and other film-forming vehicles. Their examples include gelatins, rubbers, poly (vinyl alcohols), hydroxyethyl celluloses, cellulose acetates, cellulose acetate butylates, poly (vinyl picolidons), caseins, starches, poly (acrylic acids), poly (methyl methacrylic acids), poly (vinyl chlorides), poly (methacrylic acids), styrene-anhydrous maleic acid co-polymers, styrene-acrylonitrile co-polymers, styrene-butadiene co-polymers, poly (vinyl acetals) (for example, poly (vinyl formals) and poly (vinyl butyrals), poly (esters), poly (urethanes), phenoxy resins, poly (vinylidene chlorides), poly (epoxides), poly (carbonates), poly (vinyl acetates), poly (olefins), cellulose esters and poly (amides).

The binders may be formed by coating with water, organic solvents or emulsions.

In this invention, a binder usable together with an organic silver salt-containing layer is transferred to glass preferably at temperatures of from 0° C. to 80° C. (hereinafter, from time to time, called high Tg binder), more preferably at temperatures of from 10° C. to 70° C. and still more preferably at temperatures of from 15° C. to 60° C.

In the specification of the invention, Tg was calculated by referring to the following formula.

1/Tg=Σ(Xi/Tgi)

Wherein the polymer is supposed to have copolymerization of n-number of monomers ranging from i=1 to n. Xi is the mass fraction of the first monomer (Σxi=1), Tgi is the glass transfer temperature of i-numbered monomer as homopolymer (absolute temperature). However, Σ is a sum of the numbers from i=to i=n. The value of the glass transfer temperature of each monomer as homopolymer (Tgi) was adopted from that appearing in The Polymer Handbook (3rd edition) (J. Brandrup, E. H. Immergut, published by Wiley—Interscience, 1989).

A polymer as a binder may be used singularly or in combination with 2 or more polymers when such neccessity arises. The polymer may be also used in combination of those having a glass transfer temperature of 20° C. of more with those having a temperature of less than 20° C. Where at least 2 polymers having different Tg are used in combination, the mean Tg by weight preferably falls under the above temperature range.

In the invention, it is preferable that coating, drying and subsequent film formation should be carried out by using a coating liquid wherein the organic silver salt-containing layer contains a solvent whose 30% by weight or more is water.

In this invention, an improved performance can be attained where coating, drying and subsequent film formation are carried out by using coating liquid wherein the organic silver salt-containing layer has a solvent whose 30% by weight or more is water, where a binder of the organic silver salt-containing layer can be dissolved or dispersed in an aqueous solvent (water solvent) and particularly where the binder consists of a latex polymer whose equilibrium water content is 2% by weight or less particularly at 25° C. and 60% RH. Most preferable is a case where ion conductivity is adjusted so as to give 2.5 mS/cm or less. Such adjustment can be carried out by a method wherein polymer is synthesized and then purified by a separation membrane.

The aqueous solvent capable of dissolving or dispersing the above-mentioned polymers is water or a mixture of water with water-soluble organic solvent whose content is 70% by weight or less.

Water-mixable organic solvents include alcohols such as methyl alcohol, ethyl alcohol and propyl alcohol, cellosolves such as methyl cellosolves, ethyl cellosolves and butyl cellosolves, ethyl acetate and dimethylformamide.

Solvents wherein polymers that are not dissolved in terms of thermodynamics and present in a state of so-called dispersion are also termed as aqueous solvents.

“The equilibrium water content at 25° C. and 60% RH” can be expressed as follows by referring to W₁, weight of polymer, the moisture of which in equilibrium is at 25° C. and 60% RH, and to W₀, weight of polymer, the moisture of which is kept absolutely dry at 25° C.

Equilibrium water content at 25° C. and 60% RH={(W₁—W₀)/W₀}×100 (% by weight)

The definition and method for determining the water content can be, for example, referred to in High Molecular Engineering Courses 14 (compiled by the Society of Polymer Science, Japan, Chijinshokan).

In the invention, the equilibrium water content of the binder polymer at 25° C. and 60% RH is preferably 2% by weight or less, more preferably in a range of from 0.01% by weight to 1.5% by weight, and still more preferably in a range of from 0.02% by weight to 1% by weight.

In this invention, particularly preferable binders are polymers dispersible in aqueous soluble solvents. Binders in a dispersion state may include latexes wherein water-insoluble hydrophobic polymer micro-particle are dispersed or those wherein polymer molecules are dispersed in a molecular state or micelle state. More preferable binders are those with particles dispersed in a latex state.

The mean size of dispersed particles is in a range from 1 to 50000 nm, preferably in a range from 5 to 1000 nm, more preferably in a range from 10 to 500 nm and still more preferably in a range of from 50 to 200 nm. There are no particular restrictions on the particle size distribution of dispersed particles. More particularly, a particle size distribution of said polymers may be used that is wider or of mono-disperse. Mixture of at least 2 polymers with mono-disperse particle size distribution is also preferable in controlling physical properties of a coating liquid.

In the invention, preferable examples of aqueous solvent-dispersible polymers include hydrophobic polymers such as an acrylic polymer, poly (esters), rubbers (for example, SBR resin), poly (urethanes), poly (vinyl chlorides), poly (vinyl acetates), poly (vinylidene chlorides) and poly (olefins). Further, the following polymers can be used in the invention; straight chain polymers, branched chain polymers, or cross-linked polymers, so-called, home-polymer made through polymerization of a single monomer and co-polymers made through polymerization of at least 2 types of monomers. In the case of copolymers, either random co-polymer or block co-polymer will suffice.

These polymers are preferably 5,000 to 1,000,000 in mean molecular weight and more preferably 10,000 to 200,000. Polymers with excessively low molecular weight are insufficient in the dynamic strength of the image forming layer, whereas those with an excessively high molecular weight are poor in film formability and therefore not suitable. Particularly suitable polymers are cross-linked polymer latexes.

Examples of Polymer Latexes

The following shows preferable examples of polymer latexes, which are, however, not intended to limit the scope of the invention.

Shown below are examples of starting material monomers. The number given in parenthesis means percentage by weight, and the molecular weight is the number average molecular weight. Where multifunctional monomers are used, the word, cross-linkage, is described and the molecular weight is omitted, because a concept of molecular weight for building cross linkage is not applicable. Tg indicates glass transfer temperature.

P-1: -MMA (70) -EA (27) -MMA (3) -latex (molecular weight 37000, Tg=61° C.)

P-2: -MMA (70) -2EHA (20) -St (5) -AA (5) latex (molecular weight 40000, Tg=59° C.)

P-3: -St (50) -Bu (47) -MMA (3) -latex (cross linkage, Tg=17° C.)

P-4: -St (68) -Bu (29) -AA (3) -latex (cross linkage, Tg=17° C.)

P-5: -St (71) -Bu (26) -AA (3) latex (cross linkage, Tg=24° c)

P-6: -St (70) -Bu (27) -IA (3) -latex (cross linkage)

P-7: -St (75) -Bu (24) -AA (1) -latex (cross linkage, Tg=29° C.)

P-8: -St (60) -Bu (35) -DVB (3) -MAA (2) latex (cross linkage)

P-9: -St (70) -Bu (25) -DVB (2) -AA (3) latex (cross linkage)

P-10: -VC (50) -MMA (20) -EA (20) -AA (5) latex (molecular weight: 80000)

P-11: -VDC (85) MMA (5) -EA (5) -MMA (5) latex (molecular weight: 67000)

P-12: -Et (90) -MMA (10) -latex (molecular weight: 12000)

P-13: -St (70) -2EHA (27) -AA (3) -latex (molecular weight: 130000, Tg=43° C.)

P-14: -MMA (63) -EA (35) -AA (2) latex (molecular weight: 33000, Tg=47° C.)

P-15: -St (70.5) -Bu (26.5) -AA (3) -latex (cross linkage, Tg=23° C.)

P-16: -St (69.5) -Bu (27.5) -AA (3) -latex (cross linkage, Tg=20.5° C.)

The abbreviations in the above structures correspond to monomers as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The above-described polymer latexes are commercially available, with the following trade names. As examples of acrylic polymers, they include Cevian A-4635, 4718 and 4601 (all trade names, manufactured by Daicel Kagaku Kogyo K.K.) and Nipol Lx811, 814, 821, 820 and 857 (all trade names, manufactured by Nippon Zeon Co., Ltd.), as examples of poly (esters), they include FINETEX ES650, 611, 675 and 850 (all trade names, manufactured by Dainippon Ink & Chemicals, Inc.) and WD-size WMS (all trade names, manufactured by Eastman Chemical Company), as examples of poly (urethanes), they include HYDRAN AP10, 20 and 40 (all trade names, manufactured by Dainippon Ink & Chemicals, Inc.), as examples of rubbers, they include LACSTAR 7310K and 3370B (all trade names, manufactured by Dainippon Ink & Chemicals, Inc.) and Nipol Lx416, 410 and 438C (all trade names, manufactured by Nippon Zeon Co., Ltd.), as examples of poly (vinyl chlorides), they include G351 and G576 (all trade names, manufactured by Nippon Zeon Co. Ltd.), as examples of poly (vinylidene chlorides), they include L502 and L513 (all trade names, manufactured by Asahi Chemical Industry Co., Ltd.) and as examples of poly (olefins) they include CHEMIPEARL S120 and SA100 (all trade names, manufactured by Mitsui Chemicals, Inc.).

These polymers may be used singularly or in combination with 2 or more types of polymers when such necessity arises.

Preferable Polymer Latexes

Styrene-butadiene copolymer latex is particularly preferable as polymer latex to be used in the invention. The weight ratio of styrene monomer to butadiene monomer in styrene-butadiene copolymer is preferably in a range of 40:60 to 95:15. The proportion of combined monomer units of styrene and butadiene to copolymer is preferably in a range of 60 to 99% by weight. Polymer latexes of the invention preferably contain acrylic acid or methacrylic acid in a range of 1 to 6% by weight in relation to a sum of styrene and butadiene and more preferably in a range of 2 to 5% by weight. In the invention, it is preferable that the polymer latexes contain an acrylic acid.

Preferable styrene-butadiene copolymer latexes include previously described P-3 to P-8 and P-15 as well as commercial products such as LACSTAR-3307B, 7132C and Nipol Lx416 that are listed above.

In these styrene-butadiene copolymer latexes, Tg is preferably temperatures of from 10° C. to 30° C. and more preferably temperatures of 17° C. to 25° C.

To an organic silver salt-containing layer (namely, image forming layer) used in photosensitive material of the invention, hydrophilic polymers such as gelatin, polyvinyl alcohol, methyl cellulose, hydroxypropyl cellulose and carboxymethyl cellulose may be added, whenever necessary. These hydrophilic polymers are added preferably in 30% by weight or less in relation to a total quantity of binders to be added to the organic silver salt-container layer, and more preferably in 20% by weight or less.

A preferable organic silver salt-containing layer (namely, image forming layer) of the invention is that prepared with polymer latexes. Regarding a quantity of binders to be added to the organic silver salt-containing layer, the weight ratio of total binders to organic silver salt is preferably in a range of 1/10 to 10/1, more preferably in a range of 1/3 to 5/1 and still more preferably in a range of 1/1 to 3/1.

The organic silver salt-containing layer is usually a photosensitive layer (image forming layer) that contains a photosensitive silver halide (a photosensitive silver salt) as well. In this instance, the weight ratio of total binders to silver halide is preferably in a range of 400/1 to 5/1 and more preferably in a range of 200/1 to 10/1.

A total quantity of the binders added to the image forming layer in the invention is preferably in a range of 0.2 to 30 g/m², more preferably in a range of 1 to 15 g/m² and still more preferably in a range of 2 to 10 g/m². Cross-linking agents for cross linkage and surfactants for improving applicability may be added to the image forming layer of the invention. Preferable solvents for coating liquid In the invention, aqueous solvents that contain water in 30% by weight or greater are preferable solvents of an organic silver salt-containing coating liquid added to the photosensitive material (for simplification, solvents and dispersing agents are jointly called solvents).

Any water-mixable organic solvents such as methyl alcohol, ethyl alcohol, isopropyl alcohol, methylcellosolve, ethylcellosolve, dimethylformamide and ethyl acetate may be added, as compositions other than water. The solvents for the coating liquid preferably contain water in an amount of 50% by weight or more and more preferably 70% by weight or more.

Preferable solvent compositions, other than water, include water/methyl alcohol 90/10, water/methyl alcohol=70/30, water/methyl alcohol/dimethylformamide=80/15/5, water/methyl alcohol/ethylcellosolve=85/10/5 and water/methyl alcohol/isopropyl alcohol=80/15/5 (the values indicate percentage by weight).

Fog-Preventing Agents

Fog-preventing agents used in the invention are now explained as follows:

The fog-preventing agents, fixing agents and precursors of fixing agents that can be used in the invention include compounds described in paragraph [0070] of JP-A No. 10-62899, from the 57th line on page 20 to the 7th line on page 21 of EP-A No. 0803764A1, JP-A Nos. 9-281637 and 9-329864, U.S. Pat. Nos. 6,083,681 and 6,083,681 and EP No. 1048975.

Preferable fog-preventing agents of the invention are organic silver halides. More particularly, they are described in paragraphs [0111] through [0112] of JP-A No. 11-65021. Particularly preferable compounds are organic poly-halogen compounds described in the formula (P) of JP-A No. 2000-284399, in the formula (II) of JP-A No. 10-339934 and in JP-A Nos. 2001-31644 and 2001-33911.

Poly-Halogen Compounds

The following is a specific explanation regarding organic poly-halogen compounds preferably used in the invention.

Preferable organic poly-halogen compounds of the invention are those represented by the general formula (H) below:

Q-(Y)n-C(Z₁)(Z₂)X General formula (H)

Where in the general formula (H), Q represents an alkyl group, an aryl group or a hetero cycle group, Y represents a divalent communication group, n represents zero or 1, Z₁ and Z₂ represent a halogen atom, and X represents a hydrogen atom or an electron-attracting group.

In the general formula (H), Q preferably represents a phenyl group substituted with an electron-attracting group that provides positive values of the Hammett substituent constant, σp. As to the Hammett substituent, refer to Journal of Medicinal Chemistry, 1973, Vol. 16, No. 11, 1207 to 1216.

Examples of these electron-attracting groups include a halogen atom (fluorine atom (σp value: 0.06), chlorine atom (σp value: 0.23), bromine atom (σp value: 0.23), iodine atom (σp value: 0.18), trihalomethyl group (tribromomethyl (σp value: 0.29), trichloromethyl (σp value: 0.33), trifluoromethyl (σp value: 0.54)), cyano group (σp value: 0.66), nitro group (σp value: 0.78), aliphatic sulfonyl group (for example, methane sulfonyl (σp value: 0.72), arylsulfonyl group, heterocycle sulfonyl group and aliphatic acyl group (for example, acetyl (σp value: 0.50)), arylacyl group (benzoyl (σp value: 0.43)), heterocycle acyl group, alkyl group (for example, C≡CH (σp value: 0.23), aliphatic aryl or heterocycle oxlycarbonyl group (for example, methoxycarbonyl group (σp value: 0.45), phenoxycarbamoyl (σp value: 0.44), carbamoyl group (σp value: 0.36), sulfamoyl group (σp value: 0.57), sulfoxide group, hetero-cycle group and phosphoryl group. σp values are preferably in a range of 0.2 to 2.0 and more preferably in a range of 0.4 to 1.0.

Electron-attracting groups include a particularly preferably carbamoyl group, alkoxycarbamoyl group, alkylsulfonyl group and alkylphosphoryl group, and most preferably a carbamoyl group.

X is preferably an electron-attracting group, more preferably, halogen atom, aliphatic aryl or heterocycle sulphonyl group, aliphatic acyl or heterocycle acyl group, aliphatic aryl or heterocycle oxycarbonyl group, carbamoyl group or sulfamoyl group, and particularly preferably, a halogen atom. Of a halogen atom, preferable are a chlorine atom, bromine atom and iodine atom, more preferable are a chlorine atom and bromine atom, and particularly preferable is a bromine atom.

Y preferably represents —C(═O)—, —SO— or —SO₂—, more preferably —C(═O)— or —SO₂—, and particularly preferably —SO₂—. n represents zero or 1, and preferably 1.

Examples of the compounds (H-1 to H-24) represented by the general formula (H) are shown below.

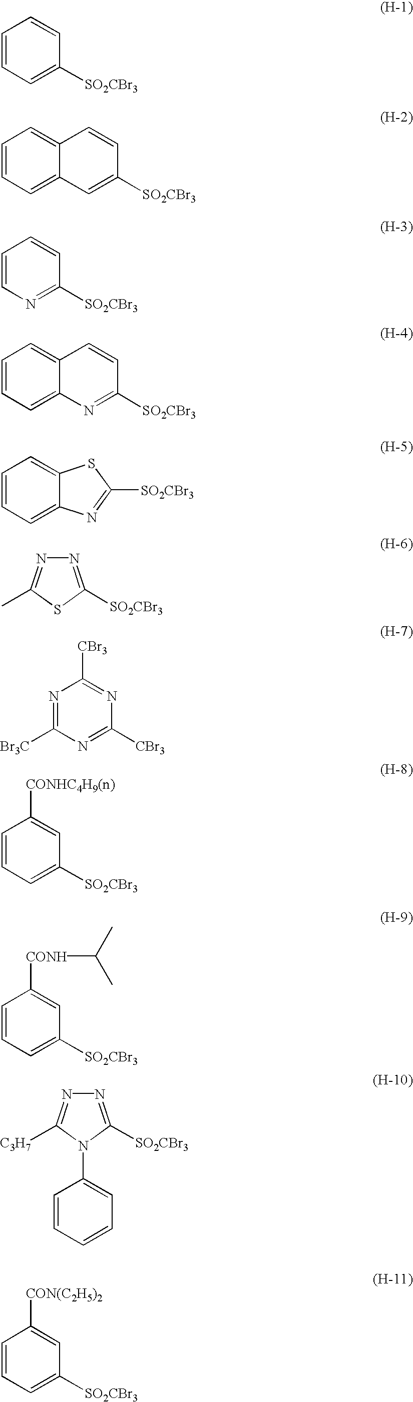

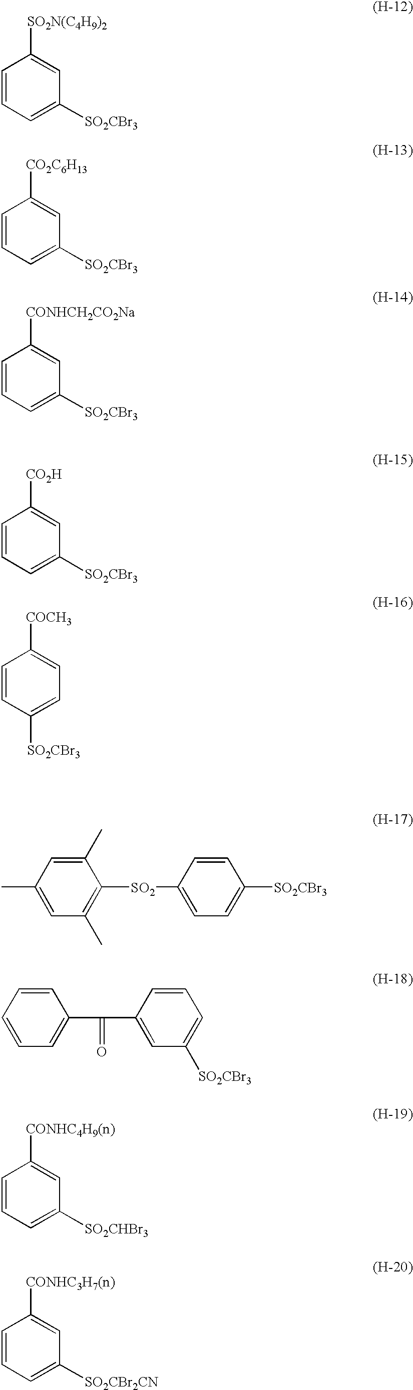

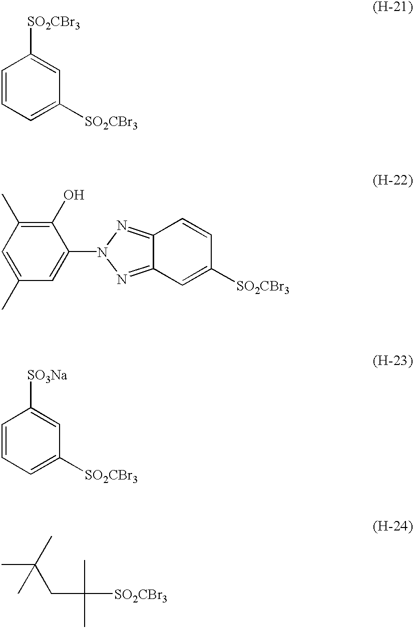

The compound represented by the general formula (H) is preferably used in the invention in a range of 1×10⁻⁴ to 0.5 mol in relation to 1 mol of a non-photosensitive silver salt of the image forming layer, more preferably in a range of 10⁻³ to 0.1 mol, and still more preferably in a range of 5×10⁻³ to 0.05 mol.

In the invention, a method for incorporating fog-preventing agents in the photosensitive material is similar to the previously described method regarding the reducing agent. It is also preferable that the organic poly-halogen compound is added in a state of a solid micro-particle dispersion.

The compound represented by the general formula (H) has a fusion point preferably at 200° C. or lower and more preferably at 170° C. or lower.

Other Fog-Preventing Agents

Other fog-preventing agents include silver (II) salt and benzoic acids respectively described in the paragraphs [0113] and [0114] of JP-A No. 11-65021, salicylic acid derivatives of JP-A No. 2000-206642, formalin scavenger compounds represented by the formula (S) of JP-A No. 2000-221634, triazine compounds described in claim 9 of JP-A No. 11-352624 and 4-hydroxy-6-methyl-1,3,3a,7-tetrazainden represented by the general formula (III) of JP-A No. 6-11791.

The photothermographic material of the invention may contain azolium salt for preventing fogging. Azolium salt includes the compound represented by the general formula (XI) in JP-A No. 59-193447, the compound described in JP-B No. 55-12581 and the compound represented by the general formula (II) in JP-A No. 60-153039. Azolium salt may be added to any site of the photosensitive material. However, it is preferable to add it to the plane of a layer having the image forming layer and it is more preferable to add it to an organic silver salt-containing layer.

Azolium salt may be added anytime while in a process of preparing coating liquid. Where added to the organic silver salt-containing layer, it may be added at any time while in a process for preparing an organic silver salt or for preparing the coating liquid, preferably during the period from the time of completing preparation of the organic silver salt to the time immediately before coating. Aazolium salt may be added in any form such as a powder, solution or solid micro-particle dispersion. It may also be added as a mixture solution with other additives such as sensitizing dye, reducing agent and image tone modifier.

In the invention, azolium salt may be added at any quantity. Preferably, it is added in a range of 1×10⁻⁶ mol to 2 mol in relation to 1 mol of silver, and more preferably in a range of 1×10⁻³ mol to 0.5 mol.

Other Additives

1) Mercapto, Disulfide and Thiones

In the invention, mercapto compound, disulfide compound or thione compound may be incorporated for the purpose of inhibiting or accelerating image development so as to control the development processing, improving the spectral sensitization rate or improving the image storability before and after the development processing. These compounds are described in paragraphs [0067] through [0069] of JP-A No. 10-62899 or represented by the formula (I) in JP-A No. 10-186572. They are also exemplified in paragraphs [0033] through [0052] of the preceding JP-A No. 10-186572 and from the 36th line to the 56th line on page 20 of EP-A No. 0803764A1. Particularly preferable compounds are mercapto-substituted hetero-cycle aromatic compounds described in JP-A Nos. 9-297367, 9-304875 and 2001-100358 and Japanese Patent Application Nos. 2001-104213 and 2001-104214.

2) Image Tone Modifier

Addition of an image tone modifier is preferred in the photothermographic material of the invention. Image tone modifiers are described in paragraphs [0054] through [0055] of JP-A No. 10-62899, from the 23rd line to the 48th line on page 21 of EP No. 0803764A1, JP-A NO. 2000-3563317 and Japanese Patent Application No. 2000-187298. Particularly preferable image tone modifiers include phthalazinones (phthalazinone, phthalazinone derivative or metallic salt; for example, 4-(1-naphthyl) phthalazinone, 6-chlorophthalazinone, 5,7-dimethoxyphthalazinone and 2,3-dihydro-1,4-phthalazinedione); a combination of phthalazinones and phthalic acids (for example, phthalic acid, 4-methylphthalic acid, 4-nitrophthalic acid, diammonium phthalate, sodium phthalate, potassium phthalate and tetrachlorophthalic anhydrate); phthalazines (phthalazine, phthalazine derivative or metallic salt; for example, 4-(1-naphthyl)-phthalazine, 6-isopropylphthalazine, 6-t-butylphthalizine, 6-chlorophthalazine, 5,7-dimethoxyphthalazine, and 2,3-dihydrophthalazine). In particular, when combined with a silver halide having a higher content of silver iodide, preferable is a combination of phthalazines with phthalic acids.

Phthalazines are added preferably in a range of 0.01 to 0.3 mol in relation to 1 mol of an organic silver salt, more preferably in a range of 0.02 to 0.2 mol and still more preferably in a range of 0.02 to 0.1 mol.

3) Plasticizers and Lubricants

Plasticizers and lubricants usable in the image forming layer of the invention are described in paragraph 0117 of JP-A No. 11-65021. Smoothing agents are described in paragraphs 0061 to 0064 of JP-A No. 11-84573 and paragraphs 0049 to 0062 of Japanese Patent Application No. 11-106881.

4) Dyes and Pigments

A variety of dyes and pigments (for example, C.I. Pigment Blue 60, C.I. Pigment Blue 64, C.I. Pigment Blue 15:6) can be used in view of improving color tone, preventing an interference wave upon laser light exposure or preventing irradiation. These dyes and pigments are described in detail in WO98/36322, JP-A Nos. 10-268465 and 11-398098.

5) Super High-Contrast Agents

It is preferable to add a super-high contrast agent to the image forming layer in order to provide a super high-contrast image suitable for printing use. Methods for adding super-high contrast agents to the image forming layer and the additive quantities are described in paragraph 0118 of JP-A No. 11-65021, paragraphs 0136 to 0193 of JP-A No. 11-223898, compounds represented by the formulae (H), (1) to (3), formulae (A) and (B) of JP-A No. 2000-284399 and compounds represented by the formulae (III) to (V) of Japanese Patent Application No. 11-91652 (specific compounds; Kagaku 21 to Kagaku 24). High contrast accelerators are described in paragraph 0102 of JP-A No. 11-65021 and paragraphs 0194 to 0195 of JP-A No. 11-223898.

When formic acid or formate is used as a strong anti-foggant, it is preferable to incorporate said substance into the plane having an image forming layer that contains a photosensitive silver halide in a quantity of 5 m mol or lower in relation to 1 mol of silver and more preferably in a quantity of 1 m mol or lower.

Where a super high-contrast agent is used in the photothermographic material of the invention, it is preferable to use the agent together with an acid or its salt produced by hydration of diphosphorous pentaoxide.

Acids or salts produced by hydration of diphosphorous pentaoxide include metaphosphoric acid (metaphosphate), pyrophosphoric acid (pyrophosphate), orthophosphoric acid (orthophosphate), triphosphoric acid (triphosphate), tetraphosphoric acid (tetraphosphate) and hexametaphosphoric acid (hexametaphosphate).

Particularly preferable acids or salts produced by hydration of diphosphorous pentaoxide include orthophosphoric acid (orthophosphate) and hexametaphosphoric acid (hexametaphosphate). Examples of the salts include sodium orthophosphate, sodium dihydrogen orthophosphate, sodium hexametaphosphate and ammonium hexametaphosphate.

Acids or salts produced by hydration of diphosphorous pentaoxide may be used in any desired quantity (quantity applicable to 1 m² of the photosensitive material), depending on factors such as the sensitivity or fogging level, preferably in a quantity of 0.1 to 500 mg/m² and more preferably in a quantity of 0.5 to 100 mg/m².

Layer Components

The image forming layer of the invention may be comprised of a single layer or plural layers. In the case of a single layer, the image forming layer is comprised of a non-photosensitive organic silver salt, a photosensitive silver halide, a reducing agent and a binder, and may contain additionally an image tone modifier, a coating adjuvant and other adjutants. In the case of plural layers, the first image forming layer (usually the layer adjacent to a support) must contain an organic silver salt and a silver halide, and the second image forming layer or both of the image forming layers must contain some other components.

A multi-color photothermographic material may be comprised of a combination of said 2 layers for each color, and also may be comprised of a single layer that contains all the components as described in U.S. Pat. No. 4,708,928. In the case of the multi-color photothermographic material, each of the image forming layers is, in general, kept separately from each other by using a functional or non-functional barrier layer between the image forming layers as described in U.S. Pat. No. 4,460,681.

The photothermographic layer of the invention may be provided with a non-photosensitive layer in addition to the image forming layer. The non-photosensitive layer is classified in view of the components into (1) surface-protective layer produced on the image forming layer (on a distal part from the support), (2) intermediate layer produced between plural image forming layers or between the image forming layer and the surface-protective layer, (3) undercoat layer produced between the image forming layer and the support, and (4) back layer produced on the opposite side of the image forming layer.

It is possible to provide a filter layer (a layer acting as an optical filter), which can be fabricated as the layer of (1) or (2). An anti-halation layer is fabricated on the photosensitive material as the layer of (3) or (4).

1) Surface-Protective Layer

The photothermographic layer of the invention may be provided with a surface-protective layer for the purpose of preventing adhesion of the image forming layer. The surface-protective layer may be produced in a single layer or plural layers. The surface-protective layer is described in paragraphs [0119] through [0120) of JP-A No. 11-65021 and Japanese Patent Application No. 2000-171936.

Gelatin is a preferable binder for the surface-protective layer of the invention. It is, however, also preferable to use polyvinyl alcohol (PVA) or in combination with gelatin. Gelatins usable in the invention include an inert gelatin (for example, Nitta Gelatin 750) and a phthalated gelatin (for example, Nitta Gelatin 801).

Preferable PVAs are described in paragraphs [0009] through [0020] of JP-A No. 2000-171986, and other preferable PVAs include a completely saponificated polyvinyl alcohol, PVA-105, a partially saponificated polyvinyl alcohol, PVA-205 or PVA-335 and a modified polyvinyl alcohol, MP-203 (all are trade names, manufacured by Kuraray Co., Ltd.).

A polyvinyl alcohol is coated preferably in a quantity of 0.3 to 4.0 g/m² in relation to the surface-protective layer (per layer) (for each 1 m² of support) and more preferably in a quantity of 0.3 to 2.0 g/m².

2) Anti-Halation Layer

Anti-halation layers are described in paragraphs [0123] through [0124] of JP-A Nos. 11-65021, 11-223898, 9-230531, 10-36695, 10-104779, 11-231457, 11-352625 and 11-352626.

These anti-halation layers contain an anti-halation dye that can exhibit absorption at exposure wavelength. In the invention, since the exposure laser has a peak wavelength at 350 nm to 450 nm, it is preferable to use an anti-halation dye that can exhibit the absorption at said wavelength.

Where a dye exhibiting absorption at the visible light range is used for preventing halation, it is preferable that color developed by a dye does not substantially remain after image formation. Namely, it is preferable that heat of thermal development is used to remove the color and it is particularly preferable that a thermal color-removing dye and a base precursor are added, thus allowing them to act as an anti-halation layer. These techniques are described in JP-A No. 11-231457.

Whether or not the color-removing dye is added depends on the usage of the dye. In general, the dye is used in a quantity that enables the optical density (absorbance) to exceed 0.1 when determined at the intended wavelength. The optical density is preferably in a range of 0.2 to 2. In general, the dye is used in a quantity of 0.001 to 1 g/m² for obtaining said optical density.

When the dye is decolored, it is possible to reduce the optical density after thermal development to no more than 1. Two or more types of color-removing dyes may be used in thermal color-removing recording materials and thermal developing photosensitive materials. Similarly, at least two 2 types of base precursors may be used in combination.

In effecting thermal color removal by use of these color-removing dyes and base precursors, it is preferable in view of thermal color-removal, etc., to use in combination with substances (for example, diphenylsulfone or 4-chlorophenyl (phenyl) sulfone), 2-naphthylbenzoate and others that can reduce the fusion point by 3° C. (deg) or greater when mixed with the base precursors described in JP-A No. 11-352626.

3) Back Layer

It is preferable that the photothermographic material of the invention is a so called single-sided photosensitive material having an image forming layer that contains at least one layer of silver halide emulsion on one side of a support and having a back layer on the other side of the support.

The back layer usable in the invention is described in paragraphs [0128] through [0130] of JP-A No. 11-65021.

In the invention, a coloring agent having a maximum absorption at 300 to 450 nm may be added for improving over-time change in silver tone and image quality. Said coloring agents are described in JP-A Nos. 62-210458, 63-104046, 63-103235, 63-208846, 63-306436, 63-314535, 01-61745 and 2001-100363.

These coloring agents are in general added in a range of 0.1 mg/m² to 1 g/m², and preferably added to a back layer fabricated on the opposite side of the image forming layer.

4) Matting Agent

In the invention, it is preferable to add a matting agent for improving the feeding property. Matting agents are described in paragraphs [0126] through [0127] of JP-A No. 11-65021. Where the matting agent is expressed in a coated quantity of 1 m² of the photosensitive material, it is preferably in a range of 1 to 400 mg/m² and more preferably in a range of 5 to 300 mg/m².

In the invention, the matting agent may be used either in a delomorphous or amorphous shape but preferably in a delomorphous spherical shape. The mean particle size is preferably 0.5 to 10 μm, more preferably 1.0 to 8.0 μm and still more preferably 2.0 to 6.0 μm. The coefficient of variation of the particle size distribution is preferably 50% or lower, more preferably 40% or lower and still more preferably 30% or lower. The coefficient of variation hereof is a value represented by the standard deviation of particle size/mean value of particle size×100. It is also preferable that 2 types of matting agents are used together that are small in the coefficient of variation and 3 or greater in the mean particle size ratio.

As long as stardust failure does not take place, the matting degree on an emulsion plane may be negligible. However, Bekk smoothness is preferably in a range of from 30 seconds to 2000 seconds, and particularly preferably in a range of from 40 seconds to 1500 seconds. Bekk smoothness can be simply referred to in Japanese Industrial Standard (JIS) P8119 [Method of Smoothness of Paper and Paper Board by Bekk Tester] and TAPPI standard method (T479).

In the invention, the matting degree of the back layer is preferably in a range of from 10 seconds to 1200 seconds in terms of Bekk smoothness, more preferably in a range of 20 seconds or greater to 800 seconds or lower, and still more preferably in a range of from 40 seconds to 500 seconds.

5) Polymer Latex

Where the photothermographic material of the invention is used in a printing application in which dimensional change poses a problem, it is preferable to use a polymer latex in the surface protective layer or back layer. Polymer latexes are described in “Synthetic Resin Emulsion” (compiled by Taira Okuda and Hiroshi Inagaki and published by Kobunshi Kankokai (1978)), “Application of Synthetic Latexes” (compiled by Takaaki Sugimura, Yasuo Kataoka, Soichi Suzuki and Keiji Kasahara, published by Kobunshi Kankokai (1993)) and “Chemistry of Synthetic Latexes” (authored by Soichi Muroi and published by Kobunshi Kankokai (1970)). Examples include methylmethacrylate (33.5% by weight)/ethylacrylate (50% by weight)/methcrylic acid (16.5% by weight) copolymer latex, methylmethacrylate (47.5% by weight)/butadiene (47.5% by weight)/itaconic acid (5% by weight) copolymer latex, methylacrylate]/methcrylic acid copolymer latex, methylmethacrylate (58.9% by weight)/2-ethylhexylacrylate (25.4% by weight)/styrene (8.6% by weight)/2-hydroxyethylmethacrylate (5.1% by weight)/acrylic acid (20% by weight) copolymer latex and methylmethacrylate(64.0% by weight)/styrene(9.0% by weight)/butylacrylate (20.0% by weight)/2-hydroxyethylmethacrylate (5.0% by weight)/acrylic acid (20% by weight) copolymer latex.

Binders for the surface-protective layer may include the combination of polymer latexes described in Japanese Patent Application No. 11-6872 or may be prepared by using the techniques described in paragraphs [0021] through [0025] of Japanese Patent Application No. 11-143058, paragraphs [0027] through [0028] of Japanese Patent Application No. 11-6872 and paragraphs [0023] through [0041] of Japanese Patent Application No. 10-199626.

The percentage of polymer latex on the surface protective layer is preferably in a range of from 10% by weight to 90% by weight in terms of a total binder quantity, and particulary preferably in a range of 20% by weight to 80% by weight.

A coating qunatity (per 1 m² of support) of the total binders (including water-soluble polymers and latex polymers) on the surface-protective layer (per layer) is preferably 0.3 to 5.0 g/m² and more preferably 0.3 to 2.0 g/m².

6) pH on Emulsion Side

The photothermographic material of the invention preferably has pH of 7.0 or lower on the emulsion side prior to thermal development, and more preferably a pH of 6.6 or lower. There are no particualr restrictions on the lower limit of pH but it is approx. a pH of 3. The most preferable pH range is 4 to 6.2.

It is preferable in view of attaining reduced pH on the emulsion side to use nonvolatile acids including an organic acid such as a phthalic acid derivative and sulfuric acid or volatile bases such as ammonia to adjust the pH on the emulsion side. In particular, ammonia will become easily volatile and can be removed during the coating process or before thermal development, thus it being preferable in reducing the pH level on the emulsion side.

It is also preferable to use nonvolatile bases such as sodium hydroxide, photassium hydroxide and lithium hydroxide in combination with ammonia. The method for determining pH on the emulson side is described in paragraph [0123] of JP-A No. 11-87297.

7) Hardener

A hardener may be used in the layers such as the image forming layer, surface-protective layer and back layer. Hardeners are produced in the methods described on pages 77 through 87 of “The Theory of the Photographic Process, fourth edition” authored by T. H. James (published by Macmillian Publsihing Co., Inc., 1997). Preferable examples of the hardeners include multi-valent metal ions described on page 78 of the above text, polyisocyanates described in U.S. Pat. No. 4,281,060 and JP-A No. 6-208193, epoxy compounds described in U.S. Pat. No. 4,791,042 and vinylsulfone compounds described in JP-A No. 62-89048, in addition to chrome alum, 2,4-dichloro-6-hydroxy-s-triazine sodium, N,N-ethylene bis (vinylsulfone acetoamide), N,N-propylene bis (vinylsulfone acetoamide).

The hardener is added in the form of a solution. The solution is added to a coating liquid for the protective-surface layer during the time 180 minutes to immediately before the coating and preferably during the time 60 minutes to 10 seconds before the coating. There are, however, no particular restrictions on the mixing methods and conditions as long as the effect of the invention can be provided sufficiently.

Specific mixing methods include a method for mixture in a tank by which a desired mean holding time can be attained by calculating a flow rate of the agents to be added and a quantity fed to the coater, or a mixing method using a static mixer described in Chapter 8 of “Technology of Mixing Liquid” authored by N. Harnby, M. F. Edwards and A. W. Nienow and translated by Koji Takahashi (published by Nikkan Gokyo Shinbun, 1989)

8) Surfactant

Surfactants usable in the invention are described in paragraph [0132] of JP-A No. 11-65021.

In the invention, it is preferable to use fluorosurfactants. Examples of fluorosurfactants include compounds described in JP-A Nos. 10-197985, 2000-19680 and 2000-214554. Also preferably used are high-polymer fluorosurfactants described in JP-A No. 9-281636. Fluorosurfactants described in Japanese Patent Application Nos. 2000-206560, 2001-203462, 2001-242357 and 2001-264110 are preferably used in the photothermographic material of the invention. Fluorosurfactants described in Japanese Patent Application No. 2001-242357 and 2001-264110 are particularly preferable in terms of the ability to control electrostatic charge, stability of coated surface and smoothness when an aqueous system coating liquid is used. The fluorosurfactant described in Japanese Patent Application No. 2001-264110 is most preferably used because it is excellent in its ability to control electrostatic charge and can attain the desired effect in a smaller quantity.

In the invention, a fluorosurfactant can be used both on the emulsion surface and the back surface, and is preferably used on the both surfaces. It is particularly preferable to use a fluorosurfactant in combination with a conductive layer that contains the previously described metal oxides. In this instance, a sufficient effect can be obtained when a fluorosurfactant is used in a small quantity or even not used at all on the surface that contains the conductive layer.

Fluorosurfactants are used preferably in a range of 0.1 mg/m² to 100 mg/m² on the emulsion or back surface, and more preferably in a range of 0.3 mg/m² to 30 mg/m², and still more preferably in a range of 1 mg/m² to 10 mg/m². The fluorosurfactant described in Japanese Patent Application No. 2001-264110 is particularly high in the effect, which can be preferably used in a range of 0.01 mg/m² to 10 mg/m² and more preferably in a range of 0.1 mg/m² to 5 mg/m².

9) Antistatic Agent

In the invention, antistatic agents may be used that contain conductive materials such as various known metal oxides or conductive polymers. Preferably usable conductive materials include metal oxides with increased conductivity by introducing oxygen-deficit different metallic atoms into metal oxides. Preferable metal oxides include ZnO, TiO₂ and SnO₂. It is preferable to add Al or In to ZnO, add Sb, Nb, P or halogen to SnO₂ and add Nb or Ta to TiO₂. It is particularly preferable to add Sb to SnO₂.

Addition of different atoms is preferably in a range of 0.01 to 30 mol % and more preferably in a range of 0.1 to 10 mol %. Any shape of metal oxides may be used, such as cubic, needle or tabular shape. Preferable are needle-shaped metal oxides with a ratio of major axis to minor axis of 2.0 or greater and more preferably 3.0 to 50 in view of imparting the conductivity.

Metal oxides are used preferably in a range of 1 mg/m² to 1000 mg/m², more preferably in a range of 10 mg/m² to 500 mg/m², and still more preferably in a range of 20 mg/m² to 200 mg/m².

The antistatic layer may be produced either on the image forming layer or on the back layer, and may be used as the previously described undercoat layer, back layer or surface protective layer, and produced as an independent layer. The antistatic layer is preferably produced between the support and the back layer. The antistatic layer can be produced in accordance with the techniques described in paragraph [0135] of JP-A Nos. 11-65021, 56-143430, 56-143431, 58-62646 and 56-120519, paragraphs 0040 to 0051 of JP-A No. 11-84573, U.S. Pat. No. 5,575,957, paragraphs 0078 to 0084 of JP-A Nos. 11-223898, 7-295146 and 11-223901.

10) Support

Preferably used transparent supports include polyesters (especially polyethylene terephtalate) that are treated at temperatures of 130 to 185° C. for alleviating an internal strain remaining in a film on a two-axis drawing and for removing shrinkage due to heat generated during thermal development. When used in the photothermographic material for diagnostic use, the transparent support may be colored with a blue dye (for example, the dye-1 described in the embodiment of JP-A No. 8-240877) or may not be colored. Examples of the support are described in paragraph [0134] of JP-A No. 11-65021.

The support is produced preferably in accordance with the undercoating technique using water-soluble polyester described in JP-A No. 11-84574, styrene butadiene copolymer described in JP-A No. 10-186565, or vinylidene chloride copolymer described in paragraphs 0063 to 0080 of Japanese Patent Application No. 11-106881.

The photothermographic material of the invention is preferably a mono sheet (image can be formed on a single sheet of thermal development layer without using another sheet like an image-receiving material).

11) Other Additives

Anti-oxidants, stabilizing agents, plasticizers, ultraviolet ray-absorbing agents or coating adjutants may be also added to the photothermographic material. It is also acceptable to add the solvent described in paragraph 0133 of JP-A No. 11-65021. These agents are added either to the image forming layer or to the non-photosensitive layer. The details of said addition can be referred to in the descriptions of WO 98/36322, EP803764 A1, JP-A Nos. 10-186567 and 10-18568. A method for producing a color image is described in paragraph [0136] of JP-A No. 11-65021.

12) Preparation of Coating Liquid and Viscosity Characteristics

The coating liquid for the photothermographic material of the invention is prepared preferably at temperatures of from 30° C. to 65° C., more preferably at temperatures of from 35° C. to lower than 60° C., still more preferably at temperatures of from 35° C. to 55° C. It is also preferable that the temperature of the coating liquid for the image forming layer immediately after addition of polymer latex is maintained at temperatures of from 30° C. to 65° C.

The coating liquid for the organic silver salt-containing layer of the invention is preferably a thioxytropic fluid. The technique can be referred to in the description of JP-A No. 11-52509. In the coating liquid for the organic silver salt-containing layer, the viscosity at 0.1S⁻¹ is preferably in a range of from 400 m Pa-s to 100,000 mPa-s, and more preferably in a range of from 500 m Pa-s to 20,000 mPa-s.

The viscosity at shear rate of 1000S⁻¹ is preferably in a range of from 1 m Pa·s to 200 mPa-s, and more preferably in a range of from 5 m Pa-s to 80 mPa-s.

13) Coating Method

The photothermographic material of the invention may be coated by any method. Specifically, it is coated by various methods including extrusion coating, slide coating, curtain coating, dip coating, knife coating, flow coating and extrusion coating by using a type of hopper described in U.S. Pat. No. 2,681,294. Preferable are extrusion coating and slide coating, and particularly preferable is slide coating described on pages 399 through 536 in “Liquid Film Coating” authored by Stephen F. Kistler, Petert M. Schweizer (published by Chapman & Hall, 1997).

The shape of the slide coater used in the slide coating is described in FIG. 11b. 1 on page 427 of the above text. If desired, 2 or more layers can be coated at the same time according to the methods described on pages 399 through 536 in the above text or by methods described in U.S. Pat. No. 2,761,791 and UKP No. 837,095.

14) Other Applicable Techniques

Techniques applicable to the photothermographic material of the invention include those described in EP 803764A1, EP 883022A1, WO98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-3055377, 11-305378, 11-305384, 11-305380, 11-316435, 11-327076, 11-338096, 11-338098, 11-338099, 11-343420, Japanese Patent Application No. 2000-187298,2000-10229, 2000-47345, 2000-206642, 2000-98530, 2000-98531, 2000-112059, 2000-112060, 2000-112104, 2000-112064 and 2000-171936.

2. Image Forming Method

Images can be formed on the photothermographic material of the invention preferably according to the method wherein the above-described photothermographic material is exposed to light by using as a light source the semiconductor laser having a peak light-emitting intensity at 350 nm to 450 nm.

Exposure

The photothermographic material of the invention exhibits the characteristics on short-time exposure under great illumination of 1 mW/mm² or more. Said exposure at great illumination is able to offer a sufficient sensitivity even to a photothermographic material that contains iodide-rich silver halide emulsion and non-photosensitive organic silver salt according to the invention. Namely, exposure under great illumination according to the invention is able to provide a higher sensitivity than exposure under low illumination.

The illumination of the invention is preferably in a range of 1 mW/mm² or more, more preferably in a range of from 2 mW/mm² to 50 W/mm² and still more preferably in a range of from 10 mW/mm² to 50 W/mm².

The photothermographic material of the invention may be exposed to light in any method and a preferable light source is laser light.

Laser light preferably usable in the invention includes a gas laser (Ar, He—Ne, He—Cd), YAG laser, dye laser and semi-conductor laser. It is also preferable to use a semi-conductor laser together with the 2^{nd} high-frequency wave device.

Preferable is a blue-violet light-emitting semi-conductor laser, more preferable is a semi-conductor laser having the peak light-emitting intensity at 350 nm to 450 nm, and still more preferable is a semi-conductor having the peak light-emitting intensity at 390 nm to 430 nm.

A blue-violet high-power semi-conductor laser includes NLHV 3000E semi-conductor laser manufactured by Nichia Corporation. Disclosed is a laser with the output of 35 mW and the wavelength of 405 nm, and the use of said laser as a light source can provide great illumination of 390 nm to 430 nm which is a particularly preferable wavelength range.

Thermal Development

The photothermographic material of the invention may be developed by any method, and usually developed, with the temperature raised, upon exposure to light in an image-oriented fashion. Developing temperatures are preferably 80 to 250° C., more preferably 100 to 140° C., and still more preferably 110 to 130° C. Developing time is preferably 1 to 60 seconds, more preferably 3 to 30 seconds, still more preferably 5 to 25 seconds and particularly preferably 7 to 15 seconds.

Thermal development can be effected by using either a drum heater or a plate-type heater, and more preferable is a plate-type heater. The preferable self-development method by using a plate-type heater is described in JP-A No. 11-133572. The heater is a thermal development device capable of providing a visible image by allowing latent image-producing photothermographic material to contact at the thermal development site by heating means, comprising a plate-type heater for providing said heating means and plural pressure rollers oppositely set along one side of said plate-type heater, so that thermal development can be effected by allowing said photothermographic material to pass between said pressure rollers and said plate-type heater. It is preferable that the plate-type heater is divided into 2 to 6 segments, with temperatures kept lower by 1 to 10° C. at the end.

For example, 4 sets of plate-type heaters are used that can be controlled for temperatures independently, each of which is controlled at 112° C., 119° C., 121° C. and 120° C. Said method is described in JP-A No. 54-30032, and is able to remove moisture and organic solvents contained in the photothermographic material from the system and heat the photothermographic material rapidly, thus making it possible to prevent deformed configuration of the support for the photothermographic material.

Said method is also described in JP-A No. 54-30032, and is able to remove moisture and organic solvents contained in the photothermographic material from the system and heat the photothermographic material rapidly, thus making it possible to prevent deformed configuration of the support for the photothermographic material.

Mean Contrast

There is no restriction on the gradation of the photothermographic material of the invention on which the image is formed by the above-described image forming method. It is preferable in view of providing the better effect of the invention that the mean contrast between the density 1.5 and 3.0 is in a range of from 1.5 to 10.

The mean contrast hereof means the gradation obtained by connecting the optical density of 1.5 and 3.0 in the characteristic curve prepared by plotting the logarithm of laser exposure on the abscissa axis and plotting the optical density obtained after thermal development of the photosensitive material exposed at the light exposure on the vertical axis.

The mean contrast is preferably in a range of from 1.5 to 10 in terms of improving the sharpness of characters. It is more preferably in a range of from 2.0 to 6 and still more preferably in a range of from 2.5 to 6.

System

A laser imager for diagnosis having the exposed area and thermal development area includes Fuji Medical Dry Imager-FM-DPL (trade name, manufactured by Fuji Film Medical Co., Ltd.). Said system is described on pages 39 through 55 of the Fuji Medical Review No. 8 and can be used as a system of the invention. The photothermographic material of the invention can also be used as a photothermographic material for a laser imager in the AD network proposed by Fuji Film Medical as a network system adapted to DICOM specifications.

Applications of the Invention

The photothermographic material of the invention will produce a black and white image based on silver image tone, and preferably finding applications as photothermographic materials for medical diagnostic use, graphic arts use, printing use and COM use.

### EXAMPLES

The present invention will be explained specifically by referring to examples, which are, however, not intended to limit the scope of the invention.

### Example 1-1

### Photothermographic Material 1-1

1-1: Fabrication of PET Support

Film Production

Terephthalic acid and ethylene glycol were used to produce PET with IV (intrinsic viscosity) of 0.66 (determined at 25° C. in phenol/tetrachlorethane=6/4 (weight ratio) by a conventional method. After the PET was processed into pellets, they were dried at 130° C. for 4 hours and dissolved at 300° C. so that the dye BB with the structure given below can be incorporated at 0.04% by weight. Then, the resultant was subjected to extrusion molding by using a T die and cooled rapidly to prepare an undrawn film so that the film thickness can be 175 μm after thermal fixation.

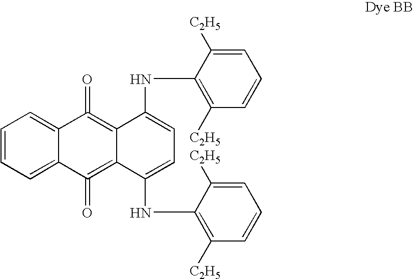

The film was drawn 3.3 times longitudinally by using rollers with a different peripheral velocity and then 4.5 times horizontally by using a tenter. The temperatures were respectively 110° C. and 130° C. Thereafter, the film was thermally fixed at 240° C. for 20 seconds and then relaxed by 4% horizontally at the same temperature. The area of the film caught with the clamp of the tenter was cut off and both ends of the film were subjected to a knurled roller and reeled off at 4 kg/cm² to obtain 175 μm-thick film.

Corona Discharge Surface Treatment

A solid-state corona discharge treatment system (trade name: 6KVA model, manufactured by Pillar Inc., was used to treat both surfaces of the support at a rate of 20 m/minute at room temperature. The electric current and voltage read at the time of said treatment confirmed that the support was treated at 0.375 kV·A·minute/m². The frequency at the time of said treatment was 9.6 kHz, and the clearance gap between the electrode and the dielectric roller was 1.6 mm.

Undercoating

(1) Preparation of Coating Liquid for the Undercoat Prescription <1>: Coating Liquid for the Undercoat of Image Forming Layer

| | | |
|---|---|---|
| Modified polyester resin | 59 | g |
| (trade name: Pesresin A-520 | | |
| (30% by weight solution), | | |
| manufactured by Takamatsu Oil & Fat Co., Ltd., | | |
| Polyethylene glycol monononylphenyl ether | 5.4 | g |
| (Mean ethylene oxide number = 8.5) | | |
| 10% by weight solution, | | |
| acrylpolymer micro-particle, mean particle size 0.4 μm | 0.91 | g |
| (trade name: MP-1000, Soken Kagaku Co., Ltd., | | |
| Distilled water, | 935 | mL |

Prescription <2>: Coating Liquid for the First Layer of Back Surface

| | | |
|---|---|---|
| Styrene butadiene copolymer latex, | 158 | g |
| (40% by weight on dry solid basis, styrene | | |
| butadiene weight ratio = 68/32) | | |
| 2,4-dichloro6-hydroxy-S-triazine sodium, | 20 | g |
| 8% by weight solution, | | |
| 1% by weight lauryl benzene sulfonic sodium | 10 | mL |
| aqueous solution, | | |
| Distilled water, | 854 | mL |

Prescription <3>: Coating Liquid for the Second Layer of Both Sides of the Back Layer

| | | |
|---|---|---|
| SnO²/SbO | 84 | g |
| (9/1 weight ratio, mean particle size 0, 0.38 μm, 17% | | |
| by weight dispersion) | | |
| Gelatin (10% by weight aqueous solution), | 89.2 | g |
| hydroxypropylmethyl cellulose, | 0.01 | g |
| (Trade name: Metolose TC-5 (2% by weight aqueous | | |
| solution), manufactured by Shin-Etsu Chemical Co., Ltd.), | | |
| 1% by weight dodecylbenzene sulfonic sodium aqueous | 10 | mL |
| solution, | | |
| NaOH (1% by weight), | 6 | mL |
| Fungicide (trade name: Proxel, manufactured by ICI), | 1 | mL |
| Distilled water, | 805 | mL |

1-2: Fabrication of Undercoat Support

Both sides of the support coated with 75 μm-thick polyethylene terephthalate prepared by two-axis drawing were respectively subjected to corona discharge treatment, then, the prescription of undercoat liquid <1> was coated on one side of the support (image forming layer) with a wire bar so as to provide 6.6 mL/m² (for one side) in terms of a wet coated quantity and dried at 180° C. for 5 minutes, then the prescription of undercoat liquid <2> was coated on the other side of the support (back plane) with a wire bar so as to provide 5.7 mL/m² in terms of a wet coat quantity and dried at 180° C. for 5 minutes, and the prescription of undercoat liquid <3> was coated on the back of the support (back plane) with a wire bar so as to provide 7.7 mL/m² in terms of a wet coat quantity and dried at 180° C. for 6 minutes to fabricate the undercoat support.

Preparation of Coating Liquid for the Back Plane

Preparation of Coating Liquid for the Anti-Halation Layer

Lime-treated gelatin, 32.7 g; mono-disperse polymethylmethacrylate micro-particle (mean particle size 8 μm, standard deviation of particle size, 0.4 μm), 0.77 g; benzoisothiazoline, 0.08 g; polystyrene sulfonic sodium, 0.3 g; blue dye compound-1, 0.06 g; ultraviolet-absorbing agent-1, 1.5 g; acrylic acid/ethylacrylate copolymer latex (copolymerization ratio 5/95), 5.0 g; N,N-ethylene bis (vinyl suflone acetoamide), 1.7 g; were mixed with 40° C.-maintained water. Sodium hydroxide (1 mol/L) was added to the mixture to adjust the pH to 6.0 and water was further added to provide a total quantity of 818 mL solution. The thus prepared solution was used as a coating liquid for the anti-halation layer.

Preparation of Coating Liquid for Back Plane Protective Layer

Lime-treated gelatin, 66.5 g; liquid paraffin emulsion as liquid paraffin, 5.4 g; benzothiazolinone, 0.10 g; disodium sulfosuccinate (2-ethylhexyl), 0.5 g; polystyrene sodium sulfonic acid, 0.27 g; 2% fluorosurfactant (F-1) aqueous solution, 13.6 mL; acrylic acid/ethylacrylate copolymer (copolymerization ratio by weight 5/95), 10.0 g, were mixed with 40° C. -maintained water. Sodium hydroxide (1 mol/L) was added to the mixture to adjust the pH to 6.0 and water was further added to provide a total quantity of 1000 mL solution. Thus prepared solution was used as a coating liquid for the back plane protective layer.

1-3: Image Forming Layer, Intermediate Layer and Surface Protective Layer

1-3-1: Preparation of Coating Materials

1) Preparation of Silver Halide Emulsion

Preparation of Silver Halide Emulsion 1-1 (AgBr 96.5, I 3.5)

3.1 mL of 1% by weight potassium bromide was added to 1420 mL distilled water, and 3.5 mL of sulfuric acid with 0.5 mL concentration and 36.5 g of phthalic gelatin were added thereto. The thus prepared mixture was stirred in a stainless-steel reaction tank and maintained at 30° C., and 22.22 g of silver nitrate was diluted to 95.4 mL solution by adding distilled water, which was designated as Solution A, and 15.3 g of potassium bromide and 0.8 g of potassium iodide were diluted to a 97.4 mL solution by adding distilled water, which was designated as Solution B. These Solutions A and B were added in a whole quantity to the mixture at a constant flow rate for 45 seconds. Then, 10 mL of 3.5% by weight hydrogen peroxide solution was added and 10.8 mL of 10% by weight benzoimidazole was also added thereto.

Further, 51.86 g of silver nitrate was diluted to 317.5 mL by adding distilled water, which was designated as Solution C, and 44.2 g of potassium bromide and 2.2 g of potassium iodide were diluted to 400 mL by adding distilled water, which was designated as Solution D. Solution C was added in a whole quantity of at a constant flow rate for 20 minutes and Solution D was maintained at pAg 8.1 and added by the control double jet (CDJ) method. Ten minutes after the addition of Solutions C and D was started, potassium iridium (III) hexa-chloride was added in a whole quantity so as to provide 1×10⁻⁴ mol in relation to 1 mol of silver. Five seconds after completed addition of Solution C, aqueous solution of potassium iron (II) hexa-cyanide was added in a whole quantity so as to provide 3×10⁻⁴ mol in relation to 1 mol of silver. Sulfuric acid with 0.5 mol/L concentration was added to adjust the pH to 3.8. Stirring was ceased to carry out the process of sedimentation, desalting and water-washing.

Sodium hydroxide with a 1 mol/L concentration was used to adjust the pH to 5.9, and silver halide dispersion with pAg 8.0 was prepared.

The above silver halide dispersion was maintained at 38° C., with stirring, and 5 mL of methanol solution of 1,2-benzoisothiazoline-3-one (0.34% by weight) was added and the temperature was raised to 47° C. Twenty minutes after the temperature was raised, benzene thiosufonic sodium was added in the form of methanol solution at 7.6×10⁻⁵ mol in relation to 1 mol of silver, and 5 minutes thereafter, tellurium sensitizer C was added in the form of methanol solution at 2.9×10⁻⁴ mol in relation to 1 mol of silver and the resultant was aged for 91 minutes.

Further, 1.3 mL of methanol solution (0.8% by weight) of N,N′-dihydroxy-N′-diethylmalmine was further added, and 4 minutes thereafter, 5-methyl-2-mercaptobenzoimidazole was added in the form of methanol solution at 4.8×10⁻³ mol in relation to 1 mol of silver, and 1-phenyl-2-heptyl-5-mercapto-1,3,4-triazole was added in the form of methanol solution at 5.4×10⁻³ mol in relation to 1 mol of silver to prepare silver halide emulsion 1-1.

The particle of the thus prepared silver halide emulsion was an iodine silver bromide particle with the mean sphere equivalent diameter of 0.040 μm and coefficient variation of the sphere equivalent diameter of 18%, containing 3.5 mol % of silver iodide. The particle size and others were determined from the mean value of 1000 particles under electron microscopic observation.

Preparation of Silver Halide Emulsion 1-2 (AgI 100)

3.1 mL of 1% by weight potassium iodide was added to 1420 mL distilled water, and 3.5 mL of sulfuric acid with 0.5 mol/L concentration and 31.7 g of phthalic gelatin were added thereto. The thus prepared mixture was stirred in a stainless-steel reaction tank and maintained at 34° C. 74.08 g of silver nitrate was diluted to 649.9 mL solution by adding distilled water, which was designated as Solution A, and 80 g of potassium iodide was diluted to 800 mL solution by adding distilled water, which was designated as Solution B. Solution A was added in a whole quantity at a constant flow rate for 100 minutes and Solution B was maintained at pAg 10.0 and added by CDJ method.

Thereafter, 10 minutes after addition of Solutions A and B was started, 10 mL of hydrogen peroxide solution (3.5% by weight) and 10.8 mL of benzoimidazole (10% by weight) were added and 10 minutes further thereafter potassium iridium (III) hexa-chloride was added in a whole quantity so as to provide 1×10⁻⁴ mol in relation to 1 mol of silver.

Sulfuric acid with 0.5 mol/L concentration was added to adjust the pH to 3.8. Stirring was ceased to carry out the processes of sedimentation, desalting and water-washing.

Sodium hydroxide with 1 mol/L concentration was used to adjust the pH to 5.9, and silver halide dispersion with pAg 8.0 was prepared. Silver halide emulsion 1-2 was prepared under the same conditions as those given in Example 1.

The particle of the thus prepared silver halide emulsion was a pure silver iodide particle of tetradecahedron with the mean sphere equivalent diameter of 0.040 μm and coefficient variation of the sphere equivalent diameter of 18%.

Preparation of Silver Halide Emulsion 1-3 (AgBr 10, I 90)

The silver halide emulsion 1-3 was prepared in a way similar to that used in preparing the silver halide emulsion 1-2 of Example 2, except that 72 g of potassium iodide and 5.7 g of potassium bromide were added and diluted by further addition of distilled water to 800 mL solution (Solution B), which was added by the CDJ method, with pAg maintained at 7.7.

The particle of the thus prepared silver halide emulsion was an iodine silver bromide particle of tetradecahedron with the mean sphere equivalent diameter of 0.040 μm and coefficient variation of the sphere equivalent diameter of 19%, containing 90 mol % silver iodide.

Preparation of Silver Halide Emulsion 1-4 (AgBr 20, I 80)

The silver halide emulsion 1-4 was prepared in a way similar to that used in preparing the silver halide emulsion 1-2 of Example 2, except that 64 g of potassium iodide and 11.4 g of potassium bromide were added and diluted by adding distilled water to 800 mL solution (Solution B), which was added by the CDJ method, with pAg maintained at 7.4.

The particle of the thus prepared silver halide emulsion was an iodine silver bromide particle of tetradecahedron with the mean sphere equivalent diameter of 0.040 μm and coefficient variation of the sphere equivalent diameter of 21%, containing 80 mol % silver iodide.

Preparation of silver halide emulsion 1-5 (Ag Br 56, I 44)

The silver halide emulsion 1-5 was prepared in a way similar to that used in preparing the silver halide emulsion 1-2 of Example 2, except that 35.0 g of potassium iodide and 32.0 g of potassium bromide were added and diluted by further addition of distilled water to 800 mL solution (Solution B), which was added by the CDJ method, with pAg maintained at 7.1.

The particle of the thus prepared silver halide emulsion was an iodine silver bromide particle with the mean sphere equivalent diameter of 0.040 μm and coefficient variation of the sphere equivalent diameter of 18%, containing 44 mol % silver iodide on average. The particle size and others were determined from the mean value of 1000 particles under electron microscopic observation.

Preparation of Mixture Emulsion 1 for Coating Liquid

Silver halide emulsion 1-1 was dissolved and 1% by weight benzothiazolium iodide aqueous solution was added thereto at 7×10⁻³ mol in relation to 1 mol of silver. Water was added to the resultant so that silver halide was incorporated at 38.2 g for 1 kg of the mixture emulsion 1 for each coating liquid.

Preparation of Mixture Emulsions for Coating Liquid 1-2 to 1-5

Mixture emulsions for coating liquid 2 to 5 were prepared in a way similar to that used in preparing the mixture emulsion for coating liquid 1-1 except that silver halide emulsions 1-2 to 1-5 were dissolved in place of the silver halide emulsion.

2) Preparation of Aliphatic Acid Silver Dispersion

87.6 kg of behenic acid (trade name: Edenor C22-85R, manufactured by Henkel), 423L of distilled water, 49.2 L of NaOH solution (5 mol/L concentration) and 120 L of t-butylalcohol were mixed and allowed to react at 75° C. for 1 hour—by stirring to obtain sodium behenic acid solution. Separately, 40.4 kg of silver nitrate was dissolved in water to prepare 206.2 L of silver nitrate solution (pH 4. 0), which was maintained at 10° C. A reaction vessel containing 635 L of distilled water and 30 L of t-butyl alcohol was maintained at 30° C., to which sodium behenic acid solution and silver nitrate solution were added in a whole quantity at a constant flow rate for 93 minutes and 15 seconds and 90 minutes respectively, with sufficient stirring.

In this instance, care was taken so that only silver nitrate solution was added for 11 minutes after start of the addition, and only sodium behenic acid solution was added for 14 minutes and 15 seconds after completed addition of silver nitrate solution. Ambient temperatures were controlled so that the solution was kept constantly at 30° C. inside the reaction vessel.

The sodium behenic acid solution was added through a double-layered pipe system, through the outer layer of which warm water was circulated to keep warm so that the solution temperature at the outlet was maintained at 75° C. at the tip of the nozzle for adding the solution. The silver nitrate solution was added through a double-layered pipe system, through the outer layer of which cold water was circulated to keep the temperature constant. The positions at which the sodium behenic acid solution and the silver nitrate solution were added were in a symmetrical position in relation to the center of the axis of the stirrer. The height was also adjusted in deciding the position so as not to contact with the reaction solution.

After addition of the sodium behenic acid solution, the thus prepared solution was allowed to stand for 20 minutes, with the temperature kept as it was. Then, the temperature was raised to 35° C. for 30 minutes and the solution was aged for 210 minutes. Immediately after completion of aging, the solution was centrifuged to separate the solid, which was washed with water until the conductivity of filtrate reached 30 μS/cm. Aliphatic acid silver salt was obtained through these processes. The separated solid was not dried but maintained as wet cake.

Electron microscopic observation was made for the configuration of the thus obtained silver behenate particle, discovering that it was flaky crystal having a=0.14 μm, b=0.4 μm and c=0.6 μm on average, mean aspect ratio of 5.2, mean sphere equivalent diameter of 0.52 μm and coefficient variation of the sphere equivalent diameter of 15%. (a, b and c were defined in the text).

19.3 kg of polyvinyl alcohol (trade name: PVA-217, manufactured by Kuraray Co., Ltd.) and water were added to the wet cake (equivalent to 260 kg on d.s.b.) to provide a total quantity of 1000 kg. The resultant was converted into a slurry by using a dissolver blade and preliminarily dispersed by using a pipeline mixer (trade name: PM-10 model, manufactured by Mizuho Industrial Co., Ltd.)

Then, the thus-preliminarily dispersed bulk solution was treated 3 times by using a disperser (trade name: Microfluidizer-M-610, manufactured by Microfluidex International Corporation, use of Z-type interaction chamber), with the pressure adjusted to 1260 kg/cm², to obtain silver behenate dispersion. In the cooling operation, coiled heat exchangers were fixed before and after the interaction chamber to adjust the temperature of the coolant so that the dispersion temperature was maintained at 18° C.

3) Preparation of Reducing Agent Dispersion

Preparation of Reducing Agent-1 Dispersion

10 kg of reducing agent-1 and 16 kg of 10% by weight modified polyvinyl alcohol aqueous solution (trade name: Poval MP203, manufactured by Kuraray Co., Ltd.) were added to 10 kg of water and mixed well to prepare a slurry.

The slurry was fed with a diaphragm pump and subjected to 3 hour- and 30 minute-dispersion by using a model sand mill (trade name: UVM-2, manufactured by Imex) in which zirconia beads (0.5 mm in mean diameter) were packed, and then 0.2 g of benzothiazolinone sodium and water were added to adjust the concentration of the reducing agent to 25% by weight, thus obtaining the reducing agent-1 dispersion.

A reducing-agent particle contained in the thus obtained dispersion was 0.40 μm in the median diameter and 1.5 μm or lower in the maximum particle diameter. The reducing agent dispersion was filtered through a 3.0 μm-pore size polypropylene filter to remove solids such as residues for subsequent retention.

4) Preparation of Hydrogen-Bond Compound Dispersion

Preparation of Hydrogen-Bond Compound-1 Dispersion

10 kg of hydrogen bond compound-1 and 16 kg of 10% by weight modified polyvinyl alcohol aqueous solution (trade name: Poval MP203, manufactured by Kuraray Co., Ltd.) were added to 10 kg of water and mixed well to prepare a slurry.

The slurry was fed with a diaphragm pump and subjected to 3 hour- and 30 minute-dispersion by using a horizontal-type sand mill (trade name: UVM-2, manufactured by Imex) in which zirconia beads (0.5 mm in mean diameter) were packed, and then 0.2 g of benzothiazolinone sodium and water were added to adjust the concentration of the hydrogen bond compound to 25% by weight, thus obtaining the hydrogen bond compound-1 dispersion.

A hydrogen bond compound particle contained in the thus obtained hydrogen bond compound dispersion was 0.35 μm in the median diameter and 1.5 μm or lower in the maximum particle diameter. The hydrogen bond compound dispersion was filtered through a 3.0 μm-pore size polypropylene filter to remove foreign matter such as residues for subsequent retention.

5) Preparation of Development Accelerator Dispersion and Image Tone Modifier Dispersion

Preparation of Development Accelerator-1 Dispersion

10 kg of the development accelerator-1 and 20 kg of 10% by weight modified polyvinyl alcohol aqueous solution (trade name: Poval MP203, manufactured by Kuraray Co., Ltd.) were added to 10 kg of water and mixed well to prepare a slurry.

The slurry was fed with a diaphragm pump and subjected to 3 hour- and 30 minute-dispersion by using a horizontal-type sand mill (trade name: UVM-2, manufactured by Imex) in which zirconia beads (0.5 mm in mean diameter) were packed, and then 0.2 g of benzothiazolinone sodium and water were added to adjust the concentration of the development accelerator to 20% by weight, thus obtaining the development accelerator-1 dispersion.

A development accelerator particle contained in the thus obtained development accelerator dispersion was 0.48 μm in the median diameter and 1.4 μm or lower in the maximum particle diameter. The development accelerator dispersion was filtered through a 3.0 μm-pore size polypropylene filter to remove foreign matter such as residues for subsequent retention.

Development Accelerator-2 Dispersion, Development Accelerator-3 Dispersion and Image Tone Modifier-1 Dispersion

Solid dispersions of development accelerator-2 dispersion, development accelerator-3 dispersion and image tone modifier-1 dispersion were dispersed similarly to the development accelerator-1 to obtain 20% by weight dispersions.

6) Preparation of Poly-Halogen Compound Dispersion

Preparation of Organic Poly-Halogen Compound Dispersion-1

10 kg of the organic poly-halogen compound-1, 10 kg of 20% by weight modified polyvinyl alcohol aqueous solution (trade name: Poval MP203, manufactured by Kuraray Co., Ltd.) and 0.4 kg of 20% by weight sodium triisopropylnaphthalen sulfonate aqueous solution were added to 14 kg of water and mixed well to prepare a slurry.

The slurry was fed with a diaphragm pump and subjected to 5 hour-dispersion by using a model sand mill (trade name: UVM-2, manufactured by Imex) in which zirconia beads (0.5 mm in mean diameter) were packed, and then 0.2 g of benzothiazolinone sodium and water were added to adjust the concentration of the organic poly-halogen compound to 26% by weight, thus obtaining the organic poly-halogen compound-1 dispersion.

An organic poly-halogen compound particle contained in the thus obtained organic poly-halogen compound dispersion was 0.41 μm in the median diameter and 2.0 μm or lower in the maximum particle diameter. The organic poly-halogen compound dispersion was filtered through a 10.0 μm-pore size polypropylene filter to remove foreign matter such as residues for subsequent retention.

Preparation of Organic Poly-Halogen Compound Dispersion-2

10 kg of the organic poly-halogen compound-2 was added to 20 kg of 10% by weight modified polyvinyl alcohol aqueous solution (trade name: Poval MP203, manufactured by Kuraray Co., Ltd.) and 0.4 kg of sodium triisopropylnaphthalen sulfonate (20% by weight) solution and mixed well to prepare a slurry.

The slurry was fed with a diaphragm pump and subjected to 5 hour-dispersion by using a horizontal-type sand mill (trade name: UVM-2, manufactured by Imex) in which zirconia beads (0.5 mm in mean diameter) were packed, and then 0.2 g of benzoisothiazolinone sodium and water were added to adjust the concentration of the organic poly-halogen compound to 30% by weight. The dispersion was heated at 40° C. for 5 hours to obtain the organic poly-halogen compound-2 dispersion.

An organic poly-halogen compound particle contained in the thus obtained organic poly-halogen compound dispersion was 0.40 μm in the median diameter and 1.3 μm or lower in the maximum particle diameter. The organic poly-halogen compound dispersion was filtered through a 3.0 μm-pore size polypropylene filter to remove foreign matter such as residues for subsequent retention.

7) Preparation of Phthalazine Compound Solution

Preparation of Phthalazine Compound Solution-1

8 kg of modified polyvinyl alcohol (trade name: Poval MP203, manufactured by Kuraray Co., Ltd.) was dissolved in 174.57 kg of water. Then, 3.15 kg of 20% by weight sodium trisiopropylnaphthalen sulfonate solution and 14.28 kg of 70% by weight phthalazine compound-1 solution (6-isopropyl phthalazine) were added thereto to prepare phthalazine compound-1 solution (5% by weight).

8) Preparation of Mercapto Compound Solution

Preparation of Mercapto Compound Solution-1

Seveng of mercapto compound-1 was dissolved in 993 g of water to provide an aqueous solution (0.7% by weight).

Preparation of Aqueous Solution of Mercapto Compound-2

20 g of mercapto compound-2 was dissolved in 980 g of water to provide an aqueous solution (20% by weight).

9) Preparation of Pigment-1 Dispersion

64 g of pigment (C.I. Pigment Blue 60 and Demaul N (trade name, manufactured by Kao Corporation) was dissolved in 250 g of water and mixed well to obtain a slurry. Zirconia beads, 800 g, (mean particle size of 0.5 mm) were provided and added together with the slurry into a vessel. The mixture was dispersed with a ¼ g sand grinder mill (manufactured by Imex) for 25 hours. Then, water was added to adjust the concentration to 5% by weight to obtain the pigment-1 dispersion. A pigment particle contained in the thus obtained pigment dispersion was 0.21 μm in the median diameter.

10) Preparation of SBR Latex Solution

Preparation of SBR Latex Solution

SBR latex with Tg=22° C. was prepared as follows:

Ammonium persulfate was used as a polymerization starter and anion surfactant was used as an emulsifier to cause styrene 70.0 by weight, butadiene 27.0 by weight and acrylic acid 3.0 by weight to undergo emulsification and polymerization. The resultant was aged for 8 hours at 80° C., and then cooled to 40° C. Ammonia water and surfactant (trade name: Sandette BL, manufactured by Sanyo Chemical Industries Ltd.) were added thereto to adjust the pH to 7.0 and the concentration to 0.22%. Further, 5% sodium hydroxide solution was added to adjust the pH to 8.3 and then ammonia water was added to adjust the pH to 8.4.

In this instance, the mole ratio of Na+ ion to NH₄⁺ ion was 1:2.3. Further, 0.15 mL of 7% sodium benzothiazolinone aqueous solution was added to the resultant to prepare SBR latex solution.

(SBR latex: latex of -St (70.0) -Bu (27.0) AA (3.0)) with the following properties: Tg: 22° C.; mean particle size, 0.1 μm; concentration, 43% by weight; equilibrium water content at 25° C., 60%RH, 0.6% by weight; ion conductivity, 4.2 mS/cm (determined at 25° C. for latex bulk solution (43% by weight) by using a diagometer (trade name: CM-30S, manufactured by Toa Denpa Kogyo Co., Ltd.); pH, 8.4.

SBR latexes with different Tg can be prepared similarly through appropriate change in the ratio of styrene to butadiene.

1-3-2. Preparation of Coating Liquid

1) Preparation of Coating Liquid for the Image Forming Layer (Photosensitive Layer)-1-1

1000 g of aliphatic acid silver dispersion, 276 mL of water, 3.2 g of organic poly-halogen compound-1 dispersion, 8.7 g of organic poly-halogen compound-2 dispersion that were prepared as above, and 173 g of phthalazine compound-1 solution, 1082 g of SBR latex solution (Tg: 22° C.), 155 g of reducing agent-1 dispersion, 55 g of hydrogen bond compound-1 dispersion, 1 g of development accelerator-1 dispersion, 2 g of development accelerator-2 dispersion, 3 g of development accelerator-3 dispersion, 2 g of image tone modifier-1 dispersion, 9 mL of mercapto compound-i aqueous solution and 27 mL of mercapto compound-2 aqueous solution that were enlisted in Table 1 were added sequentially, and 117 g of silver halide mixture emulsion enlisted in Table 1 was added immediately before coating and mixed well to prepare a coating liquid for the image forming layer. The thus prepared coating liquid was fed directly to a coating die and coated.

The viscosity of the coating liquid for the image forming layer was determined with a B-type viscometer (Tokyo Keiki Kogyo Co., Ltd.) to find 20 mPa·s at 40° C. (No. 1 rotor, 60 rpm).

2) Preparation of Coating Liquid for Emulsion Surface Intermediate Layer

27 mL of 5% by weight surfactant aqueous solution (trade name: Aerozol OT, American Cyanaide), 135 mL of 20% by weight diammonium phthalate aqueous solution and water were added to 1000 g of polyvinyl alcohol (trade name: PVA-205, manufactured by Kuraray), 272 g of 5% by weight pigment-1 dispersion, 4200 mL of 19% by weight methylmethacrylate/styrene/buthylacrylate/hydroxyethylmethacrylate/acryl acid copolymer latex solution (copolymerization ratio: 64/9/20/5/2) to provide a total quantity of 10,000 g. Further, NaOH was added thereto to adjust the pH to 7.5 to prepare the coating liquid for the intermediate layer, which was fed to the coating die so as to provide a coated quantity of 9.1 mL/m².

The viscosity of the coating liquid determined with a B-type viscometer at 40° C. (No. 1 rotor, 60 rpm) was 58 mPa·s.

3) Preparation of Coating Liquid for the Emulsion Surface Protective Layer (First Layer)

64 g of inert gelatin was dissolved in water, and 80 g of 27.5% by weight methylmethacrylate/styrene/buthylacrylate/hydroxyethylmethacrylate/acryl acid copolymer latex solution (copolymerization ratio: 64/9/20/5/2), 23 mL of 10% by weight methacrylate solution of phthalic acid, 23 mL of 10% by weight 4-methylphthalate aqueous solution, 28 mL of sulfuric acid (0.5 mol/L concentration), 5 mL of 5% by weight surfactant aqueous solution (trade name: Aerosol OT, American Cyanide), 0.5 g of phenoxyethanol and 0.1 g of benzothiazoline were added and mixed in water to prepare the coating liquid (a total quantity of 750 g). Immediately before coating, 26 mL of 4% by weight chrome alum was mixed with the coating liquid by using a static mixer, which was fed to the coating die so as to provide a coated quantity of 18.6 mL/m².

The viscosity of the coating liquid determined with a B-type viscometer at 40° C. (No. 1 rotor, 60 rpm) was 20 mPa·s.

4) Preparation of Coating Liquid of Emulsion Surface Protective Layer (the Second Layer)

80 g of inert gelatin was dissolved in water, and 10.2 g of 27.5% by weight methylmethacrylate/styrene/buthylacrylate/hydroxyethylmetacrylate/acryl acid copolymer latex solution (copolymerization ratio: 64/9/20/5/2), 3.2 mL of 5% by weight fluorosurfactant solution(F-1), 32 mL of 2% by weight fluorosurfactant solution(F-2), 3 mL of 5% by weight fluorosurfactant solution(F-5), 10 mL of 2% by weight fluorsurfactant solution(F-6), 23 mL of 5% by weight surfactant solution (trade name: Aerosol OT, American Cyanide), 4 g of polymethylmethacrylate micro-particle (0.7 μm mean particle size), 21 g of polymethylmethacrylate micro-particle (mean diameter: 4.5 μm) 1.6 g of 4-methyl phthalate, 4.8 g of phthalic acid, 44 mL of sulfuric acid (0.5 mol/L concentration) and 10 mg of benzothiazoline were added and mixed in water to prepare the coating liquid (a total quantity of 650 g). Immediately before coating, 445 mL of aqueous solution containing 4% by weight chrome alum and 0.67% by weight phthalic acid was mixed by using a static mixer to provide 445 mL of the coating liquid, which was fed to the coating die so as to provide a coated quantity of 8.3 mL/m².

The viscosity of the coating liquid determined with a B-type viscometer at 40° C. (No. 1 rotor, 60 rpm) was 19 mPa·s.

1-4. Preparation of Photothermographic Material 1-1

A coating liquid for anti-halation layer was coated on both sides of the above-described undercoat support so as to provide a light absorption of 0.3 at 504 nm and at the same time a coating liquid for the back plane protective layer was coated to attain a gelatin coated quantity of 1.7 g/m², which were dried to prepare the back layer.

A multi-coating was given by a slide bead coating method to the surface opposite to the back plane in the order of the image forming layer, intermediate layer, first protective layer and second protective layer starting from the undercoat layer to prepare samples of the photothermographic material.

The image forming layer and intermediate layer were adjusted to 31° C., the first protective layer was adjusted to 36° C. and the second protective layer was adjusted to 37° C.

The following shows the coated quantity (g/m²) for individual compounds on the image forming layer.

| | |
|---|---|
| Silver behenate | 5.55 |
| Organic poly-halogen compound-1 | 0.02 |
| Organic poly-halogen compound-2 | 0.06 |
| Phthalazine compound-1 | 0.19 |
| SBR latex | 9.67 |
| Reducing agent-1 | 0.81 |
| Hydrogen bond compound-1 | 0.30 |
| Development accelerator-1 | 0.004 |
| Development accelerator-2 | 0.010 |
| Development accelerator-3 | 0.015 |
| Image tone modifier-1 | 0.010 |
| Mercapto compound-1 | 0.002 |
| Mercapto compound-2 | 0.012 |
| Silver halide | 0.091 |
| | (as Ag) |

Coating was carried out under the following conditions: feeding rate of 160 m/minute, clearance between the tip of the coating die and the support is 0.10 to 0.30 mm, and pressure at the decompression chamber established to a lower level of 196 to 882 Pa in relation to atmospheric pressure. The support was subjected to ion aeration to remove static electricity before coating.

At the subsequent chilling zone, the coating liquid was cooled through aeration at a dry-bulb temperature of 10 to 20° C. It was fed under a non-contacting condition and dried by using a non-contacting drier (Tsurumasa type) through aeration at a dry-bulb temperature of 23 to 45° C. and wet-bulb temperature of 15 to 21° C.

After the drying liquid was adjusted for humidity 40 to 60%RH at 25° C., and then the surface was heated to 70 to 90° C., and after heating cooled to 25° C.

The degree of matting represented by Bekk smoothness of thus obtained photothermographic material was found to be 550 seconds for the plane of the image forming layer and 130 seconds for the back plane. The emulsion surface on the side of the image forming layer was found to be pH 6.0.

The photothermographic material 1-1 was obtained by the above-described procedures.

Preparation of Photothermographic Materials 1-2 to 1-5

The above-described halide emulsions 2 to 5 were used to prepare photothermographic materials 1-2 to 1-5 under the same conditions as those described in the photothermographic material 1-1.

Image Evaluation

The following evaluation was made for individual samples of the photothermographic material 1-1 to 1-4.

Arrangement

The samples were cut in half and placed inside the packaging material to be described below at ambient temperatures of 25° C. 80%RH, 25° C. 80%RH, 25° C. 60%RH, 25° C. 40%RH and 25° C. 30%RH, and heated so that the emulsion surface can reach at 70° C. to 90° C. After heating, the thus wrapped samples were cooled down to 25° C. and stored in containers maintained constantly at 25° C. and 40° C. for 2 weeks and 1 month respectively. Thereafter, the packaging material was opened at 25° C. to determine the inner temperatures and to make the following evaluation.

The photothermographic materials cut similarly as above were also wrapped in the following packaging material at an ambient temperature of 25° C. 80%%RH and stored in containers maintained constantly at 25° C. and 40° C. for 2 weeks. Thereafter, the packaging material was opened at 25° C. to determine the inner temperatures and to make the following evaluation.

Packaging Material

The packaging material consisting of PET 10 μm/PE 12 μm/aluminum foil 9 μm/Ny 15 μm/3% carbon-containing PE 50 μm was determined for oxygen permeability under the conditions of test temperature, 25° C.; test humidity, 0%RH and gas concentration of 100%, finding the oxygen permeability of 0 mL/atm·m²·25° C.·day.

The said packaging material was determined for moisture permeability at test temperature, 25° C. and 90%RH, finding the moisture permeability of 0 g/atm·m²·25° C.·day.

Exposure of Photothermographic Material

Individual samples of the thus prepared photothermographic material were subjected to the following exposure treatment.

A semi-conductor laser (trade name: NLHV3000E, manufactured by Nichia Corporation) was fixed at a semi-conductor laser light source around the exposure site of Fuji Medical Dry Laser Imager FM-DPL (trade name, manufactured by Fuji Film Medical Co., Ltd.) and the beam diameter was narrowed down to approx. 100 μm. The laser light intensity was allowed to change in a range of 0 and 1 mW/mm^{2 to} 1000 mW/mm² to attain exposure of the sensitive material at 10⁻⁶ second.

The emitting wavelength from the laser light was 405 nm.

Thermal development of the photothermographic material

The exposed samples of the photothermographic material were subjected to the following thermal development.

The samples were exposed and heat-developed with Fuji Medical Dry Laser Imager FM-DPL (trade name, manufactured by Fuji Film Medical Co., Ltd.) where 4 units of panel heaters were set at the respective temperatures of 115° C., 115° C., 118° C. and 118° C. (at thermal development area) and the film feeding rate was increased so as to attain a total thermal development time of 14 seconds.

Evaluation of the Samples

The obtained images were evaluated by means of a densitometer to prepare a characteristic curve of the density in relation to the logarithm of exposed light intensity.

A reciprocal of light exposure that obtains the optical density of 3.0 was used as sensitivity, and the sensitivity before storage for each sensitive material was defined as 100 to express the sensitivity after storage as a relative value.

The results are shown in Tables 1, 2, 3 and 4.

TABLE 1

| | | | Total silver | Humidity | | | | |
|---|---|---|---|---|---|---|---|---|
| | | Total silver | bromide | inside the | Storage | Sensitivity | Sensitivity | |
| Experiment | Sample | iodide content | content | packaging | temperature | after storage | after storage | |
| No. | No. | (mol %) | (mol %) | material (%) | (° C.) | (2 weeks) | (1 month) | Remarks |
| 1 | 1-1 | 3.5 | 96.5 | 30 | 25 | 100 | 90 | Control |
| 2 | 1-2 | 100 | 0 | 30 | 25 | 97 | 94 | Example of |
| | | | | | | | | the invention |
| 3 | 1-3 | 90 | 10 | 30 | 25 | 101 | 96 | Example of |
| | | | | | | | | the invention |
| 4 | 1-4 | 80 | 20 | 30 | 25 | 95 | 96 | Example of |
| | | | | | | | | the invention |
| 5 | 1-5 | 44 | 56 | 30 | 25 | 94 | 92 | Example of |
| | | | | | | | | the invention |
| 6 | 1-1 | 3.5 | 96.5 | 30 | 40 | 90 | 85 | Control |
| 7 | 1-2 | 100 | 0 | 30 | 40 | 91 | 85 | Example of |
| | | | | | | | | the invention |
| 8 | 1-3 | 90 | 10 | 30 | 40 | 97 | 83 | Example of |
| | | | | | | | | the invention |
| 9 | 1-4 | 80 | 20 | 30 | 40 | 83 | 79 | Example of |
| | | | | | | | | the invention |
| 10 | 1-5 | 44 | 56 | 30 | 40 | 88 | 82 | Example of |
| | | | | | | | | the invention |

TABLE 2

| | | | Total silver | Humidity | | | | |
|---|---|---|---|---|---|---|---|---|
| | | Total silver | bromide | inside the | Storage | Sensitivity | Sensitivity | |
| Experiment | Sample | iodide content | content | packaging | temperature | after storage | after storage | |
| No. | No. | (mol %) | (mol %) | material (%) | (° C.) | (2 weeks) | (1 month) | Remarks |
| 11 | 1-1 | 3.5 | 96.5 | 40 | 25 | 97 | 84 | Control |
| 12 | 1-2 | 100 | 0 | 40 | 25 | 95 | 77 | Example of |
| | | | | | | | | the invention |
| 13 | 1-3 | 90 | 10 | 40 | 25 | 100 | 75 | Example of |
| | | | | | | | | the invention |
| 14 | 1-4 | 80 | 20 | 40 | 25 | 95 | 81 | Example of |
| | | | | | | | | the invention |
| 15 | 1-5 | 44 | 56 | 40 | 25 | 92 | 81 | Example of |
| | | | | | | | | the invention |
| 16 | 1-1 | 3.5 | 96.5 | 40 | 40 | 98 | 80 | Control |
| 17 | 1-2 | 100 | 0 | 40 | 40 | 85 | 72 | Example of |
| | | | | | | | | the invention |
| 18 | 1-3 | 90 | 10 | 40 | 40 | 86 | 77 | Example of |
| | | | | | | | | the invention |
| 19 | 1-4 | 80 | 20 | 40 | 40 | 87 | 79 | Example of |
| | | | | | | | | the invention |
| 20 | 1-5 | 44 | 56 | 40 | 40 | 85 | 79 | Example of |
| | | | | | | | | the invention |

TABLE 3

| | | | Total silver | Humidity | | | | |
|---|---|---|---|---|---|---|---|---|
| | | Total silver | bromide | inside the | Storage | Sensitivity | Sensitivity | |
| Experiment | Sample | iodide content | content | packaging | temperature | after storage | after storage | |
| No. | No. | (mol %) | (mol %) | material (%) | (° C.) | (2 weeks) | (1 month) | Remarks |
| 21 | 1-1 | 3.5 | 96.5 | 60 | 25 | 93 | 82 | Control |
| 22 | 1-2 | 100 | 0 | 60 | 25 | 93 | 59 | Example of |
| | | | | | | | | the invention |
| 23 | 1-3 | 90 | 10 | 60 | 25 | 93 | 58 | Example of |
| | | | | | | | | the invention |
| 24 | 1-4 | 80 | 20 | 60 | 25 | 93 | 72 | Example of |
| | | | | | | | | the invention |
| 25 | 1-5 | 44 | 56 | 60 | 25 | 92 | 73 | Example of |
| | | | | | | | | the invention |
| 26 | 1-1 | 3.5 | 96.5 | 60 | 40 | 86 | 79 | Control |
| 27 | 1-2 | 100 | 0 | 60 | 40 | 83 | 53 | Example of |
| | | | | | | | | the invention |
| 28 | 1-3 | 90 | 10 | 60 | 40 | 83 | 63 | Example of |
| | | | | | | | | the invention |
| 29 | 1-4 | 80 | 20 | 60 | 40 | 78 | 76 | Example of |
| | | | | | | | | the invention |
| 30 | 1-5 | 44 | 56 | 60 | 40 | 81 | 73 | Example of |
| | | | | | | | | the invention |

TABLE 4

| | | | Total silver | Humidity | | | | |
|---|---|---|---|---|---|---|---|---|
| | | Total silver | bromide | inside the | Storage | Sensitivity | Sensitivity | |
| Experiment | Sample | iodide content | content | packaging | temperature | after storage | after storage | |
| No. | No. | (mol %) | (mol %) | material (%) | (° C.) | (2 weeks) | (1 month) | Remarks |
| 31 | 1-1 | 3.5 | 96.5 | 80 | 25 | 86 | 80 | Control |
| 32 | 1-2 | 100 | 0 | 80 | 25 | 75 | 51 | Control |
| 33 | 1-3 | 90 | 10 | 80 | 25 | 68 | 52 | Control |
| 34 | 1-4 | 80 | 20 | 80 | 25 | 79 | 49 | Control |
| 35 | 1-5 | 44 | 56 | 80 | 25 | 82 | 56 | Control |
| 36 | 1-1 | 3.5 | 96.5 | 80 | 40 | 79 | 75 | Control |
| 37 | 1-2 | 100 | 0 | 80 | 40 | 57 | 48 | Control |
| 38 | 1-3 | 90 | 10 | 80 | 40 | 60 | 49 | Control |
| 39 | 1-4 | 80 | 20 | 80 | 40 | 73 | 46 | Control |
| 40 | 1-5 | 44 | 56 | 80 | 40 | 71 | 52 | Control |

As apparent from Tables 1 through 4, the photothermographic material of the invention that contained a high iodide silver halide emulsion with silver iodine content ranging from 40 mol % or greater to 100 mol % or lower was less desensitized when raw stock of the photothermographic material was maintained under conditions of 25° C. and 60 RH % or lower (more specifically, 25° C. and 40 RH % or lower and 25° C. and 30 RH% or lower).

It was also found that when the silver iodine content was lower than 40 mol %, the image sensitivity was not greatly dependent on the humidity inside the packaging material. The humidity inside the packaging material did not affect greatly the sensitivity when silver bromide or silver iodide was used as silver halide. It was found that, in the invention, use of silver iodide-rich silver halide posed problems in storage stability, which was greatly dependent on the humidity inside the packaging material.

However, since a lower content of silver iodide may easily result in problems of fogging and printout, deterioration of output image or poor image storability, it is essentially necessary to keep the content of silver iodide exceeding 40 mol %. Further, since the image is formed at an exposed wavelength of 405 nm by utilization of a light absorption wavelength intrinsic to silver iodide, a content of silver bromide exceeding 60 mol % decreases the absolute sensitivity.

Therefore, in order to prevent the problems of fogging and printout, inhibit desensitization resulting from the humidity of raw stock of the photothermographic material and also to form images by exposure at a wavelength such as that of blue laser, the photothermographic material must be provided with photosensitive silver halide in a total silver iodide content of 40 to 100 mol % and wrapped in such packaging material that can maintain the humidity of the material to 60%RH or lower at 25° C.

### Example 2-1

### Photothermographic Material 2-1

2-1. Fabrication of PET Support

In order to prepare the photothermographic material 2-1, a support for the undercoat layer was fabricated similarly as described in Example 1-1.

2-2. Preparation of Coating Liquid for Back Plane

17 g of gelatin, 9.6 g of polyacrylamdie, 1.5 g of mono-disperse polymethylmethacrylate micro-particle (mean particle size, 8 μm and standard deviation of particle size, 0.4), 0.03 g of benzothiazoline, 2.2 g of polyethylene sodium sulfonate, 0.1 g of blue dye compound-2 and 0.1 g of yellow dye compound-1 were mixed with 844 mL of water to prepare a coating liquid for the anti-halation layer.

Further, the container was maintained at 40° C., and 50 g of gelatin, 0.2 g of polystyrene sodium sulfonate, 2.4 g of N,N-ethylene bis (vinylsulfone acetoamide), 1 g of t-octylphenoxyethoxyethane sodium sulfonate, 30 mg of benzoisothiazoline, 2.7 mL of 2% by weight fluorosurfactant aqueous solution (F-5), 2.7 mL of 2% by weight fluorosurfactant aqueous solution (F-4), 8.8 g of acrylic acid/ethylacrylate copolymer (copolymerization ratio: 5/95), 0.6 g of surfactant (trade name: Aerosol OT, American Cyanide), liquid paraffin emulsion (1.8 g as liquid paraffin) were mixed with water to prepare a coating liquid for the back plane protective layer.

2-3. Image Forming Layer, Intermediate Layer and Surface Protective Layer

The image forming layer, intermediate layer and surface protective layers were also prepared according to the procedures shown below.

2-3-1. Arrangement of Coating Materials

Preparation of Silver Halide Emulsion

Preparation of Silver Halide Emulsion 2-1

4.3 mL of 1% by weight potassium bromide was added to 1420 mL of distilled water, and 3.5 mL of sulfuric acid with 0.5 mol/L concentration and 36.7 g of phthalic gelatin were added thereto. The thus prepared mixture was stirred in a stainless-steel reaction tank and maintained at 42° C. and 22.22 g of silver nitrate was diluted to 195.6 mL solution by adding distilled water, which was designated as Solution A, and 21.8 g of potassium iodide was diluted with distilled water to 218 mL solution, which was designated as Solution B. These Solutions A and B were added in a whole quantity to the mixture at a constant flow rate for 9 minutes. Then, 10 mL of 3.5% by weight hydrogen peroxide solution was added and 10.8 mL of 10% by weight benzoididazole was also added thereto.

Further, 51.86 g of silver nitrate was diluted to 317.5 mL by adding distilled water, which was designated as Solution C, and 60 g of potassium iodide was diluted to 600 mL by adding distilled water, which was designated as Solution D. A whole quantity of Solution C was added at a constant flow rate for 120 minutes and Solution D was maintained at pAg 8.1 and added by control double jet (CDJ) method. Ten minutes after addition of Solutions C and D was started, potassium iridium (III) hexa-chloride was added in a whole quantity so as to provide 1×10⁻⁴ mol in relation to 1 mol of silver. Five seconds after completed addition of Solution C, aqueous solution of potassium iron (II) hexa-cyanide was added in a whole quantity so as to provide 3×10⁻⁴ mol in relation to 1 mol of silver. Sulfuric acid with 0.5 mol/L concentration was added to adjust the pH to 3.8. Stirring was ceased to carry out the processes of sedimentation, desalting and water-washing. Sodium hydroxide with 1 mol/L concentration was used to adjust the pH to 5.9, and silver halide dispersion with pAg 8.0 was prepared.

The above silver halide dispersion was maintained at 38° C., with stirring, and 5 mL of methanol solution of 1,2-benzoisothiazoline-3-on (0.34% by weight) was added and the temperature was raised to 47° C. Twenty minutes after the temperature was raised, sodium benzene thiosufonate was added in the form of methanol solution at 7.6×10⁻⁵ mol in relation to 1 mol of silver, 5 minutes thereafter, tellurium sensitizer C was added in the form of methanol solution at 2.9×10⁻⁴ mol in relation to 1 mol of silver and the resultant was aged for 91 minutes.

1.3 mL of methanol solution (0.8% by weight) of N,N′-dihydroxy-N″-diethylmalmine was further added, and 4 minutes thereafter, 5-methyl-2-mercaptobenzimidazole was added in the form of methanol solution at 4.8×10⁻³ mol in relation to 1 mol of silver, and 1-phenyl-2-heptyl-5-mercapto-1,3,4-triazole was added in the form of methanol solution at 5.4×10⁻³ mol in relation to 1 mol of silver to prepare the silver halide emulsion 1.

The particle of the thus prepared silver halide emulsion was a pure iodine silver bromide particle with the mean sphere equivalent diameter of 0.040 μm and coefficient variation of the sphere equivalent diameter of 18%. The particle size and others were determined from the mean value of 1000 particles under electron microscopic observation.

Preparation of Silver Halide Emulsions 2-2,2-3 and 2-6

Silver halide emulsions 2-2,2-3 and 2-6 with uniform halogen compositions as enlisted in Table 5 were prepared in a way similar to that used in preparing the silver halide emulsion 2-1, however, except that the halogen to be added was changed in composition.

Particle size of the silver halide was adjusted by allowing the granulation temperature to change. A particle of the thus prepared silver halide emulsion was of the mean sphere equivalent diameter of 0.04 μm.

Preparation of Silver Halide Emulsion 2-4

3.1 mL of 1% by weight potassium bromide was added to 1421 mL distilled water, and 3.5 mL sulfuric acid with 0.5 mol/L concentration and 31.7 g of phthalic gelatin were added thereto. The thus prepared mixture was stirred in a stainless-steel reaction tank and maintained at 32° C. and 22.22 g of silver nitrate was diluted to a 95.4 mL solution by adding distilled water, which was designated as Solution A, and 15.6 g of potassium bromide was diluted with distilled water to a 97.4 mL solution, which was designated as Solution B. These Solutions A and B were added in a whole quantity to the mixture at a constant flow rate for 45 seconds.

Thereafter, 10 mL of 3.5% by weight hydrogen peroxide solution was added and a further 10.8 mL of 10% by weight benzoimidazole was added. Then, 30.64 g of silver nitrate was diluted to 187.6 mL by adding distilled water, which was designated as Solution C, and 21.5 g of potassium bromide was diluted to 400 mL by adding distilled water, which was designated as Solution D. A whole quantity of Solution C was added at a constant flow rate for 12 minutes and Solution D was maintained at pAg 8.1 and added by control double jet method.

Then, 22.2 g of silver nitrate was diluted by adding 130 mL of distilled water, which was designated as Solution E, and 21.7 g of potassium iodide was diluted to 217 mL by adding distilled water, which was designated as Solution F. These Solutions E and F were maintained at pAg 6.3 and added by control double jet method. Ten minutes after addition of Solutions C and D was started, potassium iridium (III) hexa-chloride was added in a whole quantity so as to provide 1×10⁻⁴ mol in relation to 1 mol of silver. Five seconds after the completed addition of Solution C, aqueous solution of potassium iron (II) hexa-cyanide was added in a whole quantity so as to provide 3×10⁻⁴ mol in relation to 1 mol of silver.

Sulfuric acid with 0.5 mol/L concentration was added to adjust the pH to 3.8. Stirring was ceased to carry out the processes of sedimentation, desalting and water-washing. Sodium hydroxide with 1 mol/L concentration was used to adjust the pH to 5.9, and silver halide dispersion with pAg 8.0 was prepared.

The above silver halide dispersion was maintained at 38° C., with stirring, and 5 mL of methanol solution of 1,2-benzoisothiazoline-3-on (0.34% by weight) was added and 1 minute thereafter the temperature was raised to 47° C. Twenty minutes after the temperature was raised, sodium benzene thiosufonate was added in the form of methanol solution at 7.6×10⁻⁵ mol in relation to 1 mol of silver, and 5 minutes thereafter, tellurium sensitizer C was added in the form of methanol solution at 2.9×10⁻⁴ mol in relation to 1 mol of silver and the resultant was aged for 91 minutes.

1.3 mL of methanol solution (0.8% by weight) of N,N′-dihydroxy-N″-diethylmalmine was further added, and 4 minutes thereafter, 5-methyl-2-mercaptobenzoimidazole was added in the form of methanol solution at 4.8×10⁻³ mol in relation to 1 mol of silver, and 1-phenyl-2-heptyl-5-mercapto-1,3,4-triazole was added in the form of methanol solution at 5.4×10⁻³ mol in relation to 1 mol of silver to prepare the silver halide emulsion 2-4.

The particle of the thus prepared silver halide emulsion was a particle of silver bromide layer (70 mol %) with the mean sphere equivalent diameter of 0.040 μm and coefficient variation of the sphere equivalent diameter of 20%, to which 30 mol % silver iodide layer was coupled. The part having the crystalline structure of silver iodide was provided with light absorption through direct transition.

Preparation of Silver Halide Emulsion 2-5

3.1 mL of 1% by weight potassium bromide was added to 1421 mL distilled water, and 3.5 mL sulfuric acid with 0.5 mol/L concentration and 31.7 g of phthalic gelatin were added thereto. The thus prepared mixture was stirred in a stainless-steel reaction tank and maintained at 34° C. and 22.22 g of silver nitrate was diluted to 95.4 mL solution by adding distilled water, which was designated as Solution A, and 15.7 g of potassium bromide was diluted with distilled water to 97.4 mL solution, which was designated as Solution B. These Solutions A and B were added in a whole quantity to the mixture at a constant flow rate for 45 seconds. Thereafter, 10 mL of 3.5% by weight hydrogen peroxide solution was added and a further 10.8 mL of 10% by weight benzoimidazole was added.

Then, 51.86 g of silver nitrate was diluted to 317.5 mL by adding distilled water, which was designated as Solution C, and 60 g of potassium iodide was diluted to 600 mL by adding distilled water, which was designated as Solution D. A whole quantity of Solution C was added at a constant flow rate for 120 minutes and Solution D was maintained at pAg 6.3 and added by control double jet method.

Ten minutes after addition of Solutions C and D was started, potassium iridium (III) hexa-chloride was added in a whole quantity so as to provide 1×10⁻⁴ mol in relation to 1 mol of silver. Five seconds after the completed addition of Solution C, aqueous solution of potassium iron (II) hexa-cyanide was added in a whole quantity so as to provide 3×10⁻⁴ mol in relation to 1 mol of silver.

Sulfuric acid with 0.5 mol/L concentration was added to adjust the pH to 3.8. Stirring was ceased to carry out the processes of sedimentation, desalting and water-washing. Sodium hydroxide with 1 mol/L concentration was used to adjust the pH to 5. 9, and silver halide dispersion with pAg 8.0 was prepared.

The silver halide emulsion 2-5 was prepared in a way similar to that used in preparing the silver halide emulsion 2-4.

The particle of the thus prepared silver halide emulsion was a particle of silver bromide layer (30 mol %) with the mean sphere equivalent diameter of 0.040 μm and coefficient variation of the sphere equivalent diameter of 10%, to which 70 mol % silver iodide layer was coupled. The part having a crystalline structure of silver iodide was provided with strong light absorption through direct transition.

Preparation of Mixture Emulsion for Coating Liquid

The silver halide emulsions 2-1,2-2, 2-3,2-4, 2-5 and 2-6 as shown in Table 5 were dissolved, and 1% by weight benzothiazolium iodide azolium solution was added thereto at 7×10⁻³ mol in relation to 1 mol of silver. Water was added to the resultant so that silver halide was contained at 38.2 g in 1 kg of each mixture emulsion for coating liquid.

The aliphatic acid silver dispersion, reducing agent dispersion, hydrogen bond compound dispersion, development accelerator dispersion and image tone modifier dispersion, poly-halogen compound dispersion, phthalazine compound solution, mercapto compound solution, pigment dispersion and SBR latex solution were prepared similarly as in Example 1-1. In place of the phthalazine compound-1 used in preparing phthalazine compound-1 solution, phthalazine compound-2 (5,7-dimethylphthalazine) was used to adjust 5% by weight solution of phthalazine compound-2. Further, in place of the phthalazine compound-1 used in preparing phthalazine compound-1 solution, phthalazine compound-3 (phthalazine) was used as a control compound to adjust 5% by weight solution of phthalazine compound-3.

2-3-2. Preparation of Coating Liquid

Preparation of Coating Liquids 2-1 to 2-18 for the Emulsion Layer (Photosensitive Layer)

1000 g of aliphatic acid silver dispersion, 276 mL of water, 32.8 g of pigment-1 dispersion, 3.2 g of organic poly-halogen compound-1 dispersion, 8.7 g of organic poly-halogen compound-2 dispersion that were prepared above, and 173 g of phthalazine compound solution, 1082 g of SBR latex solution (Tg: 20° C.), 155 g of reducing agent-i dispersion, 55 g of hydrogen bond compound-1 dispersion, 1 g of development accelerator-1 dispersion, 2 g of development accelerator-2 dispersion, 3 g of development accelerator-3 dispersion, 2 g of image tone modifier-1 dispersion, 6 mL of mercapto compound-2 aqueous solution that were enlisted in Table 5 were added sequentially, and 117 g of silver halide mixture emulsion enlisted in Table 5 was added immediately before coating and mixed well to prepare a coating liquid for the emulsion layer. The thus prepared coating liquid was fed directly to a coating die to conduct coating.

Zirconium was contained in the coating liquid at a quantity of 0.25 mg in relation to one gram of silver.

Coating liquids for the emulsion surface intermediate layer and for emulsion surface protective layer (first layer) were prepared in a way similar to that shown in Example 1-1, and fed to the coating die.

80 g of inert gelatin was dissolved in water, and 10.2 g of 27.5% by weight methylmethacrylate/styrene/buthylacrylate/hydroxyethylmethacrylate/acryl acid copolymer latex solution (copolymerization ratio: 64/9/20/5/2), 2.7 mL of 2% by weight fluorosurfactant solution (F-5), 2.7 mL of 2% by weight fluorosurfactant solution (F-6), 2.7 mL of 2% by weight fluorosurfactant solution (F-3), 2.7 mL of 2% by weight fluorsurfactant solution (F-4), 23 mL of 5% by weight surfactant solution (trade name: Aerosol OT, American Cyanide), 4 g of polymethylmethacrylate micro-particle (0.7 μm mean particle size), 21 g of polymethylmethacrylate micro-particle (4.5 μm mean particle size), 1.6 g of 4-methyl phthalate, 4.8 g of phthalic acid, 44 mL of sulfuric acid (0.5 mol/L concentration) and 10 mg of benzoisothiazolinone were added and mixed in water to prepare a coating liquid in a total quantity of 650 g. Immediately before coating, 4% by weight chrome alum and 0.67% by weight phthalic acid were mixed with the coating liquid by using a static mixer to provide a 445 mL solution, which was fed to the coating die so as to provide a coated quantity of 8.3 mL/m².

The viscosity of the coating liquid determined with a B-type viscometer at 40° C. (No. 1 rotor, 60 rpm) was 19 mPa·s.

2-4. Preparation of Samples of the Photothermographic Material 2-1 to 2-18

The coating liquid for the anti-halation layer was coated on both sides of the above-described undercoat support so that a solid micro-particle dye was coated at a quantity of 0.04 g/m² (on dry solid basis) and at the same time the coating layer for a back plane protective layer was coated to provide a gelatin coated quantity of 1.7 g/m², which were dried to prepare a back layer.

A multi-coating was provided by a slide bead coating method to the plane opposite to the back plane in the order of the emulsion layer, intermediate layer, first protective layer and second protective layer starting from the undercoat layer to prepare samples of the photothermographic material. In this instance, the emulsion layer and intermediate layer were adjusted to 31° C., the first protective layer was adjusted to 36° C., and the second protective layer was adjusted to 37° C.

The following shows the coated quantity (g/m²) for individual compounds in the emulsion layer.

| | |
|---|---|
| Silver behenate | 5.55 |
| Organic poly-halogen compound-1 | 0.02 |
| Organic poly-halogen compound-2 | 0.06 |
| Phthalazine compound (enlisted in Table 5) | 0.19 |
| SBR latex | 9.67 |
| Reducing agent-1 | 0.81 |
| Hydrogen bond compound-1 | 0.30 |
| Development accelerator-1 | 0.004 |
| Development acceierator-2 | 0.010 |
| Development accelerator-4 | 0.015 |
| Image tone modifier-1 | 0.010 |
| Mercapto compound-2 | 0.002 |
| Silver halide (enlisted in Table 5) | 0.091 |
| | (as Ag) |

The samples of photothermographic material 2-1 to 2-18 were prepared by a coating and drying method similar to that used in Example 1-1.

Following are the chemical structures of the compounds used in the examples of the invention.

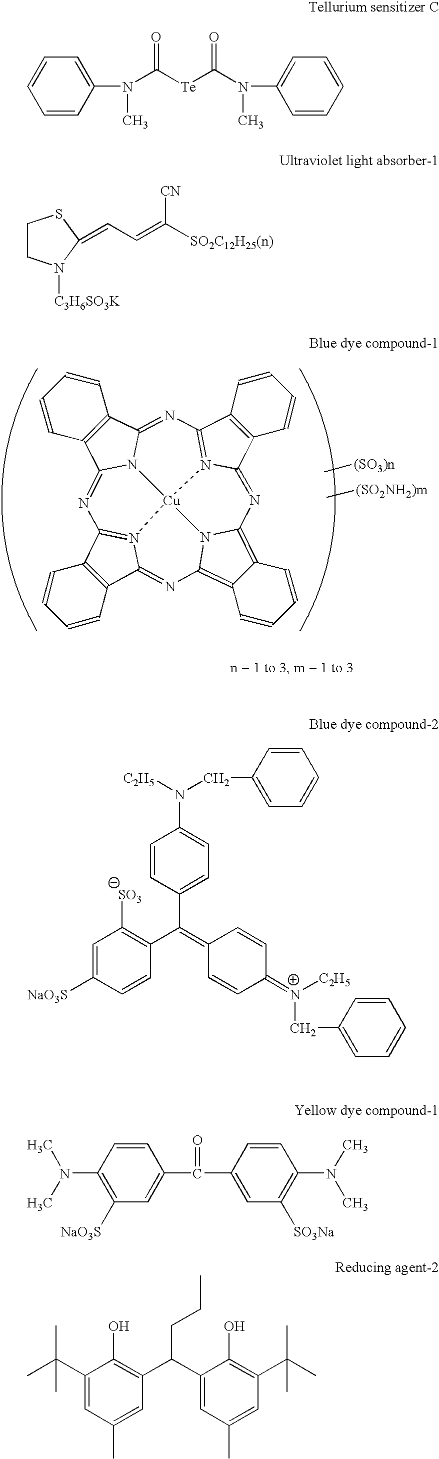

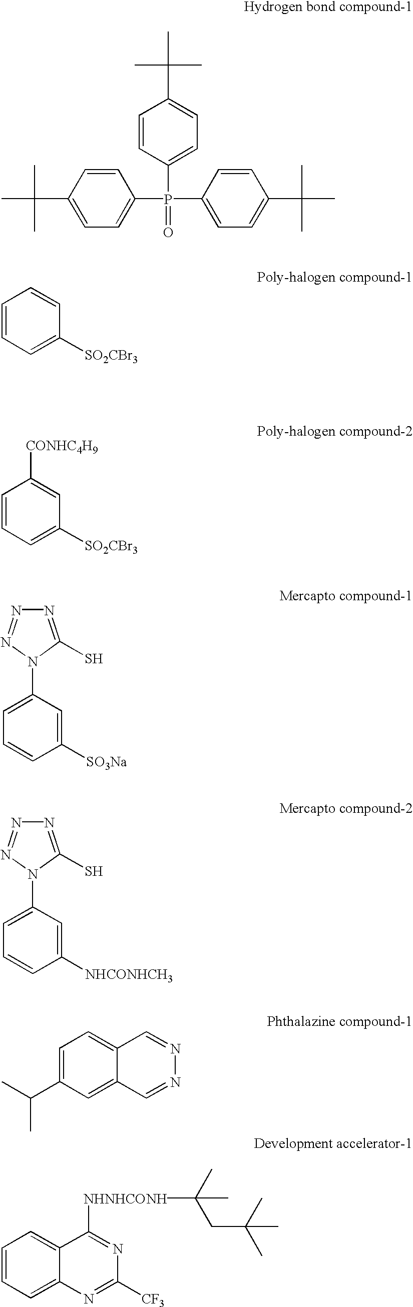

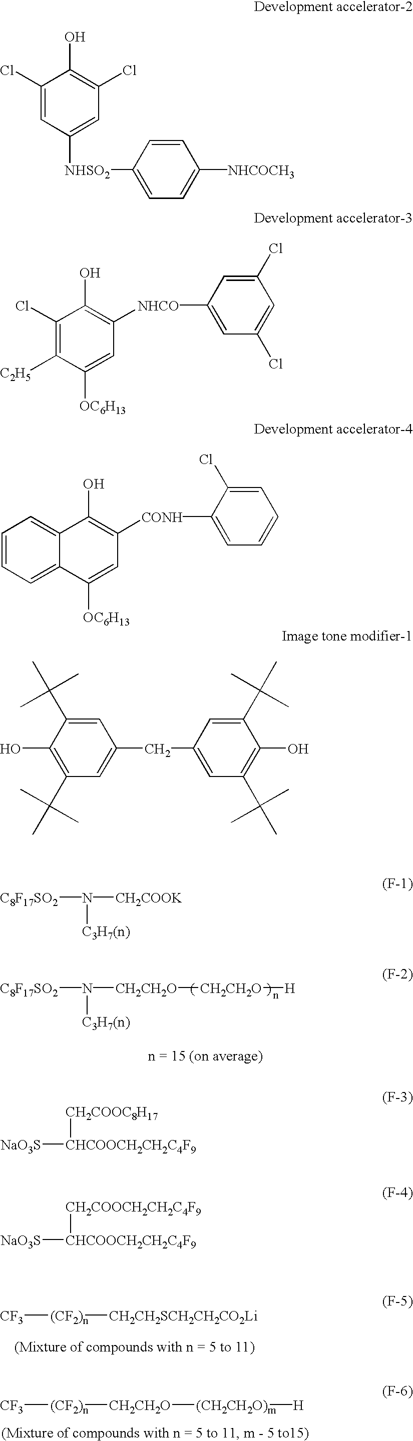

Evaluation

Samples of the thus obtained photothermographic material 2-1 to 2-18 were subjected to exposure and development process in ways similar to those used in Example 1-1 and evaluated as follows.

Image Evaluation

1) Evaluation of Sensitivity

A reciprocal of the exposed light intensity necessary for obtaining 1.0 of fog density is designated as 100 to be expressed as a relative value of the sensitivity of the photothermographic material 1. A greater value indicates a higher sensitivity.

2) Evaluation of Long Time Storability

The prepared photothermographic material was cut by half and warped in packaging materials at 35° C. and 60% and evaluated for the image 1 week later.

Packaging Material

PET10 μm/PE12 μm/aluminum foil 9 μm/Ny 15 μm/3% carbon-containing PE 5 μm

Oxygen permeability: 0.02 mL/atm·m²·day (25° C.)

Moisture permeability: 0.01 g/atm·m²·day (25° C.)

Evaluation was made for the long time storability determined for the density decrease in the maximum density area (3.5 to 4.5) when stored under the above conditions. A smaller decrease in the density shows a better long time storability.

3) Evaluation of Image Storability

Evaluation of Image Storability-1

Individual samples of the photothermographic material after thermal development were placed in a room maintained at 25° C. and 60%RH and allowed to stand for 30 days under 100-lux fluorescent light. In relation to the fogging level determined immediately after thermal development, a larger increase in the fogging level (increase in Dmin) after the samples were allowed to stand for 30 days under the above conditions indicates a poorer image storability. It is preferable to have a smaller increase in the fogging level even when the samples were allowed to stand under said conditions.

Evaluation of Image Storability-2

Individual samples of the photothermographic material after thermal development were placed in a room maintained at 30° C. and 70%RH and allowed to stand for 8 hours under 4000-lux fluorescent light. Macroscopic observation was made of tone change in the image with the density =1.2 (organoleptic evaluation). The following show evaluation scores (evaluation criteria). For practical application, the score must be zero or 1. The results are shown in Table 5.

Evaluation Score

0: no change in image tone

1: change in image tone found but not to an extent that poses problems for practical application.

2: slight browning found and posing problems for practical application

3: apparent browning found and posing problems for practical application

TABLE 5

| | | | | Absorption through | | | |
|---|---|---|---|---|---|---|---|
| Thermally | | | | direct transition | Silver | | |
| developable | Silver | Iodine | Br | resulting from | halide | Phthalizine | |
| photosensitive | halide | content | content | silver iodide | particle | compound | |
| material | emulsion | (mol %) | (mol %) | crystalline structure | size | solution | Sensitivity |
| 2-1 | 2-1 | 100 | 0 | Found | 40 nm | 1 | 100 |
| 2-2 | 2-1 | 100 | 0 | Found | 40 nm | 2 | 100 |
| 2-3 | 2-1 | 100 | 0 | Found | 40 nm | 3 | 90 |
| 2-4 | 2-2 | 3.5 | 96.5 | Not found | 40 nm | 1 | 30 |
| 2-5 | 2-2 | 3.5 | 96.5 | Not found | 40 nm | 2 | 30 |
| 2-6 | 2-2 | 3.5 | 96.5 | Not found | 40 nm | 3 | 25 |
| 2-7 | 2-3 | 30 | 70 | Not found | 40 nm | 1 | 45 |
| 2-8 | 2-3 | 30 | 70 | Not found | 40 nm | 2 | 45 |
| 2-9 | 2-3 | 30 | 70 | Not found | 40 nm | 3 | 35 |
| 2-10 | 2-4 | 30 | 70 | Found | 40 nm | 1 | 70 |
| 2-11 | 2-4 | 30 | 70 | Found | 40 nm | 2 | 70 |
| 2-12 | 2-4 | 30 | 70 | Found | 40 nm | 3 | 60 |
| 2-13 | 2-5 | 70 | 30 | Found | 40 nm | 1 | 85 |
| 2-14 | 2-5 | 70 | 30 | Found | 40 nm | 2 | 85 |
| 2-15 | 2-5 | 70 | 30 | Found | 40 nm | 3 | 75 |
| 2-16 | 2-6 | 95 | 5 | Found | 40 nm | 1 | 105 |
| 2-17 | 2-6 | 95 | 5 | Found | 40 nm | 2 | 105 |
| 2-18 | 2-6 | 95 | 5 | Found | 40 nm | 3 | 95 |

| Thermally | | Long time | Image | | |
|---|---|---|---|---|---|
| developable | | storability | storability-1 | | |
| photosensitive | | (decrease | (increase in | Image | |
| material | Fogging | in Dmax) | Dmin) | storabilty-2 | Remarks |
| 2-1 | 0.18 | 0.05 | 0.00 | 0 | Present invention |
| 2-2 | 0.18 | 0.05 | 0.00 | 0 | Present invention |
| 2-3 | 0.25 | 0.40 | 0.05 | 2 | Control |
| 2-4 | 0.32 | 0.50 | 0.10 | 3 | Control |
| 2-5 | 0.32 | 0.50 | 0.10 | 3 | Control |
| 2-6 | 0.40 | 1.00 | 0.12 | 3 | Control |
| 2-7 | 0.20 | 0.15 | 0.06 | 1 | Present invention |
| 2-8 | 0.20 | 0.15 | 0.06 | 1 | Present invention |
| 2-9 | 0.24 | 0.70 | 0.15 | 3 | Control |
| 2-10 | 0.20 | 0.12 | 0.03 | 0 | Present invention |
| 2-11 | 0.20 | 0.12 | 0.03 | 0 | Present invention |
| 2-12 | 0.24 | 0.60 | 0.11 | 3 | Control |
| 2-13 | 0.10 | 0.10 | 0.02 | 1 | Present invention |
| 2-14 | 0.18 | 0.10 | 0.02 | 1 | Present invention |
| 2-15 | 0.25 | 0.50 | 0.08 | 2 | Control |
| 2-16 | 0.18 | 0.08 | 0.01 | 0 | Present invention |
| 2-17 | 0.18 | 0.08 | 0.01 | 0 | Present invention |
| 2-18 | 0.25 | 0.40 | 0.07 | 3 | Control |

As apparent from the results of Table 5, it has been demonstrated that the photothermographic material of the invention is excellent in the long time storability and also excellent in the image storability after thermal development.

### Example 2-2

Silver halide emulsion (pure silver iodide emulsion) 2-7 having the particle size of 70 nm and silver halide emulsion (pure silver iodide emulsion) 2-8 having the particle size of 100 nm were prepared in a way similar to that used in preparing the photothermographic material of Example 2-1, except that the temperature on formation of photosensitive silver halide particle was allowed to change. The samples of the photothermographic material, 2-19, 2-20, 2-21, 2-22, 2-23 and 2-24 were prepared in a way similar to that used in preparing the sample of the photothermographic material 2-1 of Example 2-1 except that the above emulsions were used.

Evaluation was made for the image quality of the thus prepared samples of the photothermographic material. Dmax is a maximum optical density of the samples after thermal development. Other items were evaluated similarly as in Example 2-1. Table 6 shows the results.

TABLE 6

| | | | | Absorption through | | | | | | |
|---|---|---|---|---|---|---|---|---|---|---|
| Thermally | | | | direct transition | | Silver | Coated | | | |
| developable | Silver | Iodine | Br | resulting from | | halide | quantity of | | | |
| photosensitive | halide | content | content | silver iodide | Absorption | particle | silver halide | | | |
| material | emulsion | (mol %) | (mol %) | crystalline structure | found | size | (as Ag) | Sensitivity | Fogging | Dmax |
| 2-1 | 2-1 | 100 | 0 | Found | 40 nm | 0.091 g/m² | 100 | 0.18 | 4.2 | 0.00 |
| 2-19 | 2-7 | 100 | 0 | Found | 70 nm | 0.091 g/m² | 120 | 0.18 | 3.1 | 0.00 |
| 2-20 | 2-7 | 100 | 0 | Found | 70 nm | 0.18 g/m² | 130 | 0.18 | 3.7 | 0.05 |
| 2-21 | 2-7 | 100 | 0 | Found | 70 nm | 0.36 g/m² | 140 | 0.18 | 3.9 | 0.10 |
| 2-22 | 2-8 | 100 | 0 | Found | 100 nm | 0.091 g/m² | 140 | 0.18 | 2.0 | 0.10 |
| 2-23 | 2-8 | 100 | 0 | Found | 100 nm | 0.18 g/m² | 155 | 0.18 | 3.2 | 0.12 |
| 2-24 | 2-8 | 100 | 0 | Found | 100 nm | 0.36 g/m² | 170 | 0.18 | 3.6 | 0.12 |

As apparent from the results of Table 6, a smaller particle size of silver halide is able to provide a higher Dmax in a smaller quantity of coated silver, which is found to be a more favorable aspect of the invention.

The present invention provides a photothermographic material that is excellent in the sensitivity and long time storability and also excellent in the image storability after thermal development, with the use of photosensitive silver halide with a higher silver iodide content and a method for forming the image.

What is claimed is:

1. A photothermographic material comprising: a support; and an image forming layer provided on the support, wherein the image forming layer comprises at least a photosensitive silver halide, a non-photosensitive organic silver salt, a reducing agent and a binder, and the photothermographic material satisfies at least one of conditions (i) and (ii) shown below:
(i) the photosensitive silver halide whose total silver iodide content is in a range of from 40 mol % to 100 mol %, and which is wrapped with a packaging material so that humidity inside the packaging material is no more than 60%RH at an ambient temperature of 25° C., or
(ii) said photosensitive silver halide having a silver iodide content in a range of from 5 mol % to 100 mol % and the photothermographic material including the compound represented by the general formula (I) below: 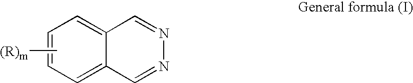
wherein R represents a monovalent substituent and where a plurality of Rs are adjacent, they may form an aliphatic ring, aromatic ring or hetero cycle; m representing an integer from 1 to 4 and when m is at least 2, the plurality of Rs may be the same or different.

2. A photothermographic material comprising: a support; and an image forming layer provided on the support, the image forming layer including at least a photosensitive silver halide, a non-photosensitive organic silver salt, a reducing agent and a binder, wherein,
the total silver iodide content of said photosensitive silver halide is in a range of from 40 mol % to 100 mol %; and
the photothermographic material is wrapped with a packaging material so that humidity inside the packaging material is no more than 60%RH at the ambient temperature of 25° C.

3. A photothermographic material comprising a support and an image forming layer provided on the support, the image forming layer including at least a photosensitive silver halide, a non-photosensitive organic silver salt, a reducing agent and a binder; wherein
the silver iodide content of said photosensitive silver halide is in a range of from 5 mol % to 100 mol % and the photothermographic material contains the compound represented by the general formula (I) below: 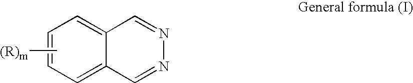
wherein in the formula (I), R represents a monovalent substituent and where a plurality of Rs are adjacent, they may form an aliphatic ring, aromatic ring or hetero cycle; m representing an integer from 1 to 4 and when m is at least 2, the plurality of Rs may be the same or different.

4. The photothermographic material according to claim 2, wherein said total silver iodide content is in a range of from 90 mol % to 100 mol %.

5. The photothermographic material according to claim 2, wherein oxygen permeability of said packaging material is no more than 10 mL/atm·m²·25° C.·day and moisture permeability of said packaging material is no more than 5 mL/atm·m²·25° C.·day.

6. The photothermographic material according to claim 4, wherein oxygen permeability of said packaging material is no more than 10 mL/atm·m²·25° C.·day and moisture permeability of said packaging material is no more than 5 mL/atm·m²·25° C.·day.

7. The photothermographic material according to claim 2, wherein said photosensitive silver halide is formed in the absence of a non-photosensitive organic silver salt.

8. The photothermographic material according to claim 4, wherein said photosensitive silver halide is formed in the absence of a non-photosensitive organic silver salt.

9. An image forming method comprising the step of exposing a photothermographic material using a semi-conductor laser having a light-emitting peak intensity of 350 nm to 450 nm as a light source for exposure,
wherein said photothermographic material comprises a support and an image forming layer provided on the support, the image forming layer including at least a photosensitive silver halide, a non-photosensitive organic silver salt, a reducing agent and a binder;
the total silver iodide content of said photosensitive silver halide is in a range of from 40 mol % to 100 mol % and the photothermographic material is wrapped with a packaging material so that humidity inside the packaging material is no more than 60%RH at the ambient temperature of 25° C.

10. The photothermographic material according to claim 3, wherein said photosensitive silver halide is provided with direct transition absorption derived from a high silver iodide crystalline structure.

11. The photothermographic material according to claim 3, wherein the particle size of said photosensitive silver halide is from 5 nm to 80 nm.

12. The photothermographic material according to claim 3, wherein said photosensitive silver halide is formed in the absence of a non-photosensitive organic silver salt.

13. The photothermographic material according to claim 3, wherein the mean silver iodide content of said photosensitive silver halide is from 10 mol % to 100 mol %.

14. The photothermographic material according to claim 3, wherein the mean silver iodide content of said photosensitive silver halide is from 40 mol % to 100 mol %.

15. An image forming method comprising the step of thermal developing a photothermographic material after exposing the photothermographic material with light having a peak intensity at a wavelength of 350 nm to 450 nm and illumination exceeding 1 mW/mm²,
wherein said photothermographic material includes a support and an image forming layer provided on the support, the image forming layer including at least a photosensitive silver halide, a non-photosensitive organic silver salt, a reducing agent and a binder, wherein
the silver iodide content of said photosensitive silver halide is in a range of from 5 mol % to 100 mol % and the photothermographic material contains the compound represented by the general formula (I) below: 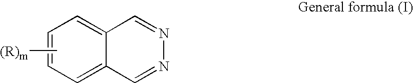
wherein R represents a monovalent substituent and when a plurality of Rs are adjacent, they may form an aliphatic ring, aromatic ring or hetero cycle; m representing an integer from 1 to 4 and when m is at least 2, the plurality of Rs may be the same or different.

16. An image forming method comprising the step of thermal developing a photothermographic material after exposing the photothermographic material with a semi-conductor laser having a light-emitting peak intensity of 390 nm to 430 nm as a light source, wherein
the silver iodide content of said photosensitive silver halide is in a range of from 5 mol % to 100 mol % and the photothermographic material contains the compound represented by the general formula (I) below: 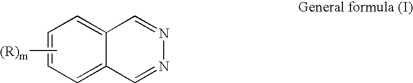
wherein R represents a monovalent substituent and when a plurality of Rs are adjacent, they may form an aliphatic ring, aromatic ring or hetero cycle; m representing an integer from 1 to 4 and when m is at least 2, the plurality of Rs may be the same or different.
